(19) United States
(12) Patent Application Publication
(10) Pub. No.: US 2024/0035174 A1
(43) Pub. Date: Feb. 1, 2024

(54) METHOD OF OPERATING CAPILLARY-BASED ELECTRO-SYNTHETIC OR ELECTRO-ENERGY CELLS

(71) Applicant: Hysata Pty Ltd, Unanderra, New South Wales (AU)

(72) Inventors: Gerhard Frederick SWIEGERS, North Wollongong (AU); Aaron HODGES, Picton (AU); Klaudia Katarzyna WAGNER, Horsley (AU); Anh Linh HOANG, Wollongong (AU); Chong-Yong LEE, Wollongong (AU)

(21) Appl. No.: 18/245,866

(22) PCT Filed: Sep. 20, 2021
(86) PCT No.: PCT/AU2021/051090

§ 371 Date: Mar. 17, 2023

(30) Foreign Application Priority Data
Sep. 21, 2020 (AU) 2020903369
Apr. 30, 2021 (AU) 2021901285

(51) Int. Cl. C25B 9/63; C25B 13/02; C25B 15/08; C25B 1/04; C25B 1/26; C25B 1/27; C25B 11/032

(52) U.S. Cl. CPC C25B 9/63; C25B 13/02; C25B 15/085; C25B 1/04; C25B 1/26; C25B 1/27; C25B 11/032

(57) ABSTRACT

A method of operating an electro-synthetic or electro-energy cell performs an electrochemical reaction. An electro-synthetic or electro-energy cell includes a reservoir containing a liquid electrolyte, a first gas diffusion electrode, and a second electrode. A porous capillary spacer is positioned between the first gas diffusion electrode and the second electrode. The porous capillary spacer can have an end positioned within the reservoir and in liquid contact with the liquid electrolyte. The method includes contacting the first gas diffusion electrode and the second electrode with the liquid electrolyte, and applying or generating a voltage across the first gas diffusion electrode and the second electrode.

### TECHNICAL FIELD

The invention broadly relates to electrochemical cells, for example used as electro-synthetic cells or electro-energy cells. Example embodiments of the invention more particularly relate to zero-gap electrochemical cell architectures that are inherently energy efficient and that employ molecular-level capillary and/or diffusion and/or osmotic effects to minimize the need for macro-level external management of the electrochemical cell.

### BACKGROUND

An electro-energy cell is an electrochemical cell that generates electrical power continually or continuously, over indefinite periods of time, for use outside of the cell. Electro-energy cells are distinguished from galvanic cells in that they may need to be provided with a constant external supply of reactants during operation. The products of the electrochemical reaction are generally also constantly removed from such cells during operation. Unlike a battery, an electro-energy cell does not store chemical or electrical energy within it.

An electro-synthetic cell may similarly be considered to be an electrochemical cell that manufactures one or more chemical materials continually or continuously, over indefinite periods of time, for use outside of the cell. The chemical materials may be in the form of a gas, liquid, or solid. Like an electro-energy cell, an electro-synthetic cell also requires a constant supply of reactants and a constant removal of products during operation. Electro-synthetic cells generally further require a constant input of electrical energy.

Because of the large quantities of electrical energy involved in operating electro-energy and electro-synthetic cells, a key challenge in their development is to make them as energy efficient as possible during operation. This may be achieved, in part, by minimizing their electrical impedance. Impedance is the opposition that a cell circuit presents to an electrical current when a voltage is applied. One method of minimizing impedance is to employ a cell architecture in which the anode and cathode electrodes of the cell are placed facing each other, as close as possible to each other, without touching (which would create a short circuit). The gap between the two electrodes should also be occupied by an electrolyte having the highest possible ionic conductance.

To this end, a range of ‘zero-gap’ cell architectures have been developed for electro-synthetic or electro-energy cells. In such architectures, two electrodes are sandwiched tightly against opposite sides of a thin membrane that may have inherently high ionic conductance or may be imbued with a liquid electrolyte having a high ionic conductance. Zero-gap membranes of this type are generally less than 2 mm thick in zero-gap cells. Some examples of zero-gap cell architectures are provided in the scientific paper by R. Phillips and C. W. Dunnill, “Zero gap alkaline electrolysis cell design for renewable energy storage as hydrogen gas” in RSC Advances (2016), Vol 6, pages 100643-100651.

Another feature of electro-synthetic or electro-energy cells is the large quantities of reactants and products that are typically involved in their operation. During operation, such cells may be constantly fed with substantial amounts of reactants, whilst significant quantities of products may, simultaneously, be constantly removed from the cell. Ideally, reactant supply and product removal should be totally separate processes, so that reactants can be supplied to the cell independently of products being removed from the cell, without these processes interfering with each other. Moreover, the supply of reactants to the cell and the removal of products from the cell should not interfere with or limit the electrochemical reaction.

For example, one of the most well-known zero-gap cells is the hydrogen-oxygen Polymer Electrolyte Membrane (PEM) fuel cell. Such cells typically employ a thin, proton (H⁺)-conductive membrane formed of a sulfonated tetrafluoroethylene-based fluoropolymer-copolymer, such as the Nafion® membrane supplied by the Chemours company, sandwiched between two gas-porous electrodes (also known as ‘Gas Diffusion Electrodes’). The Nafion® membrane may typically be ˜0.183 mm thick (e.g. when using Nafion® 117 membrane) or ˜0.125 mm thick (e.g. when using Nafion® 115 membrane). In such cells, reactant hydrogen (H₂) gas is introduced via one of the gas diffusion electrodes (the ‘hydrogen electrode’), where it is converted into protons. The protons are transported through the Nafion® membrane to the other electrode (the ‘oxygen electrode’). Oxygen (O₂) gas, introduced via the gas diffusion ‘oxygen’ electrode reacts with the protons that pass through the Nafion® membrane, to generate water (H₂O). The water, formed at the oxygen electrode, is typically removed from the cell by gravity or evaporation. The electrochemical reaction in the cell creates an electrical current or voltage in an attached external circuit.

Key to the operation of this cell is the capacity of the Nafion® membrane to facilitate proton (H⁺) conduction from the hydrogen electrode to the oxygen electrode. To perform this function, the Nafion® membrane must be partially or fully saturated with water (i.e. hydrated). However, maintaining the necessary hydration level may be challenging because water is also a product of the reaction that is generated at the oxygen electrode. Most commonly, the level of Nafion® membrane hydration in PEM fuel cells is managed by humidifying the input (reactant) hydrogen gas. This must be carefully controlled since excess humidity may lead to water condensing and pooling in one of the gas diffusion electrodes, cutting off the input gas and halting the reaction. This phenomenon is known as ‘flooding’ and is a particular risk at the oxygen electrode, where the reaction product, water, is also formed. Insufficient humidification may, however, lead to partial drying of the Nafion® membrane, causing a decline in proton conductance, and a slowing of the reaction. This is a particular risk at the hydrogen electrode as, during operation, electrophoretic drift causes water molecules to migrate away from the hydrogen electrode, across the Nafion® membrane, to the oxygen electrode. Thus, because the process of supplying a reactant (hydrogen) is entangled with the process of removing a product (water), fuel cells of this type often require active management, involving variation of the humidity content of the input gases by responsive, monitored, real-time electronic feedback systems.

Many electro-energy and electro-synthetic cells require some form of management during their operation, including active management, because the processes involved in supplying reactants are entangled with and not independent of the processes of removing products. This occurs because, within the cell itself, the molecular-level processes that supply the reactants to, and/or remove the products from the active site of the electrochemical reaction, are not separate and independent. Moreover, they are not controlled by the electrochemical reaction. This molecular-level deficiency then has to be dealt with by macro-scale management of an indirect, proxy control process to: (i) supply reactants to the electrodes, and/or (ii) remove products from the electrodes, and/or (iii) control a critical intermediate or critical process between the electrodes.

This problem can be stated in a more conceptual way to clarify the issue. Inside essentially all zero-gap electro-energy and electro-synthetic cells, reactions and molecular movements occur at the molecular-level in the ‘cross-plane’ axis, at and between the electrodes, largely within the inter-electrode membrane, under the control of the electrochemical reaction. The reactants must generally migrate into this cross-plane axis, from outside of the membrane, in a process that may not be under the control of the electrochemical reaction. Similarly, the products of the electrochemical reaction must typically migrate out of the cross-plane axis in a process that may not be controlled by the electrochemical reaction. The same can be said for all the other critical processes and the particular materials involved therein. As these processes occur in a less controlled manner, there may be a disconnection, within the cell itself, at the molecular level, between reactant supply to/product removal from the reaction site/s and the rate of the electrochemical reaction itself. It is this molecular-scale disconnection that generally creates the need for difficult, external, macro-scale management, including active management. That is, the need for management may arise from a disconnection between the electrochemical reaction and the large quantities of materials that must be supplied to it or removed from it within the cell itself. If all such movements were better controlled then this may diminish the need to manage the cell, especially to actively manage the cell.

In some electro-synthetic or electro-energy zero-gap cells involving gas-to-liquid or liquid-to-gas transformations, it is the molecular-level movements of liquid-phase materials into or out of the cross-plane axis that is problematic. For example, as noted above, in zero-gap PEM fuel cells, water movement into/out of the cross-plane axis may interfere with the gas-phase reactants accessing the electrodes, thereby necessitating active management. In other cells however, it is the molecular-level movement of gas phase materials into or out of the cross-plane axis that may be challenging and require active management. For example, the gas bubbles produced in zero-gap water electrolysis cells must often be actively swept off the electrodes by continuously pumping liquid electrolyte over the electrodes in order to provide the water reactant with access to the electrode surface. This not only increases the cost of the cell (due to the additional piping, tanks, and other equipment, including pressure management equipment), but also increases the ‘crossover’ of gas from one electrode to the other, which may significantly reduce the electrochemical efficiency of the cell and constitute a safety hazard.

In such cells, the problem can be summarised as involving a molecular-level flow inside an electrochemical cell, in which a chemical species having one phase of matter (e.g. liquid), flows in a direction and at a location that opposes and counters the flow of another chemical species having a different phase of matter (e.g. gas). Flows of this type may be termed ‘counter multiphase flows’. In interfering with and hindering each other, such countervailing multiphase flows may create inefficiencies that diminish the performance of the cell and require energy to overcome.

The existence of such counter multiphase flows in electro-synthetic or electro-energy cells are well-known. However, eliminating or minimizing them is not simple because there are often other important considerations that must be addressed. For example, as noted above, in many water electrolysis cells, the flows of liquid-phase reactants (e.g. water molecules and ions) toward an electrode counter the flow of gas-phase products (e.g. gas bubbles) away from the electrode. This is often amplified by the inter-electrode membrane. The main function of an inter-electrode membrane is to block the crossover of gas between the electrodes. To this end, an inter-electrode membrane will typically need to be non-porous and have a thickness more than or equal to the 0.125 mm of Nafion® 115 membranes. If an inter-electrode membrane is at all porous, the pores will need to be as small as possible to prevent gas bubbles from entering and passing through the inter-electrode membrane. Such properties do not lend themselves to the continuous supply of large quantities of liquid-phase reactants, like water molecules. Indeed, these properties of known inter-electrode membranes can inhibit or minimise, or even prevent, the mobility of liquid-phase water inside the inter-electrode membrane. This is needed to minimise the gas crossover through the membrane.

In summary, new and improved electrochemical cells or zero-gap electrochemical cells, for example used as electro-synthetic cells or electro-energy cells, are needed. Alternatively, or additionally, new and improved zero-gap electro-energy and/or electro-synthetic cells are needed. Alternatively, or additionally, new and improved means for managing the operation of zero-gap electro-energy and/or electro-synthetic cells, in examples where management may be necessary, are also needed. New and improved electrochemical cells or zero-gap electrochemical cells are particularly needed for electro-energy and electro-synthetic cells that facilitate gas-to-liquid or liquid-to-gas transformations.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Detailed Description. This Summary is not intended to identify all of the key features or essential features of the claimed subject matter, nor is it intended to be used to limit the scope of the claimed subject matter.

In various example aspects, embodiments relate to electrochemical cell architectures, particularly zero-gap electrochemical cell architectures, that employ molecular-level capillary and/or diffusion and/or osmotic effects within the cell to minimize the need for macro-level external management of the cell. Preferably, these molecular-level processes intrinsically respond to the electrochemical reaction within the cell, making them self-regulating. Preferably, these molecular-level processes are separate and independent for the various liquid- and gas-phase reactants and/or products of the cell. Preferably, each such molecular-level process involves a distinct, macroscopic body of liquid or gas within the cell. Preferably, fresh reactant or excess product is separately supplied to or removed from these bodies of liquid and gas during operation of the cell. Preferably, this supply or removal is via gas/liquid-tight conduits that separately link each body of liquid or gas within the cell to external storage and supply/removal systems.

Example embodiments are particularly relevant to zero-gap electro-synthetic or electro-energy cells that facilitate gas-to-liquid or liquid-to-gas processes. Such cells operate continually or continuously over indefinite periods of time, consuming reactants and generating products that are too voluminous to be accommodated within the cell, and may instead be supplied or removed by external storage and supply/removal systems. Preferably, the example embodiments are inherently energy efficient.

In one example aspect there is provided an electro-synthetic or electro-energy cell, comprising: a first gas diffusion electrode; a second electrode; and a porous capillary spacer positioned between the first gas diffusion electrode and the second electrode. Preferably, the porous capillary spacer is able to fill itself with the liquid electrolyte when the end of the porous capillary spacer is in liquid contact with the liquid electrolyte in the reservoir. Preferably, the first gas diffusion electrode is positioned outside of the reservoir. Preferably, the second electrode is also positioned outside of the reservoir. Optionally, the cell is an electro-synthetic water electrolysis cell.

In one example form, the first gas diffusion electrode is in direct contact with a first gas body. In another example form, the porous capillary spacer is filled with liquid electrolyte. In another example form, an average pore diameter of the porous capillary spacer is more than 2 μm. In another example form, the first gas diffusion electrode is in contact with and adjacent to the first gas body. In another example form, the second electrode is a second gas diffusion electrode and is in contact with and adjacent to a second gas body.

In another example aspect there is provided an electro-synthetic or electro-energy cell, comprising: a reservoir for containing a liquid electrolyte; a first gas diffusion electrode positioned outside of the reservoir; a second electrode positioned outside of the reservoir; and a porous capillary spacer positioned between the first gas diffusion electrode and the second electrode, the porous capillary spacer having an end that extends into the reservoir; wherein, the porous capillary spacer is able to fill itself with the liquid electrolyte when the end of the porous capillary spacer is in liquid contact with the liquid electrolyte in the reservoir.

In another example aspect there is provided an electro-synthetic water electrolysis cell, comprising: a first gas diffusion electrode configured to generate a first gas and be in direct contact with a first gas body comprising the first gas; a second electrode; and a porous capillary spacer configured to be filled with a liquid electrolyte and positioned between the first gas diffusion electrode and the second electrode; wherein an average pore diameter of the porous capillary spacer is more than 2 μm.

In another example aspect there is provided an electro-synthetic or electro-energy cell, comprising: a first gas diffusion electrode configured to generate a first gas and be in contact with and adjacent to a first gas body comprising the first gas; a second gas diffusion electrode configured to generate a second gas and be in contact with and adjacent to a second gas body comprising the second gas; and a porous capillary spacer positioned between the first gas diffusion electrode and the second gas diffusion electrode, the porous capillary spacer configured to be filled with a liquid electrolyte and to confine the liquid electrolyte in the porous capillary spacer by a capillary effect and whereby the liquid electrolyte has a maximum column height of more than 0.4 cm.

In another example aspect there is provided a stack of electro-synthetic or electro-energy cells, comprising: a first electro-synthetic or electro-energy cell; and a second electro-synthetic or electro-energy cell electrically connected to the first electro-synthetic or electro-energy cell; wherein each electro-synthetic or electro-energy cell is an example cell as disclosed herein.

In another example aspect there is provided a method of operating an electro-synthetic or electro-energy cell to perform an electrochemical reaction, wherein the cell is an example cell as disclosed herein, and the method comprises applying a voltage across the first gas diffusion electrode and the second electrode, or generating a voltage across the first gas diffusion electrode and the second electrode.

In another example aspect there is provided a method of operating a stack of electro-synthetic or electro-energy cells to perform an electrochemical reaction, wherein the stack of electro-synthetic or electro-energy cells is an example stack of electro-synthetic or electro-energy cells as disclosed herein, and the method comprises applying a voltage across the first gas diffusion electrode and the second electrode in each stack of electro-synthetic or electro-energy cells, or generating a voltage across the first gas diffusion electrode and the second electrode in each stack of electro-synthetic or electro-energy cells.

In another example aspect there is provided a method of operating an electro-synthetic or electro-energy cell to perform an electrochemical reaction, the electro-synthetic or electro-energy cell comprising: a reservoir containing a liquid electrolyte; a first gas diffusion electrode; a second electrode; and a porous capillary spacer positioned between the first gas diffusion electrode and the second electrode, the porous capillary spacer having an end positioned within the reservoir and in liquid contact with the liquid electrolyte. The method comprising the steps of: contacting the first gas diffusion electrode and the second electrode with the liquid electrolyte; and applying or generating a voltage across the first gas diffusion electrode and the second electrode.

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 depicts, in schematic form, a cross-sectional view of an example electro-synthetic or electro-energy cell having a separate liquid reservoir that is not in direct contact with either electrode.

FIG. 2 depicts a schematic cross-sectional view of an example electro-synthetic or electro-energy cell in which the liquid in the reservoir is in direct contact with at least one electrode.

FIG. 3 depicts a schematic cross-sectional view of an example electro-synthetic or electro-energy cell in which the reservoir is incorporated into the porous capillary spacer.

FIG. 4 depicts, in schematic form, an enlargement of a cross-section of a central portion of the electrode-spacer-electrode assembly of an example electro-synthetic or electro-energy cell.

FIG. 5 depicts graphs of measured flow rates (black dots) and modelled flow rates (hollow squares) for a porous capillary spacer comprising of porous polyethersulfone material filters with average pore diameters of: (a) 0.45 μm, (b) 1.2 μm, (c) 5 μm, and (d) 8 μm, filled with 6 M KOH liquid electrolyte.

FIG. 6 depicts an alternative example reservoir configuration.

FIG. 7 depicts an electrode-spacer-electrode assembly that may be used to implement an example electro-synthetic or electro-energy cell.

FIG. 8 depicts an example electro-synthetic or electro-energy cell incorporating an electrode-spacer-electrode assembly of the type shown in FIG. 7.

FIG. 9 depicts an example stack of the electro-synthetic or electro-energy cells shown in FIG. 8 and a reservoir architecture that may be used.

FIG. 10 depicts an example stack of the electro-synthetic or electro-energy cells shown in FIG. 8 and a reservoir architecture, using four osmotic reservoirs in a cell stack of four individual cells that may be used.

FIG. 11 depicts polarisation curves at 80° C. of: (a) an example embodiment water electrolysis cell having the architecture in FIG. 1, with a gas handling structure incorporated in the oxygen-producing electrode; (b) the same example embodiment water electrolysis cell as that in (a) above, but without the gas handling structure incorporated in the oxygen-producing electrode; (c) a comparable water electrolysis cell, using the same electrodes and porous capillary spacer as in (a)-(b), but wherein the cell was completely filled with liquid electrolyte and the gases were produced in the form of gas bubbles in the liquid electrolyte; (d) the most energy efficient commercial alkaline water electrolysis cell whose data was publicly available, (d) the most energy efficient commercial PEM water electrolysis cell whose data was publicly available.

FIG. 12 depicts the current produced by the cell in FIG. 11 for polarisation curve (a) when its cell voltage was fixed at 1.47 V at 80° C., which equates to 100% energy efficiency according to the higher heating value (HHV) of hydrogen.

FIG. 13 depicts: (a) the potential of the oxygen electrode in FIG. 11 for polarisation curve (a); and (b) the comparable potential of an oxygen electrode that has been coated with a thin hydrophilic layer of the same catalyst, which facilitates the capillary-induced movement of a thin-film of 6 M KOH liquid electrolyte along and up the surface of the electrode.

FIG. 14 depicts a schematic cross-sectional view of a further example electro-synthetic or electro-energy cell in which there is no gas body.

FIG. 15 depicts a schematic cross-sectional view of a further example electro-synthetic or electro-energy cell in which liquid electrolyte is replenished/maintained by a non-interfering vapour-phase pathway via a gas body.

FIG. 16 depicts a schematic cross-sectional view of a further example electro-synthetic or electro-energy cell in which headspaces are occupied by liquid electrolyte above one electrode and by gas above the other electrode.

FIG. 17 depicts a schematic cross-sectional view of a further example electro-synthetic or electro-energy cell in which headspaces are occupied by gas above one electrode and by gas above the other electrode.

FIG. 18 depicts a schematic cross-sectional view of a further example electro-synthetic or electro-energy cell in which liquid electrolyte is replenished/maintained by a non-interfering vapour-phase pathway via a gas body.

FIG. 19 depicts a schematic cross-sectional view of a further example electro-synthetic or electro-energy cell in which liquid electrolyte held in the porous capillary spacer blocks gas crossover between the gas bodies.

FIG. 20 depicts a schematic cross-sectional view of a further example electro-synthetic or electro-energy cell in which one electrode contacts a first gas body at the top of the electrode only (in the headspace) and the other electrode contacts a second gas body at the top of the electrode only (in the headspace).

FIG. 21 depicts a schematic cross-sectional view of a further example electro-synthetic or electro-energy cell in which liquid electrolyte held in the porous capillary spacer blocks gas crossover between a first gas body and a second gas body. One electrode contacts the first gas body at the top of the electrode only (in the headspace) and the other electrode incorporates a gas handling structure, which is filled with gas that is contiguous with the headspace (collectively forming a second gas body).

FIG. 22 depicts a schematic cross-sectional view of a further example electro-synthetic or electro-energy cell in which the first electrode incorporates a gas handling structure, which is filled with gas that is contiguous with the headspace (collectively forming the first gas body).

FIG. 23 depicts a schematic cross-sectional view of a further example electro-synthetic or electro-energy cell in which one electrode contacts a first gas body at the top of the electrode only (in the headspace) and the other electrode is adjacent to a gas capillary structure which is filled with gas that is contiguous with the headspace (collectively forming a second gas body).

FIG. 24 depicts a schematic cross-sectional view of a further example electro-synthetic or electro-energy cell in which one electrode is adjacent to a gas capillary structure, which is filled with gas that is contiguous with the headspace (collectively forming a first gas body). The other electrode is adjacent to another gas capillary structure, which is filled with gas that is contiguous with the headspace (collectively forming a second gas body).

FIG. 25 depicts a schematic cross-sectional view of a further example electro-synthetic or electro-energy cell in which one electrode has an attached or incorporated gas capillary or gas handling structure, which extends through the liquid electrolyte above the electrode to a headspace.

FIG. 26 depicts a schematic cross-sectional view of a further example electro-synthetic or electro-energy cell in which a gas capillary or gas handling structure is filled with gas that is contiguous with the headspace gas (collectively forming a first gas body) and the other electrode contacts a second gas body only at its top (in the headspace).

FIG. 27 depicts a schematic cross-sectional view of a further example electro-synthetic or electro-energy cell in which the other electrode also has an attached or incorporated gas capillary or gas handling structure, which extends through the liquid electrolyte above the other electrode to a headspace. The gas capillary or gas handling structure is filled with a gas that is contiguous with the headspace gas (collectively forming a second gas body).

FIG. 28 depicts a schematic cross-sectional view of a further example electro-synthetic or electro-energy cell in which one electrode has an attached or incorporated gas capillary or gas handling structure which releases bubbles/volumes of gas through the liquid electrolyte, and the other electrode has an attached or incorporated gas capillary or gas handling structure which releases bubbles/volumes of gas through the liquid electrolyte.

FIG. 29 depicts a schematic cross-sectional view of a further example electro-synthetic or electro-energy cell in which one electrode has an attached or incorporated gas capillary or gas handling structure which releases bubbles/volumes of gas through the liquid electrolyte, and the other electrode has an attached or incorporated gas capillary or gas handling structure which releases bubbles/volumes of gas through the liquid electrolyte.

FIG. 30 depicts a schematic cross-sectional view of a further example electro-synthetic or electro-energy cell in which a first gas body is in gaseous communication with an external conduit and external gas storage system, and a second gas body is in gaseous communication with an external conduit and external gas storage system.

FIG. 31 depicts a schematic cross-sectional view of a further example electro-synthetic or electro-energy cell in which a gas capillary or gas handling structure receives bubbles/volumes of gas through the liquid electrolyte along a first pathway from an external gas conduit, and another gas capillary or gas handling structure receives bubble/volumes of gas through the liquid electrolyte along a second pathway from an external gas conduit.

FIG. 32 depicts a schematic cross-sectional view of a further example electro-synthetic or electro-energy cell in which a gas capillary or gas handling structure receives bubbles/volumes of gas through the liquid electrolyte along a first pathway from an external gas conduit, and another gas capillary or gas handling structure receives bubble/volumes of gas through the liquid electrolyte along a second pathway from an external gas conduit.

FIG. 33 depicts a schematic cross-sectional view of a further example electro-synthetic or electro-energy cell in which one electrode has an attached or incorporated gas capillary or gas handling structure that contains a first gas body 125 within it that is in gaseous communication with an external conduit and external gas storage system, and the other electrode has an attached or incorporated gas capillary or gas handling structure that contains a second gas body within it and is in gaseous communication with an external conduit and external gas storage system.

FIG. 34 depicts a schematic cross-sectional view of a further example electro-synthetic or electro-energy cell in which gas generation by the electrodes dynamically produce the gas bodies associated with the respective electrodes, each of which gas bodies are separately in gaseous communication with an external conduit and external gas storage system.

FIG. 35 depicts a schematic cross-sectional view of a further example electro-synthetic or electro-energy cell that exhibits one or more of a set of physical attributes characteristic of an ‘independent pathway cell’.

### DETAILED DESCRIPTION

The following modes, features or aspects, given by way of example only, are described to provide a more precise understanding of the subject matter of a preferred embodiment or embodiments.

### Definitions

A ‘reservoir’ is a part of an apparatus in which liquid is held. A ‘reactant’ is a chemical material that is consumed during an electrochemical reaction. A ‘product’ is a chemical material that is produced during an electrochemical reaction. A ‘liquid electrolyte’ is a liquid containing ions in solution that has the capacity to conduct electricity. A ‘conduit’ is a channel, a tube, a chamber, or a trough for conveying a fluid. A ‘manifold’ is one or more pipes, one or more tubes, one or more chambers, or one or more channels with multiple openings, for conveying a fluid. ‘Room temperature’ is defined as 21° C.

A ‘liquid-gas’ cell is defined as an electrochemical cell that has at least one liquid-phase reactant or product, and at least one gas-phase reactant or product.

An ‘electro-energy cell’ is an electrochemical cell that generates electrical power continually or continuously, over indefinite periods of time, for use outside of the cell. Electro-energy cells may require a constant external supply of reactants during operation. The products of the electrochemical reaction may also be constantly removed from such cells during operation. An electro-energy cell may be a liquid-gas cell. An example of an electro-energy cell is a hydrogen-oxygen fuel cell. This example is also a liquid-gas cell.

An ‘electro-synthetic cell’ is an electrochemical cell that manufactures one or more chemical materials continually or continuously, over indefinite periods of time, for use outside the cell. The chemical materials may be in the form of a gas, liquid, or solid. Like an electro-energy cell, an electro-synthetic cell may also require a constant supply of reactants and a constant removal of products during operation. Electro-synthetic cells may generally further require a constant input of electrical energy during operation. An electro-synthetic cell may be a liquid-gas cell. An example of an electro-synthetic cell is a water electrolysis cell. This example is also a liquid-gas cell.

Electro-energy and electro-synthetic cells differ from other types of electrochemical cells, such as batteries, sensors and the like, in that they do not incorporate within the cell body all/some of the reactants they require to operate, nor all/some of the products they generate during operation. These may, instead, be constantly brought in from, or removed to the outside of the cell during operation. For example, electro-energy cells are distinguished from galvanic cells in that galvanic cells store their reactants and products within the cell body. Unlike a battery, an electro-energy cell does not store chemical or electrical energy within it. Similarly, while some electrochemical sensors may consume reactants and generate products in limited quantities during the sensing operation, all/some of these are stored within the cell body itself.

A ‘zero-gap’ electrochemical cell is a cell in which there is no gap between the electrodes and the inter-electrode spacer. That is, in a ‘zero-gap’ cell, the electrodes are tightly sandwiched against, or abut, opposite sides of the inter-electrode spacer.

A ‘porous material’ is a solid material containing open space (‘void’ space) not occupied by the main framework of atoms or molecules that make up the structure of the solid.

The ‘porosity’ of a porous material is defined as the ratio of the volume of void space divided by the total volume of the porous material, expressed as a percentage.

A ‘capillary’ or a ‘pore’ is a minute structure within a porous material through which a liquid or gas may pass.

The ‘pore diameter’ of a pore within a porous material is the idealised diameter of the pore.

The ‘average pore diameter’ of pores within a porous material is the average idealised diameter of the pores present in the porous material, by number, as measured using a gas porometer.

‘Capillary action’ involves liquids being drawn into, held in and induced to flow in narrow spaces without the assistance of, or even in opposition to, external forces like gravity. It can be seen in the drawing up and holding of liquids between the hairs of a paint brush, in a thin tube, or in porous materials like paper or plaster. Such capillary-induced action is typically driven by intermolecular forces between the liquid and the surrounding solid surfaces. Within porous materials, capillary action occurs because of the combination of surface tension (which is created by cohesion within the liquid) and attractive forces between the liquid and the container wall. Once drawn up, the liquids may typically be held indefinitely at up to an elevated height, known as the maximum column height.

Capillary pressure is the external pressure that needs to be applied to wholly counteract the capillary action. That is, it is the pressure that, if exerted upon a liquid drawn up by a capillary action, will cause the liquid to return to the location it would have occupied if the capillary action had not occurred. Capillary pressure may also be considered to be the pressure with which such a liquid is held within the pores or capillaries of a material that exerts the capillary action.

The ‘capillary pressure’ of a porous material containing liquid, is defined as the gas pressure required to push the liquid out of the average diameter capillaries within the porous material, as measured using a gas porometer.

The ‘bubble point’ of a porous material containing liquid, is defined as the gas pressure required to push the liquid out of the largest capillaries within the porous material, as measured using a gas porometer.

The ‘porous capillary spacer’ of example embodiments is a porous material that uses a capillary action to draw in and maintain a column height of liquid electrolyte within the porous capillary spacer itself, where the liquid electrolyte forming the column height is confined within the volume of the porous capillary spacer and displays a capillary pressure. It should be understood the ‘porous capillary spacer’ alternatively can be described as: ‘a porous spacer’, ‘a porous electrode spacer’, ‘a porous capillary electrode spacer’, ‘a porous spacer with fluidic pathways’, ‘a porous electrode spacer with fluidic pathways’, ‘a porous capillary separator’, ‘a porous separator’, ‘a porous electrode separator’, ‘a porous capillary electrode separator’, ‘a porous separator with fluidic pathways’, or ‘a porous electrode separator with fluidic pathways’.

‘Column height’ is defined as the ‘height’ of a column of liquid confined within a porous capillary spacer by capillary action, including during operation of an example embodiment cell. The term ‘height’ is defined as the height above the surface of a reservoir of liquid into which the porous capillary spacer is dipped. If the porous capillary spacer is not dipped into a reservoir of liquid, then it is defined as the height above the bottom end (distal end) of the porous capillary spacer.

‘Maximum column height’ is defined as the highest ‘height’ of a column of liquid that can be maintained within a porous capillary spacer by capillary action when the porous capillary spacer itself has hypothetically infinite height. The term ‘height’ is defined as the height above the surface of a reservoir of liquid into which the porous capillary spacer is dipped. If the porous capillary spacer is not dipped into a reservoir of liquid, then it is defined as the height above the bottom end (distal end) of the porous capillary spacer.

It should be noted that the actual ‘column height’ of a liquid in a porous capillary material may be limited by the height of the porous capillary spacer where it reaches the top of an example embodiment cell. That is, the ‘column height’ may be less than the ‘maximum column height’ if the porous capillary material itself has a height that is less than the ‘maximum column height’. In example embodiment cells it may be important for the ‘maximum column height’ to exceed the height of the cell. This may be necessary to ensure that the porous capillary spacer is fully filled with liquid at all points within the cell. This may, in turn, be needed to prevent gas crossover in the case (see definition below for ‘gas crossover’).

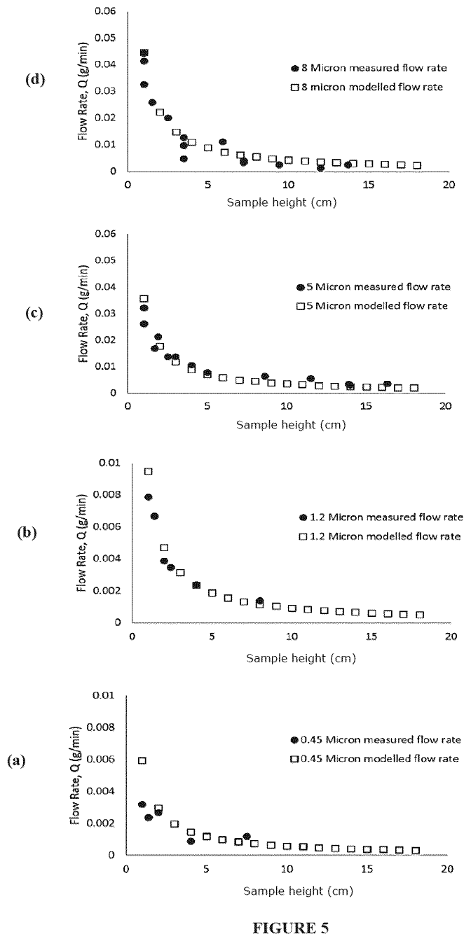

‘Flow rate’ is defined as the mass of liquid per unit time that flows through a 1 cm wide strip of porous capillary spacer, fully imbued with liquid, under the influence of capillarity only. Because of gravity, the ‘flow rate’ typically declines with increasing height of the porous capillary spacer. The ‘flow rate’ at a particular ‘height’ is defined as the flow rate at that height above the surface of a reservoir of liquid into which the porous capillary spacer is dipped, as measured using the technique employed for collecting the measured data in FIG. 5. If the porous capillary spacer is not dipped into a reservoir of liquid, then it is defined as the ‘flow rate’ at that height above the bottom end (distal end) of the porous capillary spacer.

‘Diffusion’ is the spontaneous net movement of liquid-phase or gas-phase molecules from a region of higher concentration to a region of lower concentration, with the tendency to equalize the concentrations in both regions.

‘Osmosis’ is the spontaneous movement of water molecules from a region of low solute concentration to a region of high solute concentration, typically under circumstances where the solute itself is not as free to move in the opposite direction (e.g. when there is a membrane that is not permeable or poorly permeable to solute between the two regions).

An electrochemical cell is ‘self-regulating’ when the rate of supply of reactants and/or the rate of removal of products from the reaction zone at the electrodes, inherently adjusts itself according to, and in response to the rate of the electrochemical reaction. That is, a faster rate of electrochemical reaction spontaneously leads to a faster supply of reactants and removal of products, while a slower electrochemical reaction rate yields a slower supply of reactants and removal of products to/from the reaction zone.

The term ‘counter multiphase flow’ refers to a molecular-level flow inside an electrochemical cell in which a chemical species having one phase of matter (e.g. liquid) moves (flows) in a direction and at a location that opposes and counters the movement (flow) of another chemical species having a different phase of matter (e.g. gas). In interfering with and hindering each other, such countervailing multiphase flows may create inefficiencies that require energy to overcome.

An ‘independent pathway cell’ is defined as a gas-liquid electrochemical cell that provides at least one pathway that is separate and independent for the movement (flow) of each individual liquid-phase and gas-phase reactant and product within the cell, wherein such pathways do not interfere with or hinder each other.

‘Electrode compression’ or ‘electrode pressure’ herein refers to the pressure with which two electrodes are compressed against opposite sides of an intervening porous capillary spacer. Such compression may be delivered by springs or washers on the tie rods compressing the cell or cell stack, or by a spring fitting within the cell.

A ‘gas capillary structure’ is a structure that employs a capillary effect to spontaneously draw in gas from a liquid and exhibits a measurable capillary pressure associated with the gas uptake. A capillary pressure within a gas capillary structure is herein defined as ‘measurable’ if repeated measurements and calculations reproducibly produce a capillary pressure that is greater than 10 mbar.

A ‘gas handling structure’ is a structure having physical properties that facilitate the movement of gases without necessarily harnessing a gas capillary effect.

Gas diffusion layers and porous transport layers, is terminology that may be used in other fields of electro-engineering. It is to be understood that ‘gas diffusion layers’ and/or ‘porous transport layers’, and/or structures of such types, may be ‘gas capillary structures’ if they spontaneously draw in gas from a liquid and exhibits a measurable capillary pressure associated with the gas uptake. If they do not, but they assist gas movement/transport to or from the electrodes, they may be ‘gas handling structures’.

An electrode is herein defined as being ‘bubble-free’ if, during operation, no bubbles can be discerned to form on at least a portion of its surface using the human eye.

The ‘energy efficiency’ of an electro-synthetic cell is herein defined as the net energy present within a single unit output of a chemical product, divided by the net energy consumed by the cell to produce that same unit output of the chemical product, expressed as a percentage. The ‘energy efficiency’ of an electro-energy cell is herein defined as the energy produced by the cell per unit time, divided by the maximum theoretical energy that may be produced by the cell per unit time, expressed as a percentage.

‘Gas crossover’ is the phenomenon where a portion of a first gas body on a first side of a porous capillary spacer containing liquid electrolyte, migrates through the porous capillary spacer, into a second gas body on the other side of the porous capillary spacer. ‘Benchmark gas crossover’ is defined as the volume of the first gas present in the second gas body, divided by the volume of the second gas body, expressed as a percentage, after 30 min under the condition that the cell operates at a fixed 150 mA/cm² at room temperature and atmospheric pressure.

### Preferred Embodiment Electro-Synthetic or Electro-Energy Cells

Example Cell with a Separate Reservoir, not in Contact with Either Electrode

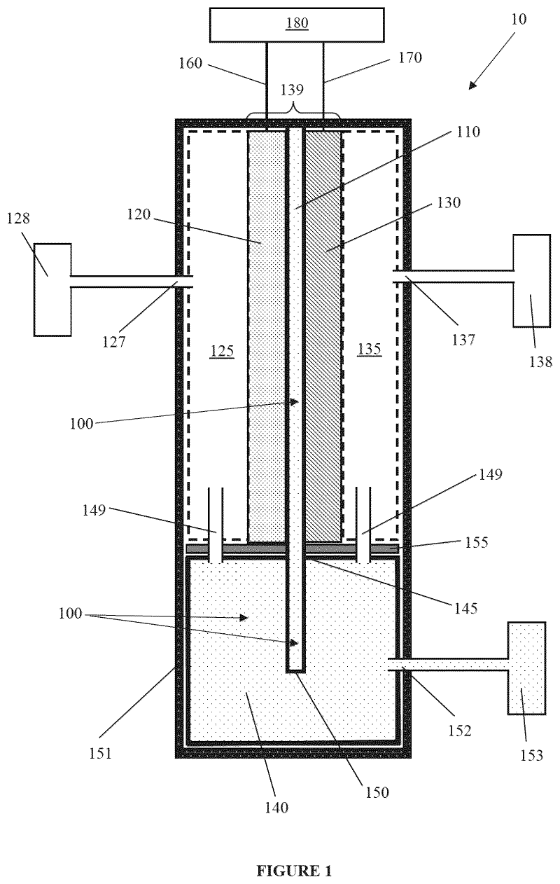

FIG. 1 schematically depicts the structure of a preferred embodiment electro-synthetic or electro-energy cell 10. Preferably, cell 10 is a zero-gap electro-synthetic or electro-energy cell. Preferably, cell 10 has a reservoir 140 for containing a liquid electrolyte; a first gas diffusion electrode 120 positioned outside of the reservoir; a second electrode 130 positioned outside of the reservoir; and a porous capillary spacer 110 positioned between the first gas diffusion electrode 120 and the second electrode 130, the porous capillary spacer 110 having an end that extends into the reservoir; wherein, the porous capillary spacer is able to fill itself with the liquid electrolyte 100 when the end of the porous capillary spacer 150 is in liquid contact with the liquid electrolyte 100 in the reservoir 140. The assembly of first electrode 120, porous capillary spacer 110, and second electrode 130 comprises the ‘electrode-spacer-electrode’ assembly 139 of the cell 10.

The porous capillary spacer comprises a porous material capable of using a capillary action to draw in and maintain a column height of liquid electrolyte within itself, where the liquid electrolyte forming the column height is confined within the volume of the porous capillary spacer and displays a capillary pressure. It should be understood the ‘porous capillary spacer’ alternatively can be described as: ‘a porous spacer’, ‘a porous electrode spacer’, ‘a porous capillary electrode spacer’, ‘a porous spacer with fluidic pathways’, ‘a porous electrode spacer with fluidic pathways’, ‘a porous capillary separator’, ‘a porous separator’, ‘a porous electrode separator’, ‘a porous capillary electrode separator’, ‘a porous separator with fluidic pathways’, or ‘a porous electrode separator with fluidic pathways’.

Preferably, an end of the porous capillary spacer is positioned within a reservoir. Preferably, a reservoir 140 containing, or able to contain, liquid electrolyte 100 is provided and an end 150, e.g. a distal end, (or equivalently an end part or a distal part) of the electrolyte-filled porous capillary spacer 110 is positioned in, i.e. dipped into the reservoir 140, which may contain liquid electrolyte 100. Preferably, the reservoir is configured to be filled with the liquid electrolyte and the end of the porous capillary spacer is configured to contact the liquid electrolyte. Preferably, the porous capillary spacer draws in and maintains a column height of the liquid electrolyte within the porous capillary spacer by capillary action. Preferably, the maximum column height of the liquid electrolyte is at least equal to or greater than the height of the first gas diffusion electrode. Preferably, the porous capillary spacer is configured to transport the liquid electrolyte along the porous capillary spacer at least by capillary action. Preferably, the cell is configured to include filling the porous capillary spacer with the liquid electrolyte from the reservoir by at least capillary action. Optionally, the cell is configured to include filling the porous capillary spacer with the liquid electrolyte before the end of the porous capillary spacer is positioned within the reservoir.

Preferably, the cell 10 may be configured such that when the reservoir 140 contains the liquid electrolyte, the first gas diffusion electrode 120 is separated from the liquid electrolyte 100 in the reservoir 140. Preferably, the cell 10 may further be configured such that when the reservoir 140 contains the liquid electrolyte 100, the second electrode 130 is separated from the liquid electrolyte 100 in the reservoir 140. Preferably, the first gas diffusion electrode 120 and the second electrode 130 are spaced apart from the reservoir 140. That is, preferably the liquid electrolyte 100 contained within reservoir 140 may not be in direct contact with either the first electrode 120 or the second electrode 130. Preferably, an area of direct contact between the porous capillary spacer 110 and the first gas diffusion electrode 120 is outside of the reservoir 140, and an area of direct contact between the porous capillary spacer 110 and the second electrode 130 is outside of the reservoir 140. Preferably, the cell involves contact of the first gas diffusion electrode and the second electrode with the liquid electrolyte after having been transported along the porous capillary spacer.

Optionally, but preferably, the end 150 of porous capillary spacer 110 extends beyond the first electrode 120 and the second electrode 130. In this example, the end 150 of porous capillary spacer 110 may extend lengthwise past an end of the first electrode 120 (e.g. a distal end of the first electrode 120) and past an end of the second electrode 130 (e.g. a distal end of the second electrode 130), so that the end 150 of porous capillary spacer 110 extends into liquid electrolyte 100 in reservoir 140. The reservoir 140 can be a cavity in a body, chamber, tank, housing, pipe, conduit, or the like suitable for containing the liquid electrolyte 100. One or more reservoirs could be used and could in one example supply liquid electrolyte to the same porous capillary spacer.

Preferably, the porous capillary spacer comprises a plurality of pores that provide a fluidic pathway between the first gas diffusion electrode, the second electrode and the reservoir. Preferably, the porous capillary spacer is fluidically connected to the reservoir. Preferably, during operation, the porous capillary spacer remains filled with liquid electrolyte.

Optionally, the porous capillary spacer 110 is filled with the liquid electrolyte 100 before the end 150 of the porous capillary spacer 110 is extended within the reservoir 140. Preferably, the cell is configured such that during operation the liquid electrolyte 100 contacts the first gas diffusion electrode 120 and the second electrode 130 only after first being transported along the porous capillary spacer 110 from the reservoir 140. Preferably, the cell is configured such that during operation a surface area covered by the liquid electrolyte within the porous capillary spacer is at least equal to or greater than a surface area of the first gas diffusion electrode facing the porous capillary space. Preferably, the first gas diffusion electrode is configured to generate a first gas to form a first gas body, a first side of the porous capillary spacer is adjacent a first side of the first gas diffusion electrode, a second side of the porous capillary spacer is adjacent a first side of the second electrode, and a second side of the first gas diffusion electrode is adjacent the first gas body.

During operation of the cells, for example cell 10, at the molecular-level, liquid-phase materials produced by or consumed by the electrochemical reaction spontaneously migrate to or from the reaction zone at the electrodes, in the liquid electrolyte, inside the inter-electrode spacer, along the length of the inter-electrode spacer to or from the reservoir. That is, the liquid-phase reactants and products undertake ‘in-plane’ migration in the liquid electrolyte, along the length of the inter-electrode spacer to or from the reservoir. The liquid-phase materials do so under capillary and/or diffusion and/or osmotic control, which is ‘self-regulated’ by the concentration differentials present in the liquid electrolyte. As a result of these self-regulated migrations, liquid-phase reactants may be replenished to the cell by adding fresh liquid-phase reactants to the reservoir, and liquid-phase products may be removed from the cell by removing them from the reservoir. Preferably, the cell is configured such that during operation liquid-phase reactants or products of an electrochemical reaction in the cell follow liquid-phase pathways within the liquid electrolyte inside the porous capillary spacer. Preferably, during the electrochemical reaction, the liquid electrolyte within the porous capillary spacer facilitates migration of one or more liquid-phase materials along a length of the porous capillary spacer. Preferably, the porous capillary spacer is configured to transport the liquid electrolyte along the porous capillary spacer by capillary action, diffusion and/or osmotic action. Preferably, the migration of the one or more liquid-phase materials along the length of the porous capillary spacer is under control of liquid-phase capillary action, diffusion and/or osmotic action. Preferably, the cell is configured such that during operation the cell is self-regulated by capillary action, diffusion and/or osmotic action occurring within the porous capillary spacer. Preferably, the electrochemical reaction is self-regulating in the electro-synthetic or electro-energy cell. Preferably, movement of liquid-phase materials out of a cross-plane axis is self-regulated by the composition of the liquid electrolyte in the reservoir. Preferably, the liquid-phase capillary, diffusion and/or osmotic actions, act within the porous capillary spacer to:
(i) continuously replenish one or more liquid-phase materials that are consumed within the liquid electrolyte; or
(ii) continuously remove one or more liquid-phase materials that are produced within the liquid electrolyte.

The cell 10 may optionally be enclosed in a liquid-impermeable and gas-impermeable external housing 151. The external housing 151 may incorporate a liquid conduit 152, or more than one liquid conduit, (i.e. the external housing 151 providing at least one external liquid conduit 152) that forms an inlet/outlet or separate inlet(s) and outlet(s) (not illustrated) for the reservoir 140, to allow for the ingress or egress from outside the cell, of replenishing or excess liquid-phase reactants and/or products, and/or liquid electrolyte 100. That is, the liquid electrolyte, along with associated liquid-phase reactants and/or products of the reaction, is transported into or out of the reservoir 140 via at least one external liquid conduit 152. The liquid conduit 152 may be directly connected to or in direct or indirect fluid communication with a liquid storage system 153, preferably an external liquid storage system 153, that may contain the replenishing or excess liquid-phase reactants and/or products, or liquid electrolyte 100. That is, at least one external liquid conduit 152 is in direct or indirect fluid communication with an external liquid storage system 153 for externally storing/supplying/removing liquid electrolyte 100 and/or liquid-phase reactants or products. Preferably, the cell further includes an external housing for the cell, the external housing providing at least one external liquid conduit. Preferably, the cell includes an external housing for the cell, the external housing providing at least one external liquid conduit, wherein the liquid electrolyte is transported into or out of the reservoir via the at least one external liquid conduit. Preferably, the cell is configured such that during operation the liquid electrolyte, liquid-phase reactants and/or products of an electrochemical reaction in the cell, are transported into or out of the cell via the at least one external liquid conduit, and the at least one external liquid conduit is in fluid communication with an external liquid storage system.

The reservoir 140 may further include an opening 145, through which porous capillary spacer 110 passes. Opening 145 could be a slit, gap, orifice or the like. Reservoir 140 could be formed of two halves, such as two cavities in different bodies, that are abutted together to form reservoir 140, with each body including a recess or cut-out through which the porous capillary spacer 110 can pass and be placed in liquid contact with the liquid electrolyte 100 within reservoir 140. The housing or walls of reservoir 140 may prevent liquid electrolyte 100 in the reservoir 140 from directly contacting the first electrode 120 or the second electrode 130. Thus, as noted above, liquid electrolyte 100 may only be able to contact the first electrode 120 and the second electrode 130 after the liquid electrolyte 100 has first been transported along porous capillary spacer 110 from the reservoir 140. The area of direct contact between the porous capillary spacer 110 and the first electrode 120 may be outside of the reservoir 140. Likewise, the area of direct contact between the porous capillary spacer 110 and the second electrode 130 may be outside of the reservoir 140. In one aspect, the first electrode 120 and the second electrode 130 are spaced apart from the reservoir 140. In one aspect, the first electrode 120 and the second electrode 130 are physically separated from the reservoir 140. In one aspect, the first electrode 120 and the second electrode 130 are positioned remote to the reservoir 140. In one aspect, the first electrode 120 and the second electrode 130 are positioned completely outside of the reservoir 140.

In one example, an additional barrier layer 155 can be optionally provided to assist in preventing liquid electrolyte 100 in the reservoir 140 from directly contacting the first electrode 120 and the second electrode 130. The barrier layer 155 includes a gap or an opening 145 through which porous capillary spacer 110 passes. Barrier layer 155 may be integrated as part of reservoir 140 or can be provided as a distinct separating layer. Barrier layer 155 may be formed of a material that is impermeable to liquid electrolyte 100. Preferably, the reservoir includes an opening through which the porous capillary spacer passes.

As a result of the presence of: (i) a single opening, slit, gap or orifice 145, or the like, and/or (ii) additional barrier layer 155 containing only a single opening, which is completely filled with the porous capillary spacer 110, the cell may be immune or partially immune to orientation effects. That is, if there is only a single opening at the end of the reservoir nearest to the electrodes, and that opening is filled with the porous capillary spacer 110, and the reservoir is mostly filled with liquid electrolyte 100, then it may be possible to successfully operate the cell in any orientation, including, for example, with the reservoir at the top of the cell.

Optionally, the second electrode is a second gas diffusion electrode. Preferably, the second gas diffusion electrode is configured to generate a second gas to form a second gas body, and a second side of the second gas diffusion electrode is adjacent the second gas body. Preferably, the second electrode is configured to generate a second gas and be in direct contact with a second gas body comprising the second gas. Thus, in the example case where both the first electrode 120 and the second electrode 130 are gas diffusion electrodes, two gas bodies, first gas body 125 comprising a first gas (associated with first electrode 120) and second gas body 135 comprising a second gas (associated with second electrode 130), are preferably present on opposite sides of the electrolyte-filled porous capillary spacer 110. A first side of the porous capillary spacer 110 is adjacent a first side of the first electrode 120. A second side of the porous capillary spacer 110 is adjacent a first side of the second electrode 130. A second side of the first electrode 120 is adjacent the first gas body 125. A second side of the second electrode 130 is adjacent the second gas body 135. Preferably, the cell is configured such that during operation at least part of the second side of the first gas diffusion electrode is in direct gas-phase contact with the first gas body; and at least part of the second side of the second gas diffusion electrode is in direct gas-phase contact with the second gas body. That is, at least part of the second side of the first electrode 120 is in direct gas-phase contact with the first gas body 125. At least part of the second side of the second electrode 130 is in direct gas-phase contact with the second gas body 135.

At the molecular-level, gas-phase materials produced by or consumed by the electrochemical reaction migrate in an orthogonal (90°) direction to the liquid-phase materials along continuous gas phase pathways that are separate from and do not interfere with the liquid-phase pathways. That is, gaseous molecules or atoms migrate to/from their respective macroscopic gas bodies through the relevant interface/s to/from the gas diffusion electrode(s) and the inter-electrode spacer, i.e. into or out of the reaction zone inside or about the inter-electrode spacer. These interfaces may, additionally, be engineered to modify the rate of gas migration (e.g. by the incorporation of gas capillary or gas handling structures). Such migrations preferably occur under capillary and/or diffusion control along continuous gas-phase pathways connecting each electrode to each gas body. For this reason, gas-phase materials (reactants or products) also exhibit self-regulation. Because the pathway of migration of each gas does not overlap with, or interfere with that of the other gas, or with the pathway of liquid migration, gas movements are independently self-regulated, separately to the self-regulation of the liquid movements. That is, the different gas- and liquid-phase reactants and products are each subject to their own self-regulation, which does not interfere with the movements of the other reactants and products.

Preferably, the gas capillary structures facilitate migration of gases into or out of the cross-plane axis under the influence of gas-phase capillarity. Examples of gas capillary structures include, but are not limited to,
i. porous degassing plates,
ii. porous hydrophobic membranes, and/or
iii. porous or narrowly pored hydrophobic structures and/or other gas capillary structures, which spontaneously draw in gas from a liquid and exhibit a measurable capillary pressure associated with gas uptake.

Preferably, the gas handling structures facilitate migration of gases into or out of the cross-plane axis. Examples of gas handling structures include, but are not limited to,
(a) materials or structures upon which gases are favoured to selectively coalesce and migrate, such as those having surface regions with low surface energy, for example containing or comprising:
   1. materials with low surface energy, like polytetrafluoroethylene (PTFE), fluorinated polymers, Nafion®, and the like; or
   2. surface structures with low surface energy, such as nanoscale superhydrophobic structures, and the like.
   or;
(b) materials or structures having strongly aerophobic surface regions that encourage the detachment of coalesced gases, such as superhydrophilic or ‘superwetting’ materials or structures,
   which facilitate or accelerate the movement of gas without involving a gas capillary effect with a measurable capillary pressure.

Preferably, bodies of gas present within such gas capillary structures or gas handling structures are, or become contiguous with adjacent bodies of gas, such as the first gas body or the second gas body. Optionally, bodies of gas present within such gas handling structures are independently in gaseous communication with an external gas conduit and/or and external gas storage system.

Preferably, the cell includes a gas capillary structure positioned at least partially in or at the second side of the first gas diffusion electrode. Preferably, the cell includes a gas handling structure positioned at least partially in or at the second side of the first gas diffusion electrode. Preferably, the cell includes a second gas capillary structure positioned at least partially in or at the second side of the second gas diffusion electrode. Preferably, the cell includes a second gas handling structure positioned at least partially in or at the second side of the second gas diffusion electrode. Preferably, the cell includes a gas handling structure positioned: between the first gas diffusion electrode and the porous capillary spacer, in the first gas diffusion electrode, at or near the first gas diffusion electrode, and/or in a portion of the first gas diffusion electrode. Preferably, the cell includes a second gas handling structure positioned: between the second gas diffusion electrode and the porous capillary spacer, in the second gas diffusion electrode, at or near the second gas diffusion electrode, and/or in a portion of the second gas diffusion electrode.

Preferably, the cell is configured such that during operation the first gas of the first gas body follows a first gas-phase pathway to the first gas diffusion electrode, and the first gas-phase pathway is separate to the liquid-phase pathways. Preferably, the cell is configured such that during operation the second gas of the second gas body follows a second gas-phase pathway to the second gas diffusion electrode, and the second gas-phase pathway is separate to the liquid-phase pathways. Preferably, the migration pathways of liquid-phase materials and gas-phase materials into and out of a cross-plane axis are differently oriented. Preferably, the cell is configured such that during operation a contiguous gas-phase pathway exists between an active surface of the first gas diffusion electrode in a cross-plane axis and the first gas body, whereby visible gas bubbles of the first gas are not produced on at least part of the active surface of first gas diffusion electrode. Preferably, the cell is configured such that during operation gas bubbles are not visible on at least a part of the first gas diffusion electrode or on at least a part of the second gas diffusion electrode. Preferably, the cell is configured such that during operation the first gas diffusion electrode is covered with a film of liquid electrolyte that is less than 0.125 mm thick, preferably less than 0.11 mm thick, and more preferably less than 0.10 mm thick. Preferably, the cell is configured such that during operation a contiguous gas-phase pathway exists between an active surface of the second gas diffusion electrode in a cross-plane axis and the second gas body, whereby visible gas bubbles of the second gas are not produced on at least part of the active surface of second gas diffusion electrode. Preferably, the cell is configured such that during operation the second gas diffusion electrode is covered with a film of liquid electrolyte that is less than 0.125 mm thick, preferably less than 0.11 mm thick, and more preferably less than 0.10 mm thick.

The first gas (associated with first electrode 120) may therefore be a reactant consumed at the first electrode 120, or a product produced by the first electrode 120. During operation of the cell, first gas body 125 will need to be re-filled with the first gas (if a reactant), or first gas will need to be removed from first gas body 125 (if a product). The second gas (associated with second electrode 130) may be a reactant consumed at the second electrode 130, or a product produced by the second electrode 130. During operation of the cell, second gas body 135 will need to be re-filled with the second gas (if a reactant), or second gas will need to be removed from second gas body 135 (if a product).

First gas within first gas body 125 can, in various examples, be connected to and in gaseous communication with, contained in or transported in or out of the cell by at least one external first gas conduit 127, which may be one or more pipes, one or more conduits, a common gas manifold, a chamber, etc., that passes through the external housing 151. Second gas in second gas body 135 can, in various examples, be connected to and in gaseous communication with, contained in or transported by at least one external second gas conduit 137, which may be one or more pipes, one or more conduits, a common gas manifold, a chamber, etc., that passes through the external housing 151. At least one external first gas conduit 127 and/or at least one external second gas conduit 137 can be provided in addition to at least one external liquid conduit 152 or can be provided without at least one external liquid conduit 152, or may not be included and the cell 10 might only include at least one external liquid conduit 152. The external first gas conduit 127 may be connected to or be in gaseous communication with a first gas storage system 128, preferably an external first gas storage system 128. The external second gas conduit 137 may be connected to or be in gaseous communication with a second gas storage system 138, preferably an external second gas storage system 138. The external first gas storage system 128 and external first gas conduit 127, i.e. associated pipes, conduits, manifolds, chambers, may allow for a first gas in the first gas body 125 to be supplied to, or removed from, the region adjacent the first electrode 120. The external second gas storage system 138 and external second gas conduit 137, i.e. associated pipes, conduits, manifolds, chambers, may allow for a second gas in the second gas body 135 to be supplied to, or removed from, the region adjacent the second electrode 130. That is, external housing 151 may provide at least one external first gas conduit 127 and/or external housing 151 may provide at least one external second gas conduit 137. The first gas (if present) may be transported into or out of the first gas body 125 via the at least one external first gas conduit 127 and/or the second gas (if present) may be transported into or out of the second gas body 135 via the at least one external second gas conduit 137. In other words, the at least one external first gas conduit 127 is in gaseous communication with external first gas storage system 128 for externally storing the first gas and/or the at least one external second gas conduit 137 is in gaseous communication with external second gas storage system 138 for externally storing the second gas.

Generally, a separate supply system and a separate removal system are externally connected to the cell 10 to independently supply each reactant to the cell and to remove each product from the cell 10 during operation. Each such system preferably supplies reactants to or removes products from a separate gas body or a liquid reservoir within the cell that, in turn, supplies the reactant to or removes the product from a relevant electrode in the cell.

Preferably, the cell includes an external housing, the external housing providing at least one external first gas conduit, wherein a first gas is transported into or out of a first gas body via the at least one external first gas conduit. Preferably, the external housing provides at least one external gas conduit that is in gaseous communication with the first gas body. Preferably, the at least one external first gas conduit is in gaseous communication with an external first gas storage system. Preferably, the external housing further providing at least one external first gas conduit, and configured such that during operation the first gas is transported into or out of the first gas body via the at least one external first gas conduit. Preferably, there is further included an external housing for the cell, the external housing providing at least one external first gas conduit, wherein a first gas is transported into or out of a first gas body via the at least one external first gas conduit. Thus, for example, an external first reactant source (that is external to cell 10) supplies a first reactant to first electrode 120 via one or more first reactant pipes or conduits. Optionally, the external housing further providing at least one external second gas conduit, and configured such that during operation the second gas is transported into or out of the second gas body via the at least one external second gas conduit. Preferably, the at least one external second gas conduit is in gaseous communication with an external second gas storage system. Preferably, there is further included the external housing providing at least one external second gas conduit, wherein a second gas is transported into or out of a second gas body via the at least one external second gas conduit. Optionally, an external second reactant source supplies a second reactant to first electrode 120 or to second electrode 130 via one or more second reactant pipes or conduits. Furthermore, optionally, an external further reactant source supplies a further reactant to first electrode 120 or to second electrode 130 via one or more further reactant pipes or conduits. Additionally, for example, an external first product reservoir or store (that is external to cell 10) receives a first product produced at first electrode 120 via one or more first product pipes or conduits. Optionally, an external second product reservoir or store receives a second product produced at first electrode 120 or at second electrode 130 via one or more second product pipes or conduits. Furthermore, optionally, an external further product reservoir or store receives a further product produced at first electrode 120 or at second electrode 130 via one or more further product pipes or conduits.

Preferably, the liquid electrolyte 100 in the porous capillary spacer 110 and the capillary pressure with which the liquid electrolyte 100 is held within the porous capillary spacer 110, separate the first gas body 125 and the second gas body 135, and prevent the first gas body 125 and the second gas body 135 from being in physical contact with each other, or, at least, minimise the extent to which each contaminates the other. In one example, the porous capillary spacer 110 is filled with the liquid electrolyte 100 before the end 150 of the porous capillary spacer 110 is positioned within the reservoir 140. In another example, the liquid electrolyte 100 contacts the first electrode 120 and the second electrode 130 after first being transported along the porous capillary spacer 110 from the reservoir 140. Preferably, during operation of the cell 10, at least part of the porous capillary spacer 110 adjacent to all of the first electrode 120 and at least part of the porous capillary spacer 110 adjacent to all of the second electrode 130, remain filled with the liquid electrolyte 100. Preferably, when the porous capillary spacer is filled with the liquid electrolyte, the porous capillary spacer is configured to block or hinder the first gas body from mixing with the second gas body and maintains a benchmark gas crossover of less than 2%.

In order to equalise or maintain as near as possible to equal, the pressures of the two gas bodies 125 and 135 and the pressure of the liquid electrolyte 100, pipes, conduits, wells, or chambers 149 may be incorporated into the top of the reservoir 140. Such pipes, conduits, wells, or chambers 149 may provide a direct interface between the respective gas bodies 125 and 135, and the liquid electrolyte in the reservoir 140, thereby ensuring that their pressures are equal. Preferably, the pipes, conduits, wells, or chambers 149 extend some way upward from the top of the reservoir into the gas bodies 125 and 135. This minimizes the likelihood that liquid electrolyte temporarily displaced from the reservoir by transient pressure differentials will spill over into gas chambers occupied by the gas bodies 125 and 135. Additionally, if some liquid electrolyte does spill over into a gas chamber, it will become physically disconnected and separated from the liquid electrolyte in the rest of the reservoir.

Preferably, but not exclusively, the cell is configured such that during operation the first gas body has a pressure of more than 3 bar gauge, preferably more than 4 bar gauge, more preferably more than 5 bar gauge. Preferably, but not exclusively, the cell is configured such that during operation the second gas body has a pressure of more than 3 bar gauge.

In the example case where only one of the first electrode 120 and the second electrode 130 is a gas diffusion electrode, there may be only one gas body present, being first gas body 125 (if the first electrode 120 is a GDE) or being second gas body 135 (if the second electrode 130 is a GDE).

The first electrode 120 and the second electrode 130 are connected to an external electrical circuit 180 by first electrical connection 160 and second electrical connection 170, respectively. The first electrical connection 160 or the second electrical connection 170 or the external electrical circuit 180 itself, preferably penetrate the external housing 151 without compromising its gas- and liquid-impermeable nature. The external electrical circuit 180 may supply electrical energy to the cell 10 (e.g. in the case of an electro-synthetic cell). Alternatively, electrical energy generated by the cell 10 may be supplied to the external electrical circuit 180 (e.g. in the case of an electro-energy cell).

For example, the external circuit may contain a power supply that, in operation, applies a voltage across the first electrode and the second electrode. Numerous examples of power supplies are available commercially, all of which may be used to apply a voltage over their two terminals that may each be separately connected to the first electrode and the second electrode. In another example, the external circuit may contain a power receiving and modulating device, such as a DC-to-AC converter that regulates the power received and generates an external voltage when attached to, for example, the electrodes of an electro-energy cell. Numerous examples of power receiving devices are available commercially, all of which may be used to generate an external voltage when their terminals are separately connected to the first electrode and the second electrode of an electro-energy cell. A range of voltages may be applied by such power supplies, or received by such power receiving devices, for example more than 0.5 V, more than 2 V, more than 5 V, more than 10 V, more than 20 V, more than 50 V, more than 100 V, more than 250 V, more than 500 V, more than 1000 V, more than 5000 V, or more than 10,000 V.

Preferably, the external circuit contains a power supply or a power receiving device capable of applying or generating a voltage across the first gas diffusion electrode and the second electrode.

Further example embodiments encompass an electro-synthetic cell or an electro-energy cell that employs a thin, porous capillary spacer 110 (less than 0.45 mm thick) as an inter-electrode spacer. Preferably, the cell being a zero-gap cell, whereby the porous capillary spacer is less than 0.45 mm thick, preferably less than 0.30 mm thick, and more preferably less than 0.13 mm thick. A non-limiting example of such a thin, porous capillary spacer 110 is a thin, porous polyethersulfone material filter with an average pore diameter of 8 μm supplied by the Pall Corporation. The thin, porous material utilizes capillary effects to draw in and hold a liquid electrolyte within the inter-electrode spacer. Two electrodes are sandwiched against opposite sides of the inter-electrode spacer. At least one or both of the electrodes may be porous to gases, i.e. may be gas diffusion electrodes. The bottom end of the inter-electrode spacer may, optionally, be dipped in a reservoir of liquid electrolyte that may be remote from the electrodes, or the reservoir may be in contact with either, or both of the two electrodes, or the reservoir may be wholly incorporated into the porous capillary spacer. When the two electrodes are both gas diffusion electrodes, the gas diffusion electrodes are in fluid contact with gas bodies on one or both sides of the electrode-spacer-electrode assembly. Sealed (liquid- and/or gas-tight) external conduits and storage volumes that separately connect to the gas bodies and/or the reservoir, supply reactants and remove products during operation of the cell. In other examples, the porous capillary spacer 110 is less than 0.35 mm thick, less than 0.2 mm thick, less than 0.1 mm thick, less than 0.05 mm thick, or less than 0.025 mm thick.

Preferably, an average pore diameter of the porous capillary spacer is more than 2 m and less than 400 μm. Preferably, the average pore diameter of the porous capillary spacer is greater than 4 μm and less than 400 μm, greater than 6 μm and less than 400 μm, greater than 8 μm and less than 400 μm, greater than 10 μm and less than 400 μm, greater than 20 μm and less than 400 μm, or greater than 30 μm and less than 400 μm. Preferably, the average pore diameter of the porous capillary spacer is about 3 μm, about 4 μm, about 5 μm, about 6 μm, about 7 μm, about 8 μm, about 9 μm, or about 10 μm. Preferably, the average pore diameter of the porous capillary spacer is less than 400 μm. Optionally, the porous capillary spacer is more than 60% porous, preferably more than 70% porous, and most preferably more than 80% porous. Preferably, the porous capillary spacer is configured to be filled with liquid electrolyte and to have an ionic resistance of less than 140 mΩ cm² at room temperature. Preferably, the first gas diffusion electrode and the second electrode are compressed against the porous capillary spacer by more than 2 bar, preferably more than 3 bar, more preferably more than 4 bar. Preferably, the first gas diffusion electrode and the second gas diffusion electrode are compressed against the porous capillary spacer by more than 2 bar, preferably more than 3 bar, more preferably more than 4 bar. Preferably, the liquid electrolyte is aqueous, and when the porous capillary spacer is filled with the liquid electrolyte, the liquid electrolyte in the porous capillary spacer flows at a flow rate of more than 0.0014 g water per minute at a height of more than 8 cm.

Preferably, the first gas diffusion electrode and the second electrode each have a side with a geometric surface area of greater than or equal to 10 cm². Preferably, the first gas diffusion electrode includes a metallic mesh, a metallic foam and/or a metallic perforated plate. Preferably, the second gas diffusion electrode includes a metallic mesh, a metallic foam and/or a metallic perforated plate. Preferably, the cell operates using an electrical current through the first gas diffusion electrode and the second electrode of greater than or equal to 1 Amp, preferably greater than or equal to 1.5 Amp, more preferably greater than or equal to 2 Amp, and more preferably greater than or equal to 2.5 Amp. Preferably, the cell is operated continuously for at least 24 hours.

For such an electro-synthetic or electro-energy cell to operate continually or continuously for an indefinite time, the thin porous capillary spacer 110 is preferably capable of, amongst other factors:
i) drawing in and maintaining itself fully filled with liquid electrolyte, to thereby sustain a column height of the liquid electrolyte within the porous capillary spacer that extends to the top of the cell;
ii) providing a flow rate of liquid electrolyte within the porous capillary spacer, that is, preferably, always and under all operating conditions, sufficient to sustain the electrochemical reaction; and
iii) releasing sufficient liquid electrolyte at the interfaces of the porous capillary spacer with the electrodes, to properly wet the electrodes for the reaction under all operating conditions.

Preferably, the cell is an electro-synthetic cell and the electrochemical reaction produces a chemical product that is transported away external to the electro-synthetic cell. Preferably, the cell is an electro-energy cell and the electrochemical reaction produces energy that is transported away external to the electro-energy cell.

Because both the liquid-phase and gas-phase migration pathways are self-regulating, the cell may operate continuously without external management. This constitutes an important advantage over many conventional electro-synthetic or electro-energy cells that may typically require active management.

Example Cell in which the Reservoir Liquid is in Direct Contact with an Electrode

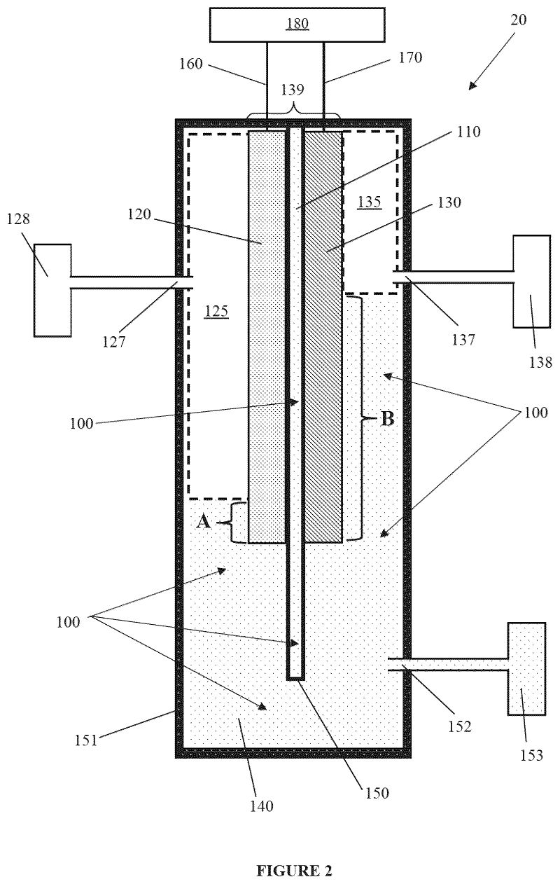

Another embodiment zero-gap electro-synthetic or electro-energy cell 20 is schematically depicted in FIG. 2. Cell 20 may differ from cell 10 insofar as the wall of the reservoir closest to the electrodes may not be present, nor may there be a barrier 155 between the reservoir and the electrodes. Liquid 100 in the reservoir may therefore be in direct contact with one or both electrodes 120 or 130. The extent of contact may be relatively small (e.g. 5-10% of the electrode outer facial area, as depicted at A in FIG. 2) or relatively large (e.g. 50-70% of the electrode outer facial area, as depicted at B in FIG. 2). It is to be understood, however, that the extent of contact between the liquid electrolyte and an electrode may be fixed, or may change, rapidly or slowly, transiently, or permanently, during operation of the cell, and the specific values of A and B may lie anywhere between 0% and 100%, inclusive.

Optionally, the values of A and/or B are small. Preferably, the cell is configured such that when the reservoir contains the liquid electrolyte, the first gas diffusion electrode touches the liquid electrolyte at an edge of the reservoir. Preferably, the cell is configured such that when the reservoir contains the liquid electrolyte, the second electrode touches the liquid electrolyte at an edge of the reservoir. In other respects, cell 20 may have the same properties and characteristics, as cell 10 in FIG. 1. In other respects, cell 20 may have one or more of the same components, having the same properties and characteristics, as the components in cell 10 in FIG. 1.

In the example embodiment cell depicted in FIG. 2, the gas bodies 125 and 135 may be adjacent to and in contact with a smaller proportion of the outer facial area of the electrodes 120 and 130 respectively, than the embodiment depicted in FIG. 2. For example, the extent of contact may be relatively small (e.g. 30-50% of the electrode outer facial area, as depicted for gas body 135 in FIG. 2) or relatively large (e.g. 90-95% of the electrode outer facial area, as depicted for gas body 125 in FIG. 2). It is to be understood, however, that these values may be fixed, or may change, rapidly or slowly, transiently, or permanently, during operation of the cell, and that the specific values may lie anywhere between 0% and 100%, inclusive.

Despite the prevalence of smaller proportions of contact between the electrodes 120 or 130 and their gas bodies 125 and 135 respectively, many of the features and benefits of the preferred embodiments may, nevertheless, still apply, either fully or partially.

Moreover, this class of example embodiment cells (i.e. cell 20) may provide features and benefits that are less common or not observed in other preferred embodiment cells. These include, for example, a capacity for physical fluctuations in the relative liquid levels within the cell 20; i.e. fluctuations in the relative values of A and B. Such changes in the relative liquid levels in the cell may allow for:
(i) rapid and spontaneous equalisation of the gas pressures in gas body 125 and 135 by compensatory movement of the liquid to new A and/or B values, thereby eliminating any pressure difference between 125 and 135;
(ii) improved maintenance of the porous capillary spacer 110 completely filled with liquid electrolyte at all times; and/or
(iii) improved maintenance of the electrodes fully wetted during operation.

Additionally, the fact that an electrode may be in physical contact with the liquid electrolyte means that capillarity in the electrode may be employed to assist the capillarity of the porous capillary spacer 110. That is, capillarity in the electrode can be harnessed to move liquid electrolyte up to the reaction zone at or between the electrodes. In effect, liquid electrolyte may be induced to move up and along the capillaries in the electrode to the porous capillary spacer 110 or to the electrodes 120 or 130 to thereby help maintain:
(i) the porous capillary spacer 110 filled with liquid electrolyte, always and at all locations, including at locations that are high up in the cell; and/or
(ii) the electrodes fully wetted during operation, always and at all locations, including at locations that are high up in the cell.

Capillary-induced movements of liquid electrolyte on and up an electrode may, of course, typically interfere with and even block gas movements between the electrodes 120 or 130 and the gas bodies 125 or 135, respectively. This may decrease the energy efficiency of the cell 20. It has been discovered, however, that if such movements are configured to only involve very thin layers of liquid electrolyte moving along the surface of the electrode, then there may be no interference with gas movements. That is, if capillary-induced transport of liquid electrolyte can be engineered to avoid flooding of the electrode and its pores, it may provide a beneficial, non-interfering alternative method of transporting liquid electrolyte to the reaction zone, which is also subject to self-regulation.

Preferably, the cell is configured such that during operation the first gas diffusion electrode is covered with a film of liquid electrolyte that is less than 0.125 mm thick, preferably less than 0.11 mm thick, and more preferably less than 0.10 mm thick. Preferably, the cell is configured such that during operation the second gas diffusion electrode is covered with a film of liquid electrolyte that is less than 0.125 mm thick, preferably less than 0.11 mm thick, and more preferably less than 0.10 mm thick.

Example Cell with the Reservoir Incorporated into the Porous Capillary Spacer

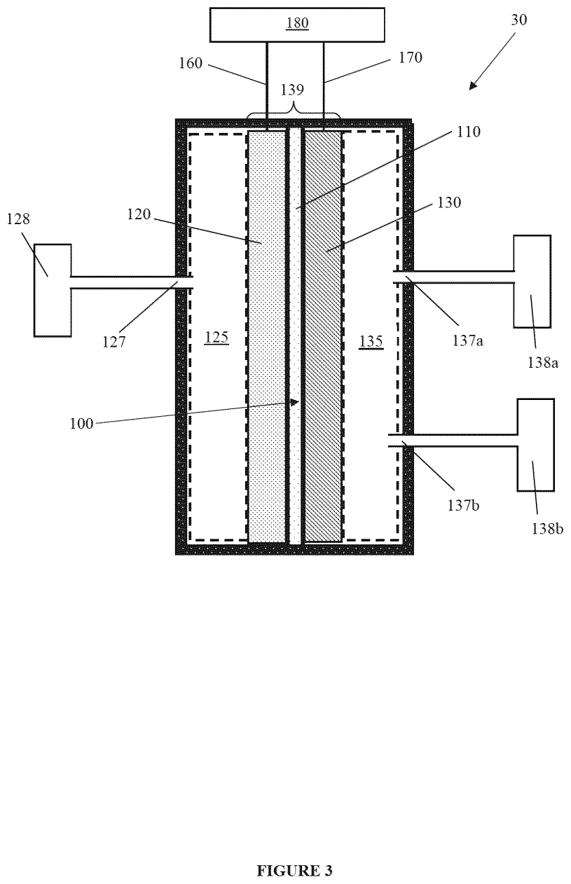

FIG. 3 depicts an alternative embodiment zero-gap electro-synthetic or electro-energy cell 30 in which the reservoir has been incorporated into the porous capillary spacer 110 itself, so that a liquid reservoir that is distinctly separate from the porous capillary spacer may not be discernible.

Cell 30 may, for example, be used when the reactants and products are purely gas-phase materials and the liquid electrolyte is not consumed or produced, or in any way affected by the electrochemical reaction. For example, a liquid electrolyte may be employed that is scarce, expensive or exotic, and which does not easily evaporate, for example an “ionic liquid”. In such cases it may be most practically viable to minimize the quantities of liquid electrolyte present by minimizing the size of the reservoir and incorporating the reservoir into the porous capillary spacer 110.

The resulting cell 30 may be capable of viably facilitating new electrochemical reactions that cannot be carried out at an industrial scale at present. A capacity to facilitate electro-energy or electro-synthetic transformations using tiny quantities of scarce, expensive or exotic liquid electrolytes may open to industrial production, new electrochemical reactions that can presently only be performed using such electrolytes. The gas-phase reactants and/or products may be supplied to or removed from gas bodies 125 and/or 135, via external pipes 127, 137a and/or 137b, to/from first gas storage system 128, second gas storage system 138a and/or third gas storage system 138b. Two gas storage systems (second gas storage system 138a and third gas storage system 138b) are depicted in FIG. 3 to illustrate the situation where a gas is circulated through a gas body (135 in this illustrative case) in order to introduce a reactant and/or remove a product from the cell.

It is to be understood that the use of a scarce, expensive or exotic, and which does not easily evaporate, for example an “ionic liquid”, is not limited to the cell architecture depicted in FIG. 3. Such electrolytes can be used in any example embodiment cell.

In another example embodiment, the porous capillary spacer 110 is filled with an aqueous, liquid electrolyte and the reservoir is wholly incorporated therein. In this case, the aqueous electrolyte in the porous capillary spacer 110 may be replenished or maintained by introducing or removing water vapour into/from gas body 125 and/or 135, with some of this water vapour condensing in, or evaporating from the porous capillary spacer 110.

As noted previously, using a gas-phase vapour to replenish or maintain a liquid-phase material like water within an inter-electrode separator, may typically interfere with or even block the movement of gas-phase reactants or products between the electrodes 120 or 130 and gas bodies 125 or 135, respectively. This may decrease the energy efficiency of the cell.

It has been discovered, however, that when a porous capillary spacer 110, filled with liquid electrolyte held within the spacer by capillary forces, is employed as the inter-electrode separator, the situation may be different. It may be possible to replenish or maintain the liquid electrolyte by introducing or removing water vapour from one or both gas bodies (i.e. first gas body 125 and/or second gas body 135) without interfering with the other gas-phase pathways present (of the gaseous reactants or products to/from the electrodes). In operation, a voltage may be applied across the first electrode 120 and the second electrode 130, or a voltage may be generated across the first electrode 120 and the second electrode 130.

That is, under some circumstances, gas-phase pathways that do not interfere with or hinder the gas-phase pathways of gaseous reactants or products to/from the electrodes, can be created to replenish or maintain a liquid-phase electrolyte.

This may be possible, specifically, when a porous capillary spacer 110 is used as an inter-electrode separator, because a contiguous body of liquid electrolyte may be confined within the porous capillary spacer. Such contiguous, confined bodies of liquid electrolyte may not be present in other inter-electrode separators. Water vapour may preferably condense in or evaporate from such a contiguous body of liquid. Moreover, that body of liquid is held within the spacer by capillary forces, so that any water vapour condensing in the body of liquid will be confined to the spacer 110 by the capillary forces, thereby ensuring that it does not flood or block the electrodes from access by gaseous reactants/products.

Preferably, the cell is configured such that during operation the liquid electrolyte in the porous capillary spacer comprises the only contiguous body of liquid electrolyte in the cell. Preferably, the cell does not include an external liquid conduit, and configured such that the liquid electrolyte and/or liquid-phase reactants and/or products, are transported into or out of the cell in the form of vapour within a gas stream, wherein the vapour condenses in or evaporates from the liquid electrolyte within the porous capillary spacer. Preferably, the cell further includes that no external liquid conduit exists and the liquid electrolyte and/or liquid-phase reactants and/or products are transported into or out of the cell in the form of vapour within a gas stream. Preferably, the reservoir is integrated as part of the porous capillary spacer and the vapour condenses in or evaporates from the liquid electrolyte within the porous capillary spacer.

In other respects, cell 30 may have the same properties and characteristics, as cell 10 in FIG. 1 or as cell 20 in FIG. 2. In other respects, cell 30 may have one or more of the same components, having the same properties and characteristics, as the components in cell 10 in FIG. 1 or in cell 20 in FIG. 2.

### FURTHER EXAMPLE EMBODIMENTS

Beyond the above example embodiments, various other example embodiments of cell architectures can be utilised. These include, but are not limited to, other architectures described in this specification.

In a further example embodiment, there is provided a stack of electro-synthetic or electro-energy cells, comprising: a first electro-synthetic or electro-energy cell; and a second electro-synthetic or electro-energy cell electrically connected to the first electro-synthetic or electro-energy cell. Wherein each electro-synthetic or electro-energy cell comprises: a reservoir for containing a liquid electrolyte; a first gas diffusion electrode positioned outside of the reservoir; a second electrode positioned outside of the reservoir; and a porous capillary spacer positioned between the first gas diffusion electrode and the second electrode, the porous capillary spacer having an end that extends into the reservoir; wherein, the porous capillary spacer is able to fill itself with the liquid electrolyte when the end of the porous capillary spacer is in liquid contact with the liquid electrolyte in the reservoir.

Preferably, within the stack of electro-synthetic or electro-energy cells, the first electro-synthetic or electro-energy cell is an example embodiment cell as described herein, and the second electro-synthetic or electro-energy cell is an example embodiment cell as described herein. Preferably, within the abovementioned stack of electro-synthetic or electro-energy cells, the first electro-synthetic or electro-energy cell and the second electro-synthetic or electro-energy cell are connected in series.

In a further example aspect, there is provided a method of operating an electro-synthetic or electro-energy cell to perform an electrochemical reaction, wherein the cell comprises: a reservoir for containing a liquid electrolyte; a first gas diffusion electrode positioned outside of the reservoir; a second electrode positioned outside of the reservoir; and a porous capillary spacer positioned between the first gas diffusion electrode and the second electrode, the porous capillary spacer having an end that extends into the reservoir; wherein, the porous capillary spacer is able to fill itself with the liquid electrolyte when the end of the porous capillary spacer is in liquid contact with the liquid electrolyte in the reservoir, and the method comprising applying a voltage across the first gas diffusion electrode and the second electrode.

In a further example aspect, there is provided a method of operating the electro-synthetic or electro-energy cell to perform an electrochemical reaction, including the step of applying a voltage across the first gas diffusion electrode and the second electrode.

In a further example aspect, there is provided a method of operating the stack of electro-synthetic or electro-energy cells to perform an electrochemical reaction, including the step of applying a voltage across the first gas diffusion electrode and the second electrode of each of the first electro-synthetic or electro-energy cell and the second electro-synthetic or electro-energy cell.

In a further example embodiment, there is provided an electro-synthetic water electrolysis cell, comprising: a first gas diffusion electrode configured to generate a first gas and be in direct contact with a first gas body comprising the first gas; a second electrode; and a porous capillary spacer configured to be filled with a liquid electrolyte and positioned between the first gas diffusion electrode and the second electrode; wherein an average pore diameter of the porous capillary spacer is more than 2 μm.

In a further example, there is provided a water electrolysis multi-cell stack, comprising a plurality of the abovementioned cells, whereby the plurality of the cells are electrically connected.

In a further example embodiment, there is provided a stack of electro-synthetic water electrolysis cells, comprising: a first electro-synthetic water electrolysis cell; and a second electro-synthetic water electrolysis cell electrically connected to the first electro-synthetic water electrolysis cell. Wherein each electro-synthetic water electrolysis cell comprises: a first gas diffusion electrode configured to generate a first gas and be in direct contact with a first gas body comprising the first gas; a second electrode; and a porous capillary spacer configured to be filled with liquid electrolyte and positioned between the first gas diffusion electrode and the second electrode; wherein an average pore diameter of the porous capillary spacer is more than 2 μm.

Preferably, within the stack of electro-synthetic water electrolysis cells, the first electro-synthetic water electrolysis cell is an example embodiment cell as described herein, and the second electro-synthetic water electrolysis cell is an example embodiment cell as described herein. Preferably, within the stack of electro-synthetic water electrolysis cell, the first electro-synthetic water electrolysis cell and the second electro-synthetic water electrolysis cell are connected in series.

In a further example aspect, there is provided a method of operating an electro-synthetic water electrolysis cell to perform water electrolysis, wherein the cell comprises: a first gas diffusion electrode configured to generate a first gas and be in direct contact with a first gas body comprising the first gas; a second electrode; and a porous capillary spacer configured to be filled with liquid electrolyte and positioned between the first gas diffusion electrode and the second electrode; wherein an average pore diameter of the porous capillary spacer is more than 2 μm, and the method comprising applying a voltage across the first gas diffusion electrode and the second electrode.

In a further example aspect, there is provided a method of operating the electro-synthetic water electrolysis cell to perform water electrolysis, including the step of applying a voltage across the first gas diffusion electrode and the second electrode.

In a further example aspect, there is provided a method of operating the stack of electro-synthetic water electrolysis cells to perform water electrolysis, including the step of applying a voltage across the first gas diffusion electrode and the second electrode of each of the first electro-synthetic water electrolysis cell and the second electro-synthetic water electrolysis cell.

In a further embodiment, there is provided an electro-synthetic or electro-energy cell, comprising: a first gas diffusion electrode configured to generate a first gas and be in contact with and adjacent to a first gas body comprising the first gas; a second gas diffusion electrode configured to generate a second gas and be in contact with and adjacent to a second gas body comprising the second gas; and a porous capillary spacer positioned between the first gas diffusion electrode and the second gas diffusion electrode, the porous capillary spacer configured to be filled with a liquid electrolyte and to confine the liquid electrolyte in the porous capillary spacer by a capillary effect and whereby the liquid electrolyte has a maximum column height of more than 0.4 cm.

Optionally, the cell may comprise a reservoir configured to contain the liquid electrolyte and to be below the porous capillary spacer during operation, wherein at least the distal end of the porous capillary spacer is in contact with the liquid electrolyte in the reservoir. Preferably, the liquid electrolyte has a maximum column height of more than 0.4 cm.

In a further example, there is provided an electro-synthetic or electro-energy multi-cell stack, comprising a plurality of the cells, whereby the plurality of the cells are electrically connected.

In a further example, there is provided a stack of electro-synthetic or electro-energy cells, comprising: a first electro-synthetic or electro-energy cell; and a second electro-synthetic or electro-energy cell electrically connected to the first electro-synthetic or electro-energy cell. Wherein each electro-synthetic or electro-energy cell comprises: a first gas diffusion electrode configured to generate a first gas and be in contact with and adjacent to a first gas body comprising the first gas; a second gas diffusion electrode configured to generate a first gas and be in contact with and adjacent to a second gas body comprising the second gas; and a porous capillary spacer positioned between the first gas diffusion electrode and the second gas diffusion electrode, the porous capillary spacer configured to be filled with a liquid electrolyte and to confine the liquid electrolyte in the porous capillary spacer by a capillary effect and whereby the liquid electrolyte has a maximum column height of more than 0.4 cm.

In a further example, there is provided the stack of electro-synthetic or electro-energy cells, wherein the first electro-synthetic or electro-energy cell is an example embodiment cell as described herein, and the second electro-synthetic or electro-energy cell is an example embodiment cell as described herein.

In a further example, there is provided the stack of electro-synthetic or electro-energy cells, wherein the first electro-synthetic or electro-energy cell and the second electro-synthetic or electro-energy cell are connected in series.

In a further example aspect, there is provided a method of operating an electro-synthetic or electro-energy cell to perform an electrochemical reaction, wherein the cell comprises: a first gas diffusion electrode configured to generate a first gas and be in contact with and adjacent to a first gas body comprising the first gas; a second gas diffusion electrode configured to generate a second gas and be in contact with and adjacent to a second gas body comprising the second gas; and a porous capillary spacer positioned between the first gas diffusion electrode and the second gas diffusion electrode; the porous capillary spacer configured to be filled with a liquid electrolyte and to confine the liquid electrolyte in the porous capillary spacer by a capillary effect and whereby the liquid electrolyte has a maximum column height of more than 0.4 cm, and the method comprising applying a voltage across the first gas diffusion electrode and the second gas diffusion electrode.

In a further example aspect, there is provided a method of operating the electro-synthetic or electro-energy cell to perform an electrochemical reaction, including the step of applying a voltage across the first gas diffusion electrode and the second gas diffusion electrode.

In a further example aspect, there is provided a method of operating the stack of electro-synthetic or electro-energy cells to perform an electrochemical reaction, including the step of applying a voltage across the first gas diffusion electrode and the second gas diffusion electrode of each of the first electro-synthetic or electro-energy cell and the second electro-synthetic or electro-energy cell.

In a further example embodiment, there is provided a method of operating an electro-synthetic or electro-energy cell to perform an electrochemical reaction. The electro-synthetic or electro-energy cell comprising: a reservoir containing a liquid electrolyte; a first gas diffusion electrode; a second electrode; and a porous capillary spacer positioned between the first gas diffusion electrode and the second electrode, the porous capillary spacer having an end positioned within the reservoir and in liquid contact with the liquid electrolyte. The method comprising the steps of: contacting the first gas diffusion electrode and the second electrode with the liquid electrolyte; and applying or generating a voltage across the first gas diffusion electrode and the second electrode.

In a further example aspect, the electrochemical reaction produces Ammonia from Nitrogen and Hydrogen. In a further example aspect, the electrochemical reaction produces electricity from Ammonia and Oxygen. In a further example aspect, the electrochemical reaction produces Hydrogen and Nitrogen from Ammonia. In a further example aspect, the electrochemical reaction uses NO_{X} as a reactant. In a further example aspect, the electrochemical reaction produces Chlorine, Hydrogen and Caustic from Brine. In a further example aspect, the electrochemical reaction produces Chlorine and Caustic from Brine. In a further example aspect, the electrochemical reaction produces Chlorine and Hydrogen from Hydrochloric Acid. In a further example aspect, the electrochemical reaction produces electrical energy from Hydrogen and Oxygen. In a further example aspect, the electrochemical reaction produces Hydrogen and Oxygen from water. In a further example aspect, the electrochemical reaction extracts pure Hydrogen from gas mixtures containing Hydrogen.

In a further example, there is provided an electro-synthetic or electro-energy cell comprising: a reservoir containing a liquid electrolyte; a first gas diffusion electrode; a second electrode; and a porous capillary spacer positioned between the first gas diffusion electrode and the second electrode, the porous capillary spacer having an end positioned within the reservoir and in liquid contact with the liquid electrolyte; wherein the electro-synthetic or electro-energy cell is configured to be operated in accordance with any example method as described herein.

In a further example, there is provided a stack of electro-synthetic or electro-energy cells, comprising: a first electro-synthetic or electro-energy cell, and a second electro-synthetic or electro-energy cell.

In a further example aspect, there is provided the stack of electro-synthetic or electro-energy cells, wherein the first electro-synthetic or electro-energy cell and the second electro-synthetic or electro-energy cell are connected in series.

In a further example aspect, there is provided an electro-synthetic or electro-energy including two or more porous capillary spacers. Preferably but not exclusively, a zero-gap electro-synthetic or electro-energy cell that contains two or more porous capillary spacers (preferably each of which is less than 0.45 mm thick) has liquid electrolyte that is drawn into them and held there continuously by capillary forces, from two or more reservoirs of liquid electrolyte(s) into which an end of each porous capillary spacer is dipped.

In a further example aspect, there is provided an electro-synthetic or electro-energy cell including two or more reservoirs configured to contain the liquid electrolyte, wherein a distal end of each of the two or more porous capillary spacers is positioned in one of the two or more reservoirs.

In another example aspect, the reservoir may be configured to create or employ or exploit an osmotic effect. Preferably, the osmotic effect amplifies the maximum column height of the liquid electrolyte in the porous capillary spacer and/or amplifies the flow rate of components of the liquid electrolyte within the porous capillary spacer, during the electrochemical reaction.

Preferably, the reservoir comprises a first volume configured to contain a first liquid, a second volume configured to contain a second liquid, and a semi-permeable membrane separating the first volume and the second volume. Optionally, the distal end of the porous capillary spacer is positioned in the first volume, configured such that during operation the first liquid is the liquid electrolyte, and the second liquid is different to the first liquid.

In another example aspect, there is provided an electro-synthetic or electro-energy multi-cell stack, comprising a plurality of the cells, configured such that during operation the second liquid, of each of the plurality of the cells, is in liquid communication via a common supply or removal pipe connected to the second volume of each of the plurality of the cells.

In a further example aspect, there is provided an electro-synthetic or electro-energy cell wherein the porous capillary spacer is at least partially comprised of one or materials selected from the group comprising: PVDF, PTFE, tetrafluoroethylene, fluorinated polymers, polyimides, polyamides, nylon, nitrogen-containing materials, glass fibre, silicon-containing materials, polyvinyl chloride, chloride-containing polymers, cellulose acetate, cellulose nitrate, cellophane, ethyl-cellulose, cellulose-containing materials, polycarbonate, carbonate-containing materials, polyethersulfone, polysulfone, polyphenylsulfone, sulfone-containing materials, polyphenylene sulphide, sulphide-containing materials, polypropylene, polyethylene, polyolefins, olefin-containing materials, asbestos, titanium-based ceramics, zirconium-based ceramics, ceramic materials, polyvinyl chloride, vinyl-based materials, rubbers, porous battery separators, and clays.

### ADDITIONAL EMBODIMENTS

In another example aspect, there is provided a zero-gap electro-synthetic or electro-energy cell, the cell comprising of the following elements:
(1) Two electrodes, at least one of which is porous to gases (i.e. a gas diffusion electrode), sandwiched against opposite sides of a porous capillary spacer that is less than 0.45 mm thick (in other examples, less than 0.30 mm thick, or less than 0.13 mm thick);
(2) The porous capillary spacer containing liquid electrolyte that is drawn into the porous capillary spacer and continuously held within the porous capillary spacer by capillary action;
(3) Optionally, an end of the porous capillary spacer, that is optionally separated from or spaced away from the electrode-spacer-electrode assembly described in (1) and (2) above, dipped into or otherwise in liquid contact with a reservoir of the liquid electrolyte. Optionally, the porous capillary spacer is itself the reservoir, or it incorporates the reservoir;
(4) One or more gas bodies on one or both sides of the electrode-spacer-electrode assembly, optionally the one or more gas bodies are separated from the reservoir of liquid electrolyte, the one or more gas bodies being in gaseous communication with respective electrodes;
(5) Sealed (liquid- and/or gas-tight) external conduits and storage volumes that separately connect to the first gas body and/or the second gas body and/or the reservoir, for supplying reactants and removing products during operation of the cell.

Preferably, the porous capillary spacer is formed of, or includes, a porous material. Preferably, during the electrochemical reaction, the porous capillary spacer draws in and maintains a maximum column height of the liquid electrolyte within the porous capillary spacer by capillary action. Preferably, the maximum column height exceeds the height of either or both electrodes that are sandwiched against the porous capillary spacer. Preferably, the maximum column height of the liquid electrolyte is at least equal to or greater than the height of the first gas diffusion electrode. Preferably, the maximum column height exceeds the height of the top of the cell. Preferably, the liquid electrolyte forming the column height is confined within the volume of the porous capillary spacer. Preferably, the liquid electrolyte within the porous capillary spacer extends to all edges of the cell. Preferably, the liquid electrolyte in the porous capillary spacer blocks or hinders the first gas body from mixing with the second gas body.

Preferably, liquid-phase reactants or products of an electrochemical reaction in the cell follow liquid-phase pathways within the liquid electrolyte inside the porous capillary spacer. Preferably, during the electrochemical reaction, the liquid electrolyte within the porous capillary spacer facilitates migration of liquid-phase materials by ‘in-plane’ movement, along the length of the porous capillary spacer, to or from the reservoir of liquid electrolyte, under the influence and control of liquid-phase capillary action and/or diffusion and/or osmotic action. Optionally, at least one electrode facilitates migration of a thin film of liquid electrolyte along and/or up the electrode surface under the influence and control of liquid-phase capillary action. Preferably, a first gas of the first gas body follows a first gas-phase pathway to the first gas diffusion electrode, and the first gas-phase pathway is separate to the liquid-phase pathways. Preferably, a second gas of the second gas body follows a second gas-phase pathway to the second gas diffusion electrode, and the second gas-phase pathway is separate to the liquid-phase pathways.

Preferably, during the electrochemical reaction, the liquid-phase capillary and/or diffusion and/or osmotic actions, act within the electrolyte-filled porous capillary spacer to: (i) continuously replenish one or more liquid-phase materials that are consumed within the liquid electrolyte, or (ii) continuously remove one or more liquid-phase materials that are produced within the liquid electrolyte, or (iii) continuously introduce/remove one or more liquid-phase materials that are otherwise, directly or peripherally, involved in the electrochemical reaction. That is, preferably the electrochemical reaction is self-regulating in the electro-synthetic or electro-energy cell. Optionally, during the electrochemical reaction, the liquid-phase capillary actions involving thin films of liquid electrolyte migrating on the surface of an electrode, act to: (i) continuously replenish one or more liquid-phase materials that are consumed within the liquid electrolyte, or (ii) continuously remove one or more liquid-phase materials that are produced within the liquid electrolyte, or (iii) continuously introduce/remove one or more liquid-phase materials that are otherwise, directly or peripherally, involved in the electrochemical reaction. That is, preferably the electrochemical reaction is self-regulating in the electro-synthetic or electro-energy cell.

Preferably, during the electrochemical reaction, the flow rates induced within the porous capillary spacer by the above-mentioned liquid-phase capillary and/or diffusion and/or osmotic actions are sufficient to sustain the electrochemical reaction. Optionally, during the electrochemical reaction, the flow rates of the liquid-phase capillary actions involving thin films of liquid electrolyte moving on the surface of an electrode, are sufficient to sustain the electrochemical reaction.

Another non-limiting example aspect provides a method for electro-production of chemical products or electrical power using a zero-gap electro-synthetic or electro-energy cell, the method comprising of:
(1) sandwiching two electrodes, at least one of which is porous to gases (i.e. a gas diffusion electrode), against
(2) opposite sides of a porous capillary spacer (that is less than 0.45 mm thick) that
(3) contains within it, liquid electrolyte that is drawn into it and held there continuously by capillary forces, from
(4) a reservoir of the liquid electrolyte into which an end of the porous capillary spacer is dipped, or, alternatively, the porous capillary spacer incorporates the reservoir, or there is no reservoir and the liquid electrolyte in the porous capillary spacer comprises the only contiguous liquid in the cell,
   wherein
(5) gas bodies are present on one or both sides of the electrode-spacer-electrode assembly, wherein
(6) liquid-phase materials involved in the electrochemical reaction, migrate by ‘in-plane’ movement, within the porous capillary spacer, along the length of the porous capillary spacer, to or from the reservoir/body, under the influence and control of capillary and/or diffusion and/or osmotic forces, and/or where, liquid-phase materials involved in the electrochemical reaction, migrate in a thin film on the surface of at least one electrode, to or from the reservoir/body, under the influence and control of capillary,
   and wherein
(7) during operation of the cell, reactants are constantly supplied/replenished from, and products constantly removed to the outside of the cell via external conduits and storage volumes separately connecting to the first gas body and/or the second gas body and/or the reservoir.

### Combinations of Features

According to various non-limiting example embodiments, the following points disclose combinations of features that provide various example cells, multi-cell stacks, systems and/or example methods of operation.
1. An electro-synthetic or electro-energy cell, comprising: a first gas diffusion electrode; a second electrode; and a porous capillary spacer positioned between the first gas diffusion electrode and the second electrode.
2. The cell of point 1, wherein, the porous capillary spacer is able to fill itself with the liquid electrolyte when the end of the porous capillary spacer is in liquid contact with the liquid electrolyte in the reservoir.
3. The cell of any preceding point, the first gas diffusion electrode positioned outside of the reservoir.
4. The cell of any preceding point, the second electrode positioned outside of the reservoir.
5. The cell of any preceding point, wherein the cell is an electro-synthetic water electrolysis cell, 6. The cell of any preceding point, wherein the first gas diffusion electrode is in direct contact with a first gas body.
7. The cell of any preceding point, wherein the porous capillary spacer is filled with liquid electrolyte.
8. The cell of any preceding point, wherein an average pore diameter of the porous capillary spacer is more than 2 μm.
9. The cell of any preceding point, wherein the first gas diffusion electrode is in contact with and adjacent to a first gas body.
10. The cell of any preceding point, wherein the second gas diffusion electrode is in contact with and adjacent to a second gas body.
11. The cell of any preceding point, wherein the liquid electrolyte is confined in the porous capillary spacer by a capillary effect and the liquid electrolyte has a maximum column height of more than 0.4 cm.
12. An electro-synthetic or electro-energy cell, comprising: a reservoir for containing a liquid electrolyte; a first gas diffusion electrode positioned outside of the reservoir; a second electrode positioned outside of the reservoir; and a porous capillary spacer positioned between the first gas diffusion electrode and the second electrode, the porous capillary spacer having an end that extends into the reservoir; wherein, the porous capillary spacer is able to fill itself with the liquid electrolyte when the end of the porous capillary spacer is in liquid contact with the liquid electrolyte in the reservoir.
13. An electro-synthetic water electrolysis cell, comprising: a first gas diffusion electrode configured to generate a first gas and be in direct contact with a first gas body comprising the first gas; a second electrode; and a porous capillary spacer configured to be filled with a liquid electrolyte and positioned between the first gas diffusion electrode and the second electrode; wherein an average pore diameter of the porous capillary spacer is more than 2 μm.
14. An electro-synthetic or electro-energy cell, comprising: a first gas diffusion electrode configured to generate a first gas and be in contact with and adjacent to a first gas body comprising the first gas; a second gas diffusion electrode configured to generate a second gas and be in contact with and adjacent to a second gas body comprising the second gas; and a porous capillary spacer positioned between the first gas diffusion electrode and the second gas diffusion electrode, the porous capillary spacer configured to be filled with a liquid electrolyte and to confine the liquid electrolyte in the porous capillary spacer by a capillary effect and whereby the liquid electrolyte has a maximum column height of more than 0.4 cm.
15. A method of operating the cell of any preceding point to perform an electrochemical reaction, the method comprising the steps of: contacting the first gas diffusion electrode and the second electrode with the liquid electrolyte; and applying or generating a voltage across the first gas diffusion electrode and the second electrode.
16. The cell or method of any preceding point, further including an external housing for the cell, the external housing providing at least one external liquid conduit.
17. The cell or method of any preceding point, configured such that when the reservoir contains the liquid electrolyte, the first gas diffusion electrode is separated from the liquid electrolyte in the reservoir.
18. The cell or method of any preceding point, configured such that when the reservoir contains the liquid electrolyte, the first gas diffusion electrode touches the liquid electrolyte at an edge of the reservoir.
19. The cell or method of any preceding point, configured such that when the reservoir contains the liquid electrolyte, the second electrode is separated from the liquid electrolyte in the reservoir.
20. The cell or method of any preceding point, configured such that when the reservoir contains the liquid electrolyte, the second electrode touches the liquid electrolyte at an edge of the reservoir.
21. The cell or method of any preceding point, wherein the porous capillary spacer is filled with the liquid electrolyte before the end of the porous capillary spacer is extended within the reservoir.
22. The cell or method of any preceding point, configured such that during operation the liquid electrolyte contacts the first gas diffusion electrode and the second electrode only after first being transported along the porous capillary spacer from the reservoir.
23. The cell or method of any preceding point, wherein the first gas diffusion electrode and the second electrode are spaced apart from the reservoir.
24. The cell or method of any preceding point, wherein an area of direct contact between the porous capillary spacer and the first gas diffusion electrode is outside of the reservoir, and an area of direct contact between the porous capillary spacer and the second electrode is outside of the reservoir.
25. The cell or method of any preceding point, wherein the reservoir includes an opening through which the porous capillary spacer passes.
26. The cell or method of any preceding point, configured such that during operation a surface area covered by the liquid electrolyte within the porous capillary spacer is at least equal to or greater than a surface area of the first gas diffusion electrode facing the porous capillary spacer.
27. The cell or method of any preceding point, wherein the first gas diffusion electrode and the second electrode each have a side with a geometric surface area of greater than or equal to 10 cm².
28. The cell or method of any preceding point, wherein the first gas diffusion electrode includes a metallic mesh, a metallic foam and/or a metallic perforated plate.
29. The cell or method of any preceding point, wherein the first gas diffusion electrode is configured to generate a first gas to form a first gas body, a first side of the porous capillary spacer is adjacent a first side of the first gas diffusion electrode, a second side of the porous capillary spacer is adjacent a first side of the second electrode, and a second side of the first gas diffusion electrode is adjacent the first gas body.
30. The cell or method of any preceding point, wherein the second electrode is a second gas diffusion electrode.
31. The cell or method of any preceding point, wherein the second gas diffusion electrode includes a metallic mesh, a metallic foam and/or a metallic perforated plate.
32. The cell or method of any preceding point, wherein the second gas diffusion electrode is configured to generate a second gas to form a second gas body, and a second side of the second gas diffusion electrode is adjacent the second gas body.
33. The cell or method of any preceding point, configured such that during operation at least part of the second side of the first gas diffusion electrode is in direct gas-phase contact with the first gas body; and at least part of the second side of the second gas diffusion electrode is in direct gas-phase contact with the second gas body.
34. The cell or method of any preceding point, including a gas capillary structure positioned at least partially in or at the second side of the first gas diffusion electrode.
35. The cell or method of any preceding point, including a second gas capillary structure positioned at least partially in or at the second side of the second gas diffusion electrode.
36. The cell or method of any preceding point, the cell being a zero-gap cell, whereby the porous capillary spacer is less than 0.45 mm thick, preferably less than 0.30 mm thick, and more preferably less than 0.13 mm thick.
37. The cell or method of any preceding point, wherein an average pore diameter of the porous capillary spacer is more than 2 μm and less than 400 μm.
38. The cell or method of any preceding point, wherein the average pore diameter of the porous capillary spacer is greater than 4 μm and less than 400 μm, greater than 6 μm and less than 400 μm, greater than 8 μm and less than 400 μm, greater than 10 μm and less than 400 μm, greater than 20 μm and less than 400 μm, or greater than 30 μm and less than 400 μm.
39. The cell or method of any preceding point, wherein the porous capillary spacer comprises a plurality of pores that provide a fluidic pathway between the first gas diffusion electrode, the second electrode and the reservoir.
40. The cell or method of any preceding point, wherein the porous capillary spacer is fluidically connected to the reservoir.
41. The cell or method of any preceding point, wherein the porous capillary spacer is at least partially comprised of one or materials selected from the group comprising: PVDF, PTFE, tetrafluoroethylene, fluorinated polymers, polyimides, polyamides, nylon, nitrogen-containing materials, glass fibre, silicon-containing materials, polyvinyl chloride, chloride-containing polymers, cellulose acetate, cellulose nitrate, cellophane, ethyl-cellulose, cellulose-containing materials, polycarbonate, carbonate-containing materials, polyethersulfone, polysulfone, polyphenylsulfone, sulfone-containing materials, polyphenylene sulphide, sulphide-containing materials, polypropylene, polyethylene, polyolefins, olefin-containing materials, asbestos, titanium-based ceramics, zirconium-based ceramics, ceramic materials, polyvinyl chloride, vinyl-based materials, rubbers, porous battery separators, and clays.
42. The cell or method of any preceding point, further including an external housing, the external housing providing at least one external liquid conduit for introducing and/or removing liquid to and/or from the cell.
43. The cell or method of any preceding point, further including the external housing providing at least one external gas conduit that is in gaseous communication with the first gas body.
44. The cell or method of any preceding point, wherein the liquid electrolyte is aqueous, and when the porous capillary spacer is filled with the liquid electrolyte, the liquid electrolyte in the porous capillary spacer flows at a flow rate of more than 0.0014 g water per minute at a height of more than 8 cm.
45. The cell or method of any preceding point, configured such that during operation the first gas body has a pressure of more than 3 bar gauge, preferably more than 4 bar gauge, more preferably more than 5 bar gauge.
46. The cell or method of any preceding point, wherein the first gas diffusion electrode and the second electrode are compressed against the porous capillary spacer by more than 2 bar, preferably more than 3 bar, more preferably more than 4 bar.
47. The cell or method of any preceding point, wherein the porous capillary spacer is more than 60% porous, preferably more than 70% porous, and most preferably more than 80% porous.
48. The cell or method of any preceding point, configured such that during operation a contiguous gas-phase pathway exists between an active surface of the first gas diffusion electrode in a cross-plane axis and the first gas body, whereby visible gas bubbles of the first gas are not produced on at least part of the active surface of first gas diffusion electrode.
49. The cell or method of any preceding point, including a gas handling structure positioned:
   between the first gas diffusion electrode and the porous capillary spacer,
   in the first gas diffusion electrode,
   at or near the first gas diffusion electrode, and/or
   in a portion of the first gas diffusion electrode.
50. The cell or method of any preceding point, wherein the second electrode is configured to generate a second gas and be in direct contact with a second gas body comprising the second gas.
51. The cell or method of any preceding point, wherein when the porous capillary spacer is filled with the liquid electrolyte, the porous capillary spacer is configured to block or hinder the first gas body from mixing with the second gas body and maintains a benchmark gas crossover of less than 2%.
52. The cell or method of any preceding point, including a second gas handling structure positioned:
   between the second gas diffusion electrode and the porous capillary spacer,
   in the second gas diffusion electrode,
   at or near the second gas diffusion electrode, and/or
   in a portion of the second gas diffusion electrode.
53. The cell or method of any preceding point, configured such that during operation the liquid electrolyte in the porous capillary spacer comprises the only contiguous body of liquid electrolyte in the cell.
54. The cell or method of any preceding point, wherein the cell does not include an external liquid conduit, and configured such that the liquid electrolyte and/or liquid-phase reactants and/or products, are transported into or out of the cell in the form of vapour within a gas stream, wherein the vapour condenses in or evaporates from the liquid electrolyte within the porous capillary spacer.
55. The cell or method of any preceding point, wherein an end of the porous capillary spacer is positioned within a reservoir.
56. The cell or method of any preceding point, wherein the reservoir is configured to be filled with the liquid electrolyte and the end of the porous capillary spacer is configured to contact the liquid electrolyte.
57. The cell or method of any preceding point, wherein the porous capillary spacer is configured to transport the liquid electrolyte along the porous capillary spacer at least by capillary action.
58. The cell or method of any preceding point, wherein the porous capillary spacer is configured to transport the liquid electrolyte along the porous capillary spacer by capillary action, diffusion and/or osmotic action.
59. The cell or method of any preceding point, configured such that during operation the cell is self-regulated by capillary action, diffusion and/or osmotic action occurring within the porous capillary spacer.
60. The cell or method of any preceding point, wherein the porous capillary spacer is configured to be filled with liquid electrolyte and to have an ionic resistance of less than 140 mΩ cm² at room temperature.
61. The cell or method of any preceding point, configured such that during operation the first gas diffusion electrode is covered with a film of liquid electrolyte that is less than 0.125 mm thick, preferably less than 0.11 mm thick, and more preferably less than 0.10 mm thick.
62. The cell or method of any preceding point, wherein the average pore diameter of the porous capillary spacer is less than 400 μm.
63. The cell or method of any preceding point, wherein the average pore diameter of the porous capillary spacer is about 3 μm, about 4 μm, about 5 μm, about 6 μm, about 7 μm, about 8 μm, about 9 μm, or about 10 μm.
64. A water electrolysis multi-cell stack, comprising a plurality of the cells of any preceding point, whereby the plurality of the cells are electrically connected, preferably electrically connected in series.
65. The cell or method of any preceding point, further comprising a reservoir configured to contain the liquid electrolyte and to be below the porous capillary spacer during operation, wherein at least the distal end of the porous capillary spacer is in contact with the liquid electrolyte in the reservoir.
66. The cell or method of any preceding point, further including an external housing, the external housing providing at least one external liquid conduit.
67. The cell or method of any preceding point, configured such that during operation the liquid electrolyte, liquid-phase reactants and/or products of an electrochemical reaction in the cell, are transported into or out of the cell via the at least one external liquid conduit, and the at least one external liquid conduit is in fluid communication with an external liquid storage system.
68. The cell or method of any preceding point, configured such that during operation liquid-phase reactants or products of an electrochemical reaction in the cell follow liquid-phase pathways within the liquid electrolyte inside the porous capillary spacer.
69. The cell or method of any preceding point, configured such that during operation the first gas of the first gas body follows a first gas-phase pathway to the first gas diffusion electrode, and the first gas-phase pathway is separate to the liquid-phase pathways.
70. The cell or method of any preceding point, configured such that during operation the second gas of the second gas body follows a second gas-phase pathway to the second gas diffusion electrode, and the second gas-phase pathway is separate to the liquid-phase pathways.
71. The cell or method of any preceding point, wherein when the porous capillary spacer is filled with the liquid electrolyte, the porous capillary spacer is configured to block or hinder the first gas body from mixing with the second gas body, and maintains a benchmark gas crossover of less than 2%.
72. The cell or method of any preceding point, configured such that during operation gas bubbles are not visible on at least a part of the first gas diffusion electrode or on at least a part of the second gas diffusion electrode.
73. The cell or method of any preceding point, the external housing further providing at least one external first gas conduit, and configured such that during operation the first gas is transported into or out of the first gas body via the at least one external first gas conduit.
74. The cell or method of any preceding point, wherein the at least one external first gas conduit is in gaseous communication with an external first gas storage system.
75. The cell or method of any preceding point, the external housing further providing at least one external second gas conduit, and configured such that during operation the second gas is transported into or out of the second gas body via the at least one external second gas conduit.
76. The cell or method of any preceding point, wherein the at least one external second gas conduit is in gaseous communication with an external second gas storage system.
77. The cell or method of any preceding point, wherein the reservoir comprises a first volume configured to contain a first liquid, a second volume configured to contain a second liquid, and a semi-permeable membrane separating the first volume and the second volume.
78. The cell or method of any preceding point, wherein the distal end of the porous capillary spacer is positioned in the first volume, configured such that during operation the first liquid is the liquid electrolyte, and the second liquid is different to the first liquid.
79. The cell or method of any preceding point, including two or more porous capillary spacers.
80. The cell or method of any preceding point, including two or more reservoirs configured to contain the liquid electrolyte, wherein a distal end of each of the two or more porous capillary spacers is positioned in one of the two or more reservoirs.
81. An electro-synthetic or electro-energy multi-cell stack, comprising a plurality of the cells of any preceding point, configured such that during operation the second liquid, of each of the plurality of the cells, is in liquid communication via a common supply or removal pipe connected to the second volume of each of the plurality of the cells.
82. The cell or method of any preceding point, including filling the porous capillary spacer with the liquid electrolyte from the reservoir by at least capillary action.
83. The cell or method of any preceding point, including filling the porous capillary spacer with the liquid electrolyte before the end of the porous capillary spacer is positioned within the reservoir.
84. The cell or method of any preceding point, including contacting the first gas diffusion electrode and the second electrode with the liquid electrolyte after having been transported along the porous capillary spacer.
85. The cell or method of any preceding point, wherein during operation, the porous capillary spacer remains filled with liquid electrolyte.
86. The cell or method of any preceding point, wherein the cell is an electro-synthetic cell and the electrochemical reaction produces a chemical product that is transported away external to the electro-synthetic cell.
87. The cell or method of any preceding point, further including an external housing for the cell, the external housing providing at least one external liquid conduit, wherein the liquid electrolyte is transported into or out of the reservoir via the at least one external liquid conduit.
88. The cell or method of any preceding point, further including the external housing providing at least one external first gas conduit, wherein a first gas is transported into or out of a first gas body via the at least one external first gas conduit.
89. The cell or method of any preceding point, further including an external housing for the cell, the external housing providing at least one external first gas conduit, wherein a first gas is transported into or out of a first gas body via the at least one external first gas conduit.
90. The cell or method of any preceding point, further including the external housing providing at least one external second gas conduit, wherein a second gas is transported into or out of a second gas body via the at least one external second gas conduit.
91. The cell or method of any preceding point, further including that no external liquid conduit exists and the liquid electrolyte and/or liquid-phase reactants and/or products are transported into or out of the cell in the form of vapour within a gas stream.
92. The cell or method of any preceding point, wherein the reservoir is integrated as part of the porous capillary spacer and the vapour condenses in or evaporates from the liquid electrolyte within the porous capillary spacer.
93. The cell or method of any preceding point, wherein the cell operates using an electrical current through the first gas diffusion electrode and the second electrode of greater than or equal to 1 Amp, preferably greater than or equal to 1.5 Amp, more preferably greater than or equal to 2 Amp, and more preferably greater than or equal to 2.5 Amp.
94. The cell or method of any preceding point, wherein the cell is operated continuously for at least 24 hours.
95. The cell or method of any preceding point, wherein the porous capillary spacer draws in and maintains a column height of the liquid electrolyte within the porous capillary spacer by capillary action.
96. The cell or method of any preceding point, wherein the maximum column height of the liquid electrolyte is at least equal to or greater than the height of the first gas diffusion electrode.
97. The cell or method of any preceding point, wherein during the electrochemical reaction, the liquid electrolyte within the porous capillary spacer facilitates migration of one or more liquid-phase materials along a length of the porous capillary spacer.
98. The cell or method of any preceding point, wherein the migration of the one or more liquid-phase materials along the length of the porous capillary spacer is under control of liquid-phase capillary action, diffusion and/or osmotic action.
99. The cell or method of any preceding point, wherein the electrochemical reaction is self-regulating in the electro-synthetic or electro-energy cell.
100. The cell or method of any preceding point, wherein movement of liquid-phase materials out of a cross-plane axis is self-regulated by the composition of the liquid electrolyte in the reservoir.
101. The cell or method of any preceding point, wherein migration pathways of liquid-phase materials and gas-phase materials into and out of a cross-plane axis are differently oriented.
102. The cell or method of any preceding point, wherein liquid-phase capillary, diffusion and/or osmotic actions, act within the porous capillary spacer to:
   (i) continuously replenish one or more liquid-phase materials that are consumed within the liquid electrolyte; or
   (ii) continuously remove one or more liquid-phase materials that are produced within the liquid electrolyte.
103. The cell or method of any preceding point, wherein the electrochemical reaction produces Ammonia from Nitrogen and Hydrogen.
104. The cell or method of any preceding point, wherein the electrochemical reaction produces electricity from Ammonia and Oxygen.
105. The cell or method of any preceding point, wherein the electrochemical reaction produces Hydrogen and Nitrogen from Ammonia.
106. The cell or method of any preceding point, wherein the electrochemical reaction uses NO_{X} as a reactant.
107. The cell or method of any preceding point, wherein the electrochemical reaction produces Chlorine, Hydrogen and Caustic from Brine.
108. The cell or method of any preceding point, wherein the electrochemical reaction produces Chlorine and Caustic from Brine.
109. The cell or method of any preceding point, wherein the electrochemical reaction produces Chlorine and Hydrogen from Hydrochloric Acid.
110. The cell or method of any preceding point, wherein the electrochemical reaction produces electrical energy from Hydrogen and Oxygen.
111. The cell or method of any preceding point, wherein the electrochemical reaction produces Hydrogen and Oxygen from water.
112. The cell or method of any preceding point, wherein the electrochemical reaction extracts pure Hydrogen from gas mixtures containing Hydrogen.

Example cells can be used in a number of major industrial processes, including: (1) ammonia production, (2) chlorine production by the chlor-alkali process and its variants (e.g. including by oxygen-depolarised chlor-alkali processes and HCl recycling reactions), (3) fuel cell production of electricity, (4) hydrogen production by water electrolysis, and (5) hydrogen purification.

To be industrially useful as an electro-synthetic or electro-energy cell, the electrodes 125 and 135 in example cells may carry a current of 1 Ampere or more during operation of the cell. To achieve such a current, the electrodes 125 and 135 may have a geometric surface area greater than or equal to 10 cm². To be energy-efficient and maintain a low electrical resistance during operation, the electrodes 125 and 135 may include a current carrier capable of conducting a high current with low electrical resistance, such as a metallic mesh, a metallic foam and/or a metallic perforated plate. That is, first gas diffusion electrode 120 may include a metallic mesh, a metallic foam and/or a metallic perforated plate, and/or second gas diffusion electrode 130 may include a metallic mesh, a metallic foam and/or a metallic perforated plate. To be industrially useful, such cells may operate continuously or continually for at least 24 hours at a time.

Features that May be Present in Preferred Embodiment Cells

### Separate Liquid- and Gas-Phase Molecular-level Migrations Into and Out of the Reaction Zone/Cross-Plane Axis

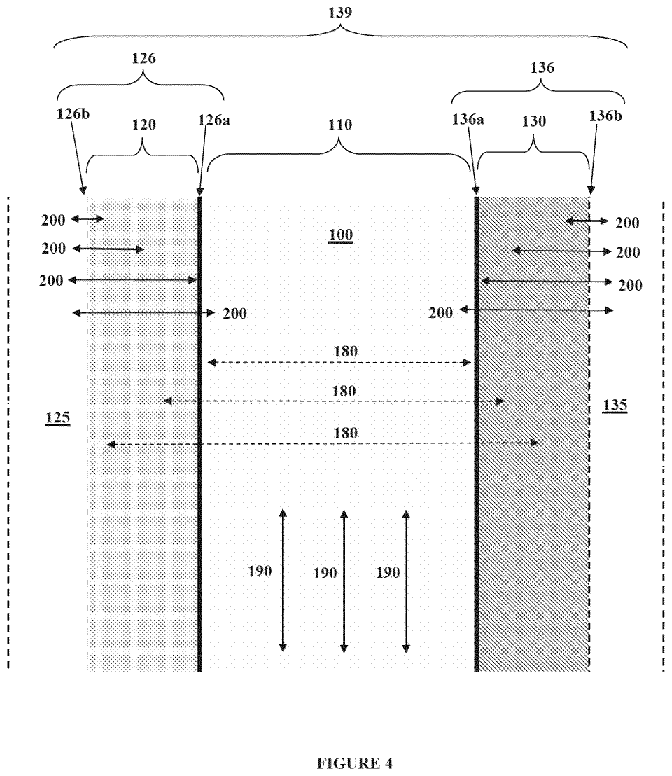

FIG. 4 depicts an enlargement of a portion of electrode-spacer-electrode assembly 139 within an example electro-synthetic or electro-energy cell such as cell 10. The electrochemical reaction in the cell 10 occurs at or between first electrode 120 and second electrode 130. In the example in FIG. 4, both the first electrode 120 and the second electrode 130 are gas diffusion electrodes—that is, they are porous, allowing gases to pass through them.

At each location along the electrode surfaces that are positioned adjacent to, abut, or are sandwiched or laminated against, the porous capillary spacer 110, the electrochemical reactions occur at the electrodes with liquid-phase ions, intermediates or molecules that are exchanged by the electrodes, moving along, or within, or mostly confined to pathways 180 between the first electrode 120 and the second electrode 130. Multiple such pathways 180 exist down the full length of the two electrodes 120, 130. For reasons of clarity, FIG. 4 depicts only a small number of the many pathways 180. As can be seen, these pathways 180 follow a ‘cross-plane’ direction. That is, they are perpendicular to the plane of the porous capillary spacer 110, and largely within the porous capillary spacer 110. For this reason, the cumulative combination of all the pathways 180 present in the cell are said to comprise the ‘Cross-Plane’ Axis (also called the ‘Reaction Zone’).

The electrochemical reaction will typically consume reactants and generate products in the cross-plane axis. That is, reactants will generally be consumed, and products generated within the cumulative pathways 180. Once consumed, the reactants need to be replenished in order to sustain the electrochemical reaction. For that to occur, new reactants need to move into the cross-plane axis from outside of the cross-plane axis. This movement needs to occur continuously if the electrochemical reaction is to be sustained. In the same way, products generated in the cross-plane axis need to move away from it for the electrochemical reaction to be sustained. If products build up in the cross-plane axis, then the electrochemical reaction may be hindered or halted completely.

In preferred embodiments, liquid-phase reactants or products (or other liquid-phase materials involved in the electrochemical reaction in some way) may move into or out of the cross-plane axis by migration within the liquid electrolyte 100 present in the porous capillary spacer 110, following pathways 190. Such migration may be to or from a reservoir 140. That is, liquid-phase reactants or products may follow pathways 190 in an ‘in-plane’ direction, where the pathways 190 are within the liquid electrolyte 100 inside the porous capillary spacer 110.

Such migration may occur spontaneously, under the influence and control of capillary and/or diffusion and/or osmotic actions. The capillary and/or diffusion and/or osmotic actions will typically be driven by the differential in the concentration and composition of the electrolyte in the cross-plane axis relative to that in the rest of the electrolyte, which may comprise mainly the liquid electrolyte in the reservoir 140. The reservoir 140 may constitute the overwhelming bulk of the liquid electrolyte in the system, so that, in the preferred embodiment, its composition and concentration, may, effectively:
(i) control the rate at which the capillary and/or diffusion and/or osmotic actions counteract changes to the concentration and composition of the electrolyte in the cross-plane axis caused by the electrochemical reaction, and
(ii) determine the final, equilibrium state of the liquid electrolyte throughout the cell, including in the cross-plane axis, once the electrochemical reaction has stopped.
   In effect, the presence of the liquid electrolyte 100 in reservoir 140 and its continuous liquid connection to the cross-plane axis (via the porous capillary spacer 110) may control and regulate the movement of liquid-phase materials into and out of the cross-plane axis.

Important Note Concerning Diffusion and Osmosis: In this specification, the terms ‘diffusion’ and ‘osmosis’ have been used interchangeably to describe processes that create net motion of liquid-phase materials within a porous capillary spacer, for example the porous capillary spacer 110. The reason for this equivalence is that within some example porous capillary spacers, being porous materials, the diffusion of solutes may be less free than the diffusion of water. That is, water motion may be favoured over solute motion in some example porous capillary spacers, which potentially is an osmotic rather than a diffusion effect. In order to cover this possibility and to be descriptively comprehensive, no distinction has been made between diffusion and/or osmotic actions creating the motion of liquid phase materials within a porous capillary spacer. By contrast, solute and water motion will generally always be equally free in a reservoir of liquid electrolyte.

For example, in a hydrogen-oxygen fuel cell according to an example embodiment, water may be generated as a product in the cross-plane axis. As it is formed, the water would normally progressively dilute the electrolyte in the cross-plane axis, which would, in turn, increase its ionic resistance and, thereby, decrease the energy efficiency of the cell. However, because there is a continuous body of liquid electrolyte 100 in porous capillary spacer 110, connecting the cross-plane axis with, for example, a reservoir 140, capillarity, diffusion and/or osmosis may spontaneously counteract the dilution effect. That is, because of capillarity, diffusion and/or osmosis, excess water in the cross-plane axis may spontaneously migrate down the porous capillary spacer 110 toward and into the reservoir 140, while solute in the porous capillary spacer 110 and reservoir 140 migrate upward, toward and into the cross-plane axis. These actions may be driven by the differential in the electrolyte concentration and composition within the cross-plane axis relative to that in the rest of the electrolyte, which mostly comprises of the liquid electrolyte in the reservoir 140. The greater the dilution occurring in the cross-plane axis, the faster the above actions may proceed. In this way, the movement of liquid-phase products out of the cross-plane axis may be ‘self-regulated’ by the concentration and/or composition of the liquid electrolyte in the porous capillary spacer 110 and any associated reservoir 140.

In the same way, capillarity, diffusion and osmosis may counteract, in a self-regulating way, any other changes that occur in the composition and concentration of the electrolyte in the cross-plane axis due to the electrochemical reaction. This includes, for example, the consumption of liquid-phase materials and/or chemical changes to liquid-phase materials in the electrolyte in the cross-plane axis.

By contrast, gas-phase movements may occur in an orthogonal direction to liquid movements. When the first electrode 120 and the second electrode 130 are both porous gas diffusion electrodes, gas-phase reactants or products (or other gas-phase materials involved in the electrochemical reaction) may move into or out of the cross-plane axis by migration to or from their contiguous gas bodies 125 and 135 respectively, across the first interface 126 and the second interface 136 respectively, between the gas bodies 125 and 135 and the porous capillary spacer 110. These movements follow pathways 200. There may be multiple such pathways 200 down the length of the electrodes 120, 130. These migrations may occur spontaneously, under the influence and control of capillary forces and/or diffusion to and from the gas bodies 125, 135, through the first electrode 120 and the second electrode 130 respectively.

Gases are well-known to diffuse spontaneously from a region of high partial pressure to a region of low partial pressure, with the rate of diffusion driven by the differential in partial pressures. Diffusion processes typically continue until the partial pressures are equalized in both locations, with their rate depending on the differential in partial pressures. Accordingly, the supply of a gaseous reactant to or removal of a gaseous product from an electrode reaction zone may occur separately to the movement of liquid-phase reactants or products and may be independently ‘self-regulated’. Moreover, the supply of a gaseous reactant to or removal of a gaseous product from the reaction zone associated with one electrode may occur separately to the supply of a gaseous reactant to or removal of a gaseous product from the reaction zone associated with the other electrode, and also may be independently ‘self-regulated’.

In providing pathways for the gas-phase and liquid-phase reactants and products to be separate and non-interfering with each other, preferred embodiment cells may also avoid or minimise the phenomenon of ‘counter multiphase flow’, which occurs in many electrochemical cells. Counter multiphase flow involves molecular-level movements of a liquid-phase species opposing and countering the flow of a gas-phase species within the cell. For example, in many water electrolysis cells, the movement of the liquid-phase reactant (water) to an electrode surface may oppose and counter the movement of a gas-phase product (e.g. hydrogen or oxygen) away from the electrode surface. The resulting counter multiphase flows may create serious complications in cell operation. For example, they may generate a mixed gas-liquid froth or foam, whose two phases of matter need to be disentangled in a gas-liquid separator tank. Counter multiphase flows of this type may also create mass transport limitations insofar as, for example, an electrode may become starved of a reactant, or a product may build-up excessively at an electrode, because of the intensity of the countervailing flow. Inefficiencies of these types may result in inefficient cell operation and require energy to overcome.

Gas-liquid cells in which at least one separate, independent, and non-interfering pathway exists for the molecular-level movements (flows) of each gas-phase and liquid-phase reactant and product in the cell, may be termed ‘independent pathway cells’. In avoiding or minimising counter multiphase flows, independent pathway cells may also avoid or minimise the inefficiencies that they create. Example embodiment cells may be independent pathway cells.

### Cell Operation May be ‘Self-Regulated’

Gas consumed or produced at the electrodes 120 or 130 may therefore be in direct gas-phase contact with the gas bodies 125 and 135 respectively, along pathways 200. Since the gas bodies 125 and 135 contain most of their respective gases in the system, the composition and pressures of the gas bodies 125 and 135 may control and regulate the rate of gas transport to and from their respective electrodes 120 and 130. Capillarity and diffusion may operate, in a self-regulating way, to counteract changes that occur in the composition and concentration of the gases at the electrodes and in the cross-plane axis due to the electrochemical reaction.

By contrast, liquid-phase materials may move into and out of the cross-plane axis along pathways 190 that are orthogonal (i.e. angled at 90°) to and separated from the pathways 200 along which gas-phase materials may move into and out of the cross-plane axis.

Moreover, the pathways 190 may involve a continuous liquid-phase, which is the optimum phase for controlled migration of liquid-phase materials, while the pathways 200 may involve a continuous gas-phase, which is the optimum phase for controlled migration of gas-phase materials.

An important feature of example embodiments is therefore that the migration pathways of liquid-phase and gas-phase materials into and out of the cross-plane axis may be separate, differently located, and independent. They may also involve the optimum phase of matter for controlling and regulating their migration. In so doing, they may avoid interfering with each other and may, as a result, be subject to independent regulation.

Another important feature is that the movement of liquid-phase and gas-phase materials into and out of the cross-plane axis along pathways 190 and 200 respectively, may be controlled by processes that inherently respond to the conditions in the cell, including to changes in the conditions in the cell. That is, capillary, diffusion, and osmotic processes have the common property that they may spontaneously change their rate in response to the concentration or partial-pressure differentials that are present. Accordingly, these processes may be ‘self-regulating’ and this may cause the cell as a whole to be self-regulating.

For example, when an insufficiency develops in a reactant that needs to be consumed during the electrochemical reaction, this may manifest as a higher concentration or partial-pressure differential, causing such processes to automatically increase the supply the needed reactant. By contrast, when sufficient reactant is present, the concentration or partial-pressure differential may be decreased, thereby decreasing the supply of the reactant.

### Capillary-Induced Movement of Electrolyte May be Facilitated Along or Up an Electrode

It is to be understood that while well separated, non-interfering liquid-phase and gas-phase pathways are a feature of the preferred embodiments, such pathways need not lie strictly within the above-described porous capillary spacer 110 (liquid-phase) and the interface between the gas bodies (125 and 135) and their corresponding electrodes (120 and 130, respectively) (gas-phase). Any liquid-phase or gas-phase pathway that is separate and non-interfering falls within the preferred embodiments and may be beneficially employed. Provided such a pathway is separate and non-interfering, it may still be self-regulating.

Thus, for example, as noted above, in preferred embodiments having the architecture depicted in FIG. 2, the liquid electrolyte in the reservoir may be in physical contact with an electrode and may be induced to move up and along an electrode to the reaction zone.

Capillary actions of the above type generally fill and flood the electrode and its pores and thereby hinder/interfere with gas movements to or from the electrodes, decreasing the energy efficiency of the cell, often substantially.

However, it has been surprisingly discovered that porous electrodes (e.g. gas diffusion electrodes) with relatively open structures/large pores may facilitate the upward, capillary-induced movement of only a thin layer of liquid electrolyte on the electrode surface. Such a layer may be sufficiently thin that it avoids impinging on gas movements (depending on the reaction). That is, such movement may constitute a non-interfering liquid-phase pathway that has a beneficial effect in, for example, improving the wetting of the electrode and helping maintain liquid electrolyte in the porous capillary spacer 110.

It has, moreover, been discovered that electrode surfaces may be modified by coating with a thin, hydrophilic or superhydrophilic layer that facilitates upward, capillary-induced movement of such a thin layer of liquid electrolyte. In some cases, it has proved possible to achieve extraordinarily rapid upward flow rates and maximum column heights. This may be especially beneficial for improving electrode wetting and helping maintain liquid electrolyte in the porous capillary spacer 110 at locations that are high up in the cell.

Such hydrophilic or superhydrophilic layers may, moreover, be fabricated from a catalyst. That is, the hydrophilic or superhydrophilic layer may also be the catalyst layer of the electrode. When covered by only a thin layer of liquid electrolyte, such a catalyst layer may exhibit several beneficial effects. For example, gases may be produced by the catalyst layer without producing gas bubbles. This is known as ‘bubble-free’ gas generation and is described below in more detail.

Additionally, hydrophilic or superhydrophilic layers of this type may be fabricated to incorporate a ‘gas handling structure’ that facilitates the movement of gas into or out the reaction zone via an independent, non-interfering pathway. Gas handling structures are described in more detail below.

Accordingly, liquid electrolyte, induced to move up and along the capillaries in the electrode as a thin-film, to the porous capillary spacer 110 or to the electrodes 120 or 130 may constitute a non-interfering liquid-phase pathway that helps maintain:
(i) the porous capillary spacer 110 filled with liquid electrolyte, always and at all locations, including at locations that are high up in the cell; and/or
(ii) the electrodes fully wetted during operation, always and at all locations, including at locations that are high up in the cell.

In preferred embodiments, a ‘thin layer’ of liquid may be less than 0.125 mm thick. In other examples it may be less than 1.5 mm thick, less than 1.0 mm thick, less than 0.7 mm thick, less than 0.5 mm thick, less than 0.3 mm thick, or less than 0.2 mm thick. In other examples it may be less than 0.1 mm thick, less than 0.05 mm thick, less than 0.025 mm thick, less than 0.01 mm thick, less than 0.005 mm thick, less than 0.001 mm thick, less than 0.00001 mm thick, or less than 0.000001 mm thick.

Accordingly, there are provided electrodes 120 or 130 that facilitate the movement of liquid electrolyte 100 over their surface by a capillary action, preferably at a rate of more than 0.5 cm per minute. In other examples, the rate of movement may be more than 1 cm per minute, more than 1.5 cm per minute, more than 2 cm per minute, more than 2.5 cm per minute, more than 3 cm per minute, more than 3.5 cm per minute, more than 4 cm per minute, or more than 5 cm per minute.

Non-Interfering Gas-Phase Pathways for Liquid Replenishment/Maintenance May be Possible with a Porous Capillary Spacer 110

As also noted above, while gas-phase pathways for replenishment/maintenance of a liquid electrolyte generally interfere with the other gas-phase pathways present, that may, surprisingly, not be the case when a Porous Capillary Spacer 110 is used.

Thus, for embodiments of the type of cell 30 depicted in FIG. 3, it has been discovered that when a porous capillary spacer 110 is employed as the inter-electrode separator, it may be possible to replenish or maintain the liquid electrolyte in a separate and non-interfering way, by introducing or removing water vapour from one or both gas bodies 125 or 135.

This may be because a porous capillary spacer 110 contains a contiguous body of liquid electrolyte confined within the porous capillary spacer. Other inter-electrode separators may not have such a contiguous, confined body of liquid electrolyte present. Water vapour may preferentially condense in or evaporate from a contiguous body of liquid. Any water vapour condensing in a contiguous body of aqueous electrolyte may, moreover, be confined to the spacer 110 by the capillary forces, thereby ensuring that it does not flood or block the electrodes from access by gaseous reactants/products.

Accordingly, it is also possible for the liquid electrolyte in porous capillary spacer 110 to be replenished/maintained via a separate and non-interfering pathway in which water vapour is introduced to/removed from a gas body 125 or 135. Providing that the resulting pathway is truly separate and does not interfere with other liquid-phase or gas-phase pathways, it should still be self-regulating.

### Electrode Wetting May Involve Electrode Capillarity and Compression of the Electrodes Against the Porous Capillary Spacer

As noted above, a preferred feature of embodiments cells is that sufficient liquid electrolyte 100 is released from the porous capillary spacer 110, at its interface, 126a or 136a, with an electrode, 120 or 130 respectively, to wet that electrode, 120 or 130, for the reaction. To this end, an electrode, 120 or 130, may need to exhibit a capillary action toward liquid electrolyte 100 at interface 126a or 136a, that is stronger than the capillary action of the porous capillary spacer 110 toward the liquid electrolyte 100. That is, porous capillary spacer 110 employs a capillary action to draw in and fill itself with liquid electrolyte 100. Electrode 120 or 130, sandwiched against the porous capillary spacer 110, may need a stronger capillary action at interface 126a or 136a, to draw in and wet itself with liquid electrolyte 100 that is held within the porous capillary spacer 110.

Accordingly, electrode 120 or 130 may also display a capillary action toward liquid electrolyte 100. The capillary action may involve a higher capillary pressure than the capillary pressure of the porous capillary spacer 100 filled with liquid electrolyte at interface 126a or 136a. Preferably, the capillary pressure of the electrode 120 or 130 is at least 10 mbar greater than that of the porous capillary spacer 100 at interface 126a or 136a, respectively. In other examples, it is more 20 mbar greater, more than 50 mbar greater, more than 75 mbar greater, more than 100 mbar greater, more than 200 mbar greater, more than 500 mbar greater, more than 1 bar greater, more than 2 bar greater.

It has further been discovered that electrode wetting may be facilitated by compressing the electrodes 120 and 130 against the porous capillary spacer 110. Electrode compression of this type may assist the creation and maintenance of electrode wetting by ensuring that there is a tight and intimate contact between the electrode 120 or 130 and the porous capillary spacer 110 at the interface 126a or 136a respectively. That is, it may avoid dislocations in the liquid-phase pathways along which liquid-phase species move from the porous capillary spacer 110 to the electrodes 120 or 130 respectively. Experiments using pressure sensitive films indicate that electrode compression of this type is preferably in the range 8-20 bar. In other examples, electrode compression may be in the range 6-8 bar, 4-6 bar, or 2-6 bar. In other examples, electrode compression may be in the range 20-25 bar, 25-30 bar, 30-35 bar, or 35-50 bar.

### Gas Capillary- or Gas Handling Structures in, at or Near Electrodes

While less well-known, capillarity may also be observed with gas-phase materials. In such cases, gas may be induced to spontaneously flow into narrow spaces that would normally be expected to be filled with liquid. This can be seen, for example, when a capillary tube is dipped into a pool of mercury. The meniscus of liquid mercury inside the tube will typically move to a level lower than the level of the mercury outside of the tube. In a more practical application, it can also be seen in the spontaneous extraction of gas from liquid solutions by, for example, a degassing plate or a porous, hydrophobic membrane. Any structure that spontaneously draws in gas from a liquid and exhibits a measurable capillary pressure associated with gas uptake may be termed a gas capillary structure.

Gas capillary structures may facilitate gas movements into or out of the cross-plane axis along pathways that do not interfere with and are independent from other, molecular-level liquid- and gas-phase movements in the cell. Gas capillary structures that facilitate the movement of gas into or out of the cross-plane axis may be incorporated within, or at least partially in, the first electrode 120 and/or within, or at least partially in, the second electrode 130, or adjacent/near, or at, to the first electrode 120 or the second electrode 130, at or near to, for example, the electrode-gas (liquid-gas) boundaries 126b or 136b, or the electrode-spacer boundaries 126a or 136a. The cell may optionally include a gas capillary structure positioned within or at the first gas diffusion electrode, and optionally include a second gas capillary structure positioned within or at the second gas diffusion electrode. Gas capillary structures may include, but are not limited to any of the following, provided they display a capillary pressure for gas uptake,
narrowly spaced hydrophobic surfaces,
narrowly pored hydrophobic bodies,
a degassing plate, or
a porous, hydrophobic membrane.
   Examples may include but are not limited to those described in the section entitled ‘Breathable (bubble-free) electrodes’ in the scientific publication entitled: ‘The prospects of developing a highly energy efficient water electrolyser by eliminating or mitigating bubble effects’, published in Sustainable Energy and Fuels, 2021, Volume 5, page 1280, which is incorporated herein by reference.

A feature of gas capillary structures is that, by virtue of their affinity for gas, they may contain one or more bodies of gas within themselves. Such gas may persist as a distinct body of bulk gas even if the gas capillary structure is fully immersed in a liquid electrolyte.

In example embodiments, such a body of gas inside a gas capillary structure may be or become contiguous with an adjacent body of gas. For example, a gas capillary structure within, at least partially in, adjacent to, at, or near to electrode 120 may contain a body of gas that is or becomes contiguous with gas body 125. Similarly, a gas capillary structure within, at least partially in, adjacent to, at, or near to electrode 130 may contain a body of gas that is or becomes contiguous with gas body 135. In such cases, the body of gas within the gas capillary structure may form part of the larger gas body. For example, a body of gas within a gas capillary structure that is or becomes contiguous with gas body 125 may form part of gas body 125. Gas body 125 may be in gaseous communication with an external gas conduit (e.g. 127) and/or gas storage system 128. Similarly, a body of gas within a gas capillary structure that is or becomes contiguous with gas body 135 may form part of gas body 135. Gas body 135 may be in gaseous communication with an external gas conduit (e.g. 137) and/or gas storage system (e.g. 138). In an example, a first side of the porous capillary spacer is adjacent a first side of the first gas diffusion electrode, a second side of the porous capillary spacer is adjacent a first side of the second gas diffusion electrode, a second side of the first gas diffusion electrode is adjacent a first gas body, and a second side of the second gas diffusion electrode is adjacent a second gas body. The gas capillary structure is positioned at least partially in or at the second side of the first gas diffusion electrode. A second gas capillary structure can be positioned at least partially in or at the second side of the second gas diffusion electrode.

Alternatively, a body of gas inside a gas capillary structure may be a bulk gas body in its own right, that is independently in gaseous communication with an external gas conduit or storage system. For example, a gas capillary structure within, adjacent to, or near to electrode 120 may contain an internal body of gas, that is gas body 125, and which is in direct gaseous communication with an external gas conduit (e.g. 127) or storage system (e.g. 128). Similarly, a gas capillary structure within, adjacent to, or near to electrode 130 may contain an internal body of gas, that is gas body 135, and which is in direct gaseous communication with an external gas conduit (e.g. 137) or storage system (e.g. 138).

An alternative to the use of gas capillary structures within or near electrodes is to incorporate ‘gas handling’ structures, which have physical properties that facilitate the movement of gases without necessarily harnessing a gas capillary effect. The pathways for gas movement in gas handling structures may also not interfere with and be independent from other, molecular-level liquid- and gas-phase movements in the cell.

Optionally, the first gas diffusion electrode 120 may include a gas handling structure positioned within it, at it, or near it, for example, at or near the boundary 126a or 126b. Also optionally, the second gas diffusion electrode 130 may include a gas handling structure within it, or positioned at or near boundary 136a or 136b. Examples of gas handling structures include, but are not limited to:
(a) materials or structures upon which gases are favoured to selectively coalesce and migrate, such as those having surface regions with low surface energy, for example containing or comprising:
   1. materials with low surface energy, like polytetrafluoroethylene (PTFE), fluorinated polymers, Nafion®, and the like; or
   2. surface structures with low surface energy, such as nanoscale superhydrophobic structures, and the like.
Examples may include but are not limited to those described in the section entitled ‘Hydrophobic islands’ in the scientific publication entitled: ‘The prospects of developing a highly energy efficient water electrolyser by eliminating or mitigating bubble effects’, published in Sustainable Energy and Fuels, 2021, Volume 5, page 1280, which is incorporated herein by reference.
or;
(b) materials or structures having strongly aerophobic surface regions that encourage the detachment of coalesced gases, such as superhydrophilic or ‘superwetting’ materials or structures.
Examples may include but are not limited to those described in the section entitled ‘Superwetting electrodes’ in the scientific publication entitled: ‘The prospects of developing a highly energy efficient water electrolyser by eliminating or mitigating bubble effects’, published in Sustainable Energy and Fuels, 2021, Volume 5, page 1280, which is incorporated herein by reference.

A feature of gas handling structures is that, by virtue of their affinity for gas, they may contain one or more bodies of gas within themselves. Such gas may persist as a distinct body of bulk gas even if the gas handling structure is fully immersed in a liquid electrolyte.

In example embodiments, such a body of gas inside a gas handling structure may be or become contiguous with an adjacent body of gas. For example, a gas handling structure within, adjacent to, or near to electrode 120 may contain a body of gas that is or becomes contiguous with gas body 125. Similarly, a gas handling structure within, adjacent to, or near to electrode 130 may contain a body of gas that is or becomes contiguous with gas body 135. In such cases, the body of gas within the gas handling structure may form part of the larger gas body. For example, a body of gas within a gas handling structure that is or becomes contiguous with gas body 125 may form part of gas body 125. Gas body 125 may be in gaseous communication with an external gas conduit (e.g. 127) and/or gas storage system 128. Similarly, a body of gas within a gas handling structure that is or becomes contiguous with gas body 135 may form part of gas body 135. Gas body 135 may be in gaseous communication with an external gas conduit (e.g. 137) and/or gas storage system (e.g. 138).

Alternatively, a body of gas inside a gas handling structure may be a bulk gas body in its own right that is, independently, in gaseous communication with an external gas conduit or storage system. For example, a gas handling structure within, adjacent to, or near to electrode 120 may contain an internal body of gas, that is gas body 125, and which is in direct gaseous communication with an external gas conduit (e.g. external gas conduit 127) or storage system (e.g. storage system 128). Similarly, a gas handling structure within, adjacent to, or near to electrode 130 may contain an internal body of gas, that is gas body 135, and which is in direct gaseous communication with an external gas conduit (e.g. external gas conduit 137) or storage system (e.g. storage system 138).

### ‘Bubble-Free’ Electrodes

A feature of example cells that generate gases at one or more of their electrodes is that they may directly produce bulk gases from a liquid electrolyte without visible formation of gas bubbles in the electrolyte. Such ‘bubble-free’ gas generation may provide important benefits over conventional gas-generating cells that produce gas in the form of gas bubbles within a liquid electrolyte. These benefits may include higher energy efficiency, due to an avoidance of the energy needed to form gas bubbles, and the fact that the electrode surfaces may be maintained free of bubbles and available for the electrochemical reaction. In particular, the crevices, cracks and defects on the surface, which are generally the most active catalytic sites, may be maintained free and available for catalysis, whereas they are typically the first place that gas bubbles form and to which they cling the most tenaciously. Bubble coverage of electrode active surfaces may decrease the energy efficiency of gas generating cells because of such impediments.

Thus, for example, in a water electrolysis cell, liquid water is electrochemically converted to hydrogen gas at the active surface of the cathode electrode and oxygen gas at the active surface of the anode electrode. In conventional electrolysis cells, these gases are generated in the form of gas bubbles surrounded by the liquid electrolyte. However, in a preferred embodiment water electrolysis cell, when the first electrode 120 and the second electrode 130 are both gas diffusion electrodes, the gases may directly join the associated gas bodies 125 and 135 respectively, without visible formation of gas bubbles. That is, contiguous gas-phase pathways may exist between the active surfaces of the electrodes 120 and 130 in the cross-plane axis and the gas bodies 125 and 135 respectively. Gases that are newly formed on the electrode active surfaces may join this continuous gas-phase pathway without ever forming gas bubbles.

Historically, it has only been possible to achieve bubble-free gas generation at an electrode using a gas capillary structure, such as a porous hydrophobic membrane.

A feature of example embodiments however is that bubble-free gas generation may be created in other ways that do not rely on or require the presence of the micro- and nanostructure of a gas capillary structure. For example, the architecture of example embodiment cell may create bubble-free gas generation by an electrode. This may occur in several ways.

In some examples, surfaces of the gas diffusion electrode (e.g. gas diffusion electrode 120 or second gas diffusion electrode 130) may be covered by only a thin layer of liquid electrolyte during cell operation. Gas produced at the electrode surface may dissolve in the electrolyte and migrate through the thin layer to its surface, where it interfaces with the adjacent gas body (first gas body 125 or second gas body 135). The gas may then pass into the gas body (first gas body 125 or second gas body 135), thereby avoiding bubble formation.

In so doing, the gas may be moved away from the electrode in a way that does not interfere with the movement of the water and the liquid-phase ions on the surface of the electrode. That is, in avoiding gas bubble formation, water may always have unimpeded access and a pathway to the surface of the electrode. There may be no counter multiphase flow in which gas bubbles moving away from the electrode oppose and counter the movement of water to the electrode.

The gas may also be expelled at a substantially lower partial pressure than that needed to nucleate gas bubbles, thereby avoiding the higher voltages required to create the extra partial pressure.

The incorporation of gas handling structures at or near an electrode may also help create a direct, bubble-free, gas-phase pathway from the electrode active surfaces to their respective gas bodies 125 and/or 135. Such pathways may be separate, independent, and not interfere with the movement of the water and the liquid-phase ions on the surface of the electrode. In such cases, newly formed gas may dissolve in the electrolyte and then coalesce on and be scavenged by the low energy surfaces of the gas handling structures. Such gas may, further, migrate along these low energy surfaces away from the electrolyte, into the respective gas bodies 125 and 135 without forming bubbles. Bubble-free operation of this type may be facilitated by the capillary pressure of the porous capillary spacer 110, which may inhibit bubble formation by increasing the high partial pressures needed to nucleate a gas bubble from a dissolved gas. That is, at the porous capillary spacer 110, a nucleating gas bubble would have to not only push itself up, but also push away the liquid in a capillary that is held there with a notable capillary pressure.

Of course, bubble-free gas generation can also be achieved by incorporating a gas capillary structure, such as a porous hydrophobic membrane, at or near an electrode. In such a case, newly formed gases may be spontaneously drawn out of the liquid electrolyte and through the gas capillary structure by a gas capillary action, before bubbles are formed. A gas-phase movement may thereby be created that is separate, independent, and does not interfere with the movement of the water and the liquid-phase ions on the surface of the electrode.

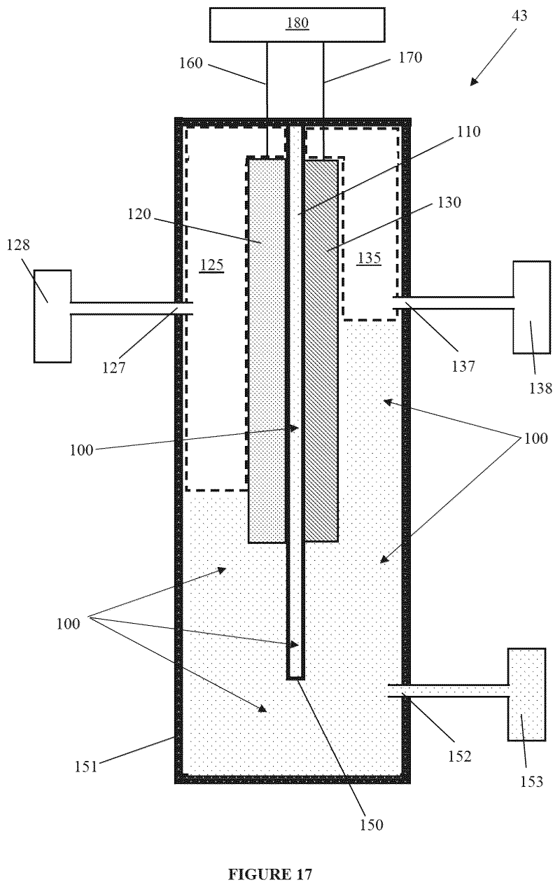

While effective, the use of gas capillary structures at or near electrodes has the disadvantage that such structures are generally not electrically conductive. Electrical connections to the electrodes therefore have to go around the gas capillary structures. The resulting need for longer electrical connection pathways creates additional electrical resistance that builds up additively when cells are stacked in commercial configurations. The additional resistance may typically counteract and negate the benefits of operating bubble-free. This problem is described in the section related to FIG. 17 in the scientific publication entitled: ‘The prospects of developing a highly energy efficient water electrolyser by eliminating or mitigating bubble effects’, published in Sustainable Energy and Fuels, 2021, Volume 5, page 1280, which is incorporated herein by reference.

By contrast, this problem does not exist in example embodiment cells that achieve bubble-free operation without the use of gas capillary structures. In such examples, electrical connections can be made by the shortest possible pathway, directly to the (entire) face of an electrode. In so doing, the limitation of additional resistance counteracting the benefits of bubble-free operation may be lifted, allowing for full utilization of the benefits of bubble-free operation. The resulting cells may be significantly more energy efficient.

Example embodiments that are bubble-free, may preferably display a more than 0.5% higher energy efficiency than a bubbled analogue. In other examples, the improvement in energy efficiency may be more than 1%, more than 2%, more than 5%, more than 10%, more than 15%, or more than 20%.

Preferred Embodiment Cells May Constitute ‘Independent Pathway Cells’ that Display Increased Energy Efficiency

It will be appreciated that many of the features in preferred embodiment cells provide for separate, independent, and non-interfering molecular-level pathways for movements (flows) of gas-phase and liquid-phase species within the cell. In so doing, preferred embodiment cells may be ‘independent pathway cells’.

An ‘independent pathway cell’ is defined as a gas-liquid electrochemical cell that provides at least one pathway that is separate and independent for the movement (flow) of each individual liquid-phase and gas-phase reactant and product within the cell, wherein such pathways do not interfere with or hinder each other.

A pathway is defined in this context as a route or set of routes, at the molecular level within a cell, that are capable of sustaining an electrochemical reaction indefinitely if sufficient reactants are provided from outside of the cell and if sufficient products are removed to the outside of the cell.

In not interfering with or hindering each other, separate and independent liquid- and gas-reactant and product flows of this type are inherently efficient. As a result, independent pathway cells may display increased energy efficiency relative to an equivalent electrochemical cell in which not all of the gas- and liquid-phase reactant and product flows are separate and independent. Such higher energy efficiency may be manifested in a lower voltage (applied across the first electrode and the second electrode) being required in an electro-synthetic cell, or a higher voltage (generated across the first electrode and the second electrode) being produced in an electro-energy cell under equivalent conditions, relative to a cell in which not all of the gas- and liquid-phase reactant and product flows are separate and independent.

Independent pathway cells may utilize all or some of the following features to realise higher energy efficiency: (1) separate and independent liquid- and gas-phase molecular-level migrations into and out of the reaction zone/cross-plane axis, (2) a non-interfering capillary-induced movement of electrolyte along or up an electrode, (3) a non-interfering gas-phase pathway for liquid replenishment/maintenance in the cell, (4) capillarity-induced electrode wetting involving non-interfering pathways, (5) capillarity-induced electrode wetting involving non-interfering pathways created by compression of the electrodes against the porous capillary spacer, (6) non-interfering gas-phase movements via gas handling or gas capillary structures, and/or (7) non-interfering gas- and liquid-phase movements on bubble-free electrodes. The increased energy efficiency may be due to some, or all these effects cumulatively.

Example embodiment ‘independent pathway cells’, may preferably display an energy efficiency that is more than 0.5% higher than a comparable, analogue cell in which at least one reactant or product flow is interfering. In other examples, the improvement in energy efficiency may be more than 1%, more than 2%, more than 5%, more than 10%, more than 15%, or more than 20%.

### Capillary-Related Features of the Porous Capillary Spacer 110

A further feature of preferred embodiments is capillarity in the porous spacer 110. That is, the porous capillary spacer 110 contains liquid electrolyte and this liquid electrolyte is tightly held by capillary forces within the porous capillary spacer. For example, the earlier-mentioned example of a porous capillary spacer 110, namely, the polyethersulfone material filter with average pore diameter of 8 μm supplied by the Pall Corporation, may draw in liquid electrolyte, for example aqueous liquid electrolyte, and hold that electrolyte within the material by capillary forces.

In order to operate continually or continuously over an indefinite time period, the porous capillary spacer 110 may need sufficient capillarity to keep itself continuously or constantly filled with the liquid electrolyte 100.

Such a porous capillary spacer 110 may also need to display other properties including the following.
(1) Capillary Pressure and ‘Bubble Point’: The capillary pressure and, more specifically, the ‘bubble point’ of the porous capillary spacer 110 may need to be suitably large (within reason and considering the other requirements discussed herein). The capillary pressure represents the gas pressure required to push the liquid electrolyte 100 out of the average capillaries in the porous capillary spacer 110. The bubble point represents the gas pressure required to push the liquid electrolyte 100 out of the largest capillaries in the porous capillary spacer 110. These pressures may need to be sufficiently high to help ensure that small or transient pressure differentials in the gas bodies 125 and 135 are not able to push the liquid electrolyte 100 out of or down the porous capillary spacer 110. Loss of liquid electrolyte in the porous capillary spacer 110 at any point in a cell of the type shown in FIGS. 1-3 for example, may: slow or stop the electrochemical reaction (if there is no liquid electrolyte at any point between the electrodes) and/or lead to gas crossover (if there is, at any point in the spacer, no liquid present to act as a barrier between the gas bodies present).
(2) Maximum Column Height: As noted above, the porous capillary spacer 110 may need to indefinitely maintain within itself, a column height of liquid electrolyte 100. This column height may need to extend to the top of an example embodiment cell to thereby ensure that the porous capillary spacer 110 is filled with liquid electrolyte at all points within the cell. This can only be guaranteed if the maximum cell height is equal to or less than the maximum column height of the porous capillary spacer 110, which is the highest column height of liquid electrolyte 100 that can be maintained by the porous capillary spacer 110 when it has hypothetically infinite height. That is, in order that, at all locations in the electrode-spacer-electrode assembly 139 there is always liquid electrolyte 100 between the electrodes, the maximum column height of the liquid electrolyte 100 in the porous capillary spacer 110 may need to be as high or higher than the highest point of cell, i.e. greater than or equal to the height of the cell at the location of the porous capillary spacer. In example embodiment cells, the porous capillary spacer 110 and the liquid electrolyte 100 therein, may lie between gas bodies, for example gas bodies 125 and 135 in FIGS. 1-3. The liquid electrolyte 100 in the porous capillary spacer 110 may then be needed to prevent gas from, for example, gas body 125 in FIGS. 1-3 from crossing into and mixing with the gas in gas body 135, and vice versa. In electrochemical cells this phenomenon is known as ‘gas crossover’ and may result in a loss of energy efficiency, the production or consumption of impure gases, and/or safety hazards. The maximum column height may also need to be higher than the first electrode 120 and the second electrode 130.
(3) Flow Rate: The upward flow rate at which the liquid electrolyte 100 moves inside a filled porous capillary spacer 110 under the influence of capillarity may need to be sufficient to keep the porous capillary spacer always filled with the liquid electrolyte 100, including during cell operation. For example, in a cell having the architecture depicted in FIG. 1 or FIG. 2, where the electrochemical reaction consumes water as a reactant, the capillary-driven flow rate, at all heights within the porous capillary spacer, must be capable of replenishing the water that is consumed when the cell is operated at its maximum rate.

### Specific Capillary Features of the Porous Capillary Spacer 110—Capillary Pressure and Bubble Point

The capillary pressure is defined as the pressure differential across the meniscus in a capillary. That is, it is the pressure required to push a liquid electrolyte out of a capillary. The most common mathematical expression of capillary pressure is the Young-Laplace equation:

$$Δ P = \frac{2 η cos ( θ )}{r} \qquad ( 2 )$$

where ΔP is the pressure drop, η is the surface tension of the liquid, θ is the contact angle between the liquid and the solid, and r is the pore radius.

Using this expression, the capillary pressure of 6 M KOH electrolyte in a series of example porous capillary spacers 110, namely, porous polyethersulfone material filters with average pore diameters of 0.45 μm, 1.2 μm, 5 μm, and 8 μm supplied by the Pall Corporation, were calculated to be: 1.66 atm (for 0.45 μm average pore diameter), 1.08 atm (for 1.2 μm average pore diameter), 0.27 atm (for 5 μm average pore diameter), and 0.22 atm (for 8 μm average pore diameter).

Equation (2) indicates that the larger the pore radius/diameter, the lower the pressure needed to displace the liquid in it. Therefore, the most important type of capillary pressure in a porous capillary spacer, is its ‘bubble point’. This is the pressure required to displace the liquid from the largest pores of the porous capillary spacer. The bubble points of the above series of porous polyethersulfone material filters were measured using Capillary Flow Porometry and found to be: 0.91 atm (for 0.45 μm average pore diameter), 0.48 atm (for 1.2 μm average pore diameter), 0.13 atm (for 5 μm average pore diameter), and 0.11 atm (for 8 μm average pore diameter).

As noted above, a high bubble point helps ensure that small or transient pressure differentials in the gas bodies, for example gas bodies 125 or 135 in FIGS. 1-3, are not able to push the liquid electrolyte out of or down the porous capillary spacer. Accordingly, if the porous polyethersulfone material filter having an average specified pore diameter of about 8 μm was used as porous capillary spacer 110 with 6 M KOH as the liquid electrolyte 100 in a cell of architecture shown in FIG. 1, the cell 10 would have to be engineered to ensure that neither of the gas bodies 125 or 135 ever had a pressure of more than or equal to 0.11 atm above the liquid pressure or above the pressure of the other gas body during operation (since this would cause liquid electrolyte to be driven out of the largest pores). However, if the porous polyethersulfone material filter having an average specified pore diameter of 0.45 μm was used as porous capillary spacer 110, pressure differentials of up to 0.91 atm could be sustained without starting to drive the liquid electrolyte 100 out of the porous capillary spacer 110.

The above trend in bubble points may be modelled as a power law, wherein the bubble point at larger average pore diameters may be calculated as: 0.5086×(average pore diameter)^{-0.772}. By this measure, an average pore diameter of 400 μm in a polyethersulfone material porous capillary spacer 110 may be expected to produce a bubble point of 0.005 atm (5 mbar), which is a low pressure differential between gas body 125 and gas body 135 that may be considered to provide a threshold of being practically difficult to ensure indefinitely in a cell.

An average pore diameter of 400 μm in a polyethersulfone material porous capillary spacer 110 corresponds to a capillary pressure of 0.011 atm (11 mbar) by an extrapolation of the above-mentioned trend in capillary pressures.

When filled with liquid electrolyte, example embodiments of the porous capillary spacer 110 may therefore preferably have a capillary pressure of more than 11 mbar. In other examples, the porous capillary spacer 110 may have a capillary pressure of more than 15 mbar, more than 20 mbar, more than 30 mbar, more than 50 mbar, more than 80 mbar, more than 100 mbar, more than 500 mbar, more than 1 bar, or more than 2 bar.

When filled with liquid electrolyte, example embodiments of the porous capillary spacer 110 may therefore preferably have a bubble point of more than 5 mbar. In other examples, the porous capillary spacer 110 may have a bubble point of more than 10 mbar, more than 15 mbar, more than 20 mbar, more than 50 mbar, more than 100 mbar, more than 250 mbar, more than 500 mbar, more than 1 bar, or more than 2 bar.

### Specific Capillary Features of the Porous Capillary Spacer 110—Maximum Column Height

Without wishing to be constrained by theory, the maximum column height of liquid electrolyte that can be maintained by a capillary tube of hypothetically infinite height may be given by Jurin's law:

$$h = \frac{2 η cos ( θ )}{ρ gr} \qquad ( 1 )$$

where h is the column height, η is the liquid-air surface tension (force/unit length), θ is the contact angle of the liquid electrolyte with the porous capillary spacer material itself, ρ is the density of the liquid electrolyte (mass/volume), g is the local acceleration due to gravity (length/square of time), and r is the average radius of the capillary tube. It should be noted that Jurin's law pertains specifically to capillary tubes and not to porous capillary materials. However, it may reasonably be used to provide factors with which to extrapolate trends in the maximum column heights of porous capillary materials.

As can be seen, Jurin's law indicates that the smaller the pore diameter and the lower the contact angle of the porous capillary spacer material with the liquid electrolyte, the higher the column of liquid electrolyte 100 may be that may be maintained within a porous capillary spacer 110.

The maximum column heights that could be maintained by the aforementioned series of example porous capillary spacers 110, namely, porous polyethersulfone material filters with average pore diameters of 0.45 μm, 1.2 μm, 5 μm, and 8 μm supplied by the Pall Corporation, were measured. The filters were hydrophilic, displaying contact angles of 66.6° with class II de-ionized water and 70.3° with an alkaline 6 M KOH solution. The measurements indicated that the polyethersulfone material filters with 8 μm average pore diameter sustained the lowest maximum column height of the above filters, which was 19.6 cm of class II de-ionized water and 16.6 cm of 6 M KOH. Filters with smaller average pore diameters sustained higher maximum column heights, including significantly higher maximum column heights.

Accordingly, if a porous polyethersulfone material filter with average pore diameter of about 8 μm was used as the porous capillary spacer 110 in an example cell having the architecture depicted in FIG. 1, with 6 M KOH as the liquid electrolyte 100, then the cell, including the first electrode 120 and the second electrode 130, could safely extend up to about 16.4-16.5 cm in height. That is, the porous capillary spacer could be safely employed as a barrier to gas crossover at heights up to 16.4-16.5 cm. Materials with smaller pores provide for higher maximum column heights, including much higher maximum column heights. No limitation exists as to how wide the porous capillary spacer and the electrodes could be, provided that at all points along the width, the porous capillary spacer, i.e. the polyethersulfone porous capillary spacer, had access to 6 M KOH.

As noted in the previous section, an average pore diameter of about 400 μm in a polyethersulfone material porous capillary spacer 110 may be expected to produce a bubble point of 0.005 atm (5 mbar), which is a low pressure differential between gas body 125 and gas body 135 that may provide a threshold of being practically difficult to ensure indefinitely in a cell.

To determine the maximum column height that may correspond to such an average pore diameter of 400 μm, the maximum column height of the polyethersulfone material filter with 8 m average pore diameter was scaled by a differential factor predicted by Jurin's law. By this measure, a polyethersulfone material porous capillary spacer 110 with an average pore diameter of about 400 μm, filled with 6 M KOH, may be expected to have a maximum column height of 0.4 cm above its end 150. This corresponds to a very small capillary effect.

In example embodiments the maximum column height of liquid electrolyte within the porous capillary spacer 110, may therefore preferably be more than 0.4 cm. In other examples, the maximum column height of liquid electrolyte may be more than 1 cm, more than 3 cm, more than 6 cm, more than 8 cm, more than 10 cm, more than 12 cm, more than 14 cm, more than 16 cm, more than 18 cm, more than 20 cm, more than 25 cm, more than 30 cm, more than 50 cm, or more than 100 cm.

### Specific Capillary Features of the Porous Capillary Spacer 110—Flow Rate

The rate at which the liquid electrolyte will flow upward, inside an already filled porous capillary spacer under the influence of capillarity is given by Darcy's law:

$$Q = - \frac{kA}{μ L} \cdot Δ P \qquad ( 3 )$$

where: Q is the rate of flow per unit time, k is the permeability of the porous capillary spacer, A is the cross-sectional area of the porous capillary spacer, μ is the viscosity of the liquid electrolyte, L is the height above the liquid reservoir at which the flow rate is sought, or the height above the bottom end of the porous capillary spacer if no reservoir is present, and ΔP is the pressure drop over the height L

According to a widely accepted study entitled “The Permeability of Porous Media to Liquids and Gases” by L. J. Klinkenberger in the American Petroleum Institute, Drilling and Production Practice, page 200-213, 1 Jan. 1941, New York, the Poiseuille equation describing the flow rate of a liquid in a porous media may be given by:

$$Q = \frac{1}{m} \cdot \frac{n π {r}^{4}}{8 μ L} \cdot Δ P \qquad ( 4 )$$

where: Q is the overall rate of flow per unit time, 1/m is the proportion of pores that are capable of transporting liquid (which may be termed the ‘tortuosity factor’), n is the number of capillaries, r is the average pore radius, μ is the viscosity of the liquid electrolyte, L is the height above the liquid reservoir at which the flow rate is sought, and ΔP is the pressure drop over the height L.

The permeability (k) of a porous material and its porosity (φ) may then be represented as follows,

$$\begin{matrix}k = \frac{1}{m} \cdot \frac{n π {r}^{4}}{8 A} & ( 5 ) \\ φ = \frac{n π {r}^{4}}{A} & ( 6 )\end{matrix}$$

where: k is the permeability of the porous material, φ is the porosity, 1/m is the proportion of pores that are capable of transporting liquid (tortuosity factor), n is the number of capillaries, r is the average pore radius, and A is the cross-sectional area of the porous material.

Thus:

$$k = \frac{1}{m} \cdot \frac{φ {r}^{2}}{8} \qquad ( 7 )$$

Moreover, the pressure difference across a meniscus is given by the Young-Laplace equation:

$$Δ P = \frac{2 η cos ( θ )}{r} \qquad ( 2 )$$

where: ΔP is the pressure drop, η is the surface tension of the liquid, θ is the contact angle between the liquid and the solid, and r is the pore radius.

Substituting into the Darcy equation gives:

$$Q = - \frac{1}{m} \cdot \frac{A φ r η ( cos θ )}{4 μ L} \qquad ( 8 )$$

where: Q is the rate of flow per unit time, 1/m is the proportion of pores that are capable of transporting liquid (tortuosity factor), A is the cross sectional area of the porous capillary spacer, φ is the porosity, r is the pore radius, η is the surface tension of the liquid, θ is the contact angle between the liquid and the solid, μ is the viscosity of the liquid, and L is the height above the liquid reservoir.

For porous capillary spacers 110 comprising the above-mentioned polyethersulfone material filters with pore diameters of 0.45 μm, 1.2 μm, 5 μm, and 8 μm, and filled with 6 M KOH as the liquid electrolyte:
the cross-sectional area (A) of the porous capillary spacer 110 may be measured using a microscope;
the porosity (φ) of the porous capillary spacer 110 may be measured as follows. The empty porous capillary spacer 110 is weighed and then filled with liquid electrolyte and weighed again. The difference provides the weight of liquid that fills the void volume in the porous capillary spacer 110. That weight is converted into a volume and then compared with the net volume of the porous capillary spacer, as measured with a microscope;
the average pore radius (r) of the porous capillary spacer 110 may be measured using a capillary flow porometer,
the surface tension of the 6 M KOH electrolyte at the relevant temperature may be obtained from published data (see, the scientific paper by P. Ripoche and M. Rolin in Bull. Soc. Chem. France, Part 1, 1980, Vol 9-10, pages I386-I39, which is incorporated herein by reference);
the contact angle (θ) of the 6 M KOH electrolyte with the polyethersulfone material of the porous capillary spacer 110 may be measured using standard laboratory goniometer instrument;
the viscosity (μ) of the 6 M KOH electrolyte at the relevant temperature may be obtained from published data (see Graph 7 in the Caustic Potash Handbook, March 2018, by Occidental Chemical Corporation of the United States of America, which is incorporated herein by reference), and
the height above the reservoir (L) (or above the bottom end of the porous capillary spacer if there is no reservoir) may be measured.

Accordingly, it is possible to model the capillary flow rate within the porous capillary spacer 110 at a certain height using equation (8), with the tortuosity factor 1/m, that describes the proportion of pores participating in the flow, determined by comparing the predicted flow rates with the actual measured flow rates.

To measure the flow rate of one of the above polyethersulfone material filters at a particular height, a dry sample of the filter of 1 cm width was cut to the selected length and hung from a balance capable of measuring changes in the weight of a hanging object. An absorbent pad was attached at the top of the filter, where it was affixed to the balance. The filter and adsorbent pad was then wrapped in parafilm to block any evaporation of the liquid during the experiment. The bottom end of the filter was thereafter dipped in a reservoir of 6 M KOH and the filter was allowed to fill itself up by capillary action. Data was collected of the change in weight with time. The data was analysed for flow rate from the point at which the filter had completely filled itself, after which the weight vs time data became linear. The flow rate was the change in weight per unit time.

FIG. 5 depicts graphs of the flow rates measured in this way (black dots), and modelled flow rates (hollow squares) for a 6 M KOH liquid electrolyte at room temperature within porous capillary spacers 110 comprising of porous polyethersulfone material filters with pore diameters of: 0.45 μm, 1.2 μm, 5 μm, and 8 μm. The factor 1/m=1/1.7=58.8% was found to provide the best fit for all samples tested. As can be seen, the modelled results provide a good match of the measured results for each of the porous capillary spacers 110 comprising of porous polyethersulfone material filters.

As noted earlier, the capillary flow rate within the porous capillary spacer 110 is important insofar as it may need to be enough to keep the porous capillary spacer 110 indefinitely filled with the liquid electrolyte 100, including during operation. For example, where the electrochemical reaction consumes water as a reactant, the capillary-driven flow rate may have to be capable of replenishing the consumed water when the cell is operated at its maximum rate. If it is unable to do that, then the cell may not be capable of operating indefinitely.

As can be seen in the graphs in FIG. 5 however, the flow rate within a porous capillary spacer 110 generally decreases with increasing height. Thus, the flow rate required by the electrochemical reaction (and by external factors such as evaporation) may determine the maximum height of the electrodes.

This may be illustrated by the following example. For a zero-gap cell that consumes water during the electrochemical reaction, such as a zero-gap alkaline water electrolysis cell having the architecture depicted in FIG. 1 or FIG. 2, a total current of 10 A corresponds to the overall consumption of 0.056 g of water per minute. If the porous capillary spacer and associated electrodes are to be 40 cm² in size (i.e. the cell will operate at a current density of 0.25 A/cm²), then the porous capillary spacer needs to be able to supply 0.056/40=0.0014 g of water per minute to every 1 cm² of the electrode-spacer-electrode assembly 139. This includes to the 1 cm² at the maximum height of the electrodes.

Referring to the graph in FIG. 5(d): if the porous polyethersulfone material filter with an average pore diameter of 8 μm, filled with 6 M KOH, were used as the porous capillary spacer 110, then the supply rate of 0.0014 g water per minute may only be sustained up to a maximum electrode height of around 20 cm. Accordingly, an electrode-spacer-electrode assembly 139 that was 20 cm high may be expected to operate indefinitely. Such a cell may be 20 cm high and 2 cm wide (giving 40 cm² overall area). Assemblies 139 that were less than 20 cm high and wider may also operate indefinitely.

If, however, the porous polyethersulfone material filter with an average pore diameter of 5 μm, filled with 6 M KOH, was used as the porous capillary spacer 110, then the supply rate of 0.0014 g water per minute could only be indefinitely sustained up to a maximum electrode height of around 15 cm (as shown in FIG. 5(c)). That is, the electrodes in a cell of this type would need to 15 cm or less in height to operate indefinitely.

Moreover, if the porous polyethersulfone material filter with an average pore diameter of 1.5 μm, filled with 6 M KOH, was used as the porous capillary spacer 110, then the supply rate of 0.0014 g water per minute could only be indefinitely sustained up to a maximum electrode height of around 6 cm (as shown in FIG. 5(d)). The maximum height of the electrodes could then only be around 6 cm if the cell was to operate indefinitely.

Furthermore, if the porous polyethersulfone material filter with an average pore diameter of 0.45 μm, filled with 6 M KOH, was used as the porous capillary spacer 110, then the supply rate of 0.0014 g water per minute could only be indefinitely sustained up to a maximum electrode height of around 4 cm (as shown in FIG. 5(d)). The maximum height of the electrodes would be around 4 cm. Electrodes higher than 4 cm could not indefinitely sustain the required flow rate of 0.0014 g water per minute at the maximum electrode height.

Accordingly, high capillary flow rates within the porous capillary spacer 110 may have a potentially limiting influence on the dimensions of a preferred embodiment cell. A porous capillary spacer 110 with a high flow rate may provide greater freedom in respect of cell design.

From a practical, industrial viewpoint, electrodes of greater than 8 cm height are preferable. A porous capillary spacer 110 capable of providing a flow rate of 0.0014 g water per minute at a height of more than 8 cm is therefore preferred.

The average pore diameter of such a porous capillary spacer 110 may be determined by plotting the above maximum heights as a function of the above average pore diameters. Such a plot indicates that the average pore diameter would need to be greater than 2 μm. That is, a porous capillary spacer 110 capable of providing a flow rate of 0.0014 g water per minute at a height greater than 8 cm is calculated to have an average pore diameter greater than 2 μm.

Accordingly, preferred embodiments of the porous capillary spacer 110 preferably have average pore diameters greater than 2 μm. In another example, the average pore diameter is less than 400 μm. In another example, the average pore diameter may be greater than 2 μm and less than 400 μm. In other examples, the average pore diameter may be greater than 4 μm, greater than 6 μm, greater than 8 μm, greater than 10 μm, greater than 20 μm, or greater than 30 μm. In other examples, the average pore diameter may be greater than 4 μm and less than 400 μm, greater than 6 μm and less than 400 μm, greater than 8 μm and less than 400 μm, greater than 10 μm and less than 400 μm, greater than 20 μm and less than 400 μm, or greater than 30 μm and less than 400 μm. In other examples, the average pore diameter of the porous capillary spacer is about 3 μm, about 4 μm, about 5 μm, about 6 μm, about 7 μm, about 8 μm, about 9 μm, or about 10 μm.

It should be noted that the above measured and calculated graphs describe the flow rate under the influence of capillarity only at room temperature. As such, it does not include the effects of diffusion or osmosis, both of which may contribute to the flow rate being higher. Moreover, equation (8) indicates a direct relationship with surface tension and contact angle, but an inverse relationship with viscosity. Since viscosity normally decreases sharply with higher temperatures, while surface tension and contact angle display much smaller changes, the flow rate may be much higher at higher temperatures. Accordingly, these flow rates could reasonably be considered the minimum values for the purposes of designing a cell for operation at higher temperatures than room temperature.

Capillarity May Impart the Porous Capillary Spacer 110 with Unusually Low Ionic Resistance/Unusually High Ionic Conductance

Porous capillary spacers 110 comprising of the polyethersulfone material filters of the types described above had a uniform thickness of about 145 μm. Measurements indicated that, when filled with 6 M KOH electrolyte, the ionic resistance of such porous capillary spacers between two tightly sandwiched electrodes was 33-53 mΩ cm² at room temperature. These values are a quarter to an eighth of those of conventional commercial inter-electrode membrane separators. At 80° C., which is a common operating temperature in electro-synthetic or electro-energy cells, this declined to as low as 15-23 mΩ cm².

The origin of the lower ionic resistance of these polyethersulfone material filters was found to derive from their porosity, which was 75-85%, and the fact that their porous (empty) volume was occupied by the highly conductive 6 M KOH electrolyte, which was held firmly within the spacer by its capillarity. The ionic resistance of a 145 μm thick layer of 6 M KOH is only around 22 mΩ cm² at room temperature and 10 mΩ cm² at 80° C. Thus, when drawn into a porous capillary material and held there by the capillary forces, the 6 M KOH electrolyte imparted an unusually low ionic resistance to the porous capillary material. The greater the porosity of the porous capillary material, the larger the proportion that was occupied by the 6 M KOH and the lower its overall ionic resistance. Accordingly, the porous polyethersulfone material filters with the largest porosity (84.6%) displayed the lowest ionic resistance when imbued with the 6 M KOH electrolyte (33 mΩ cm² at room temperature and 15 mΩ cm² at 80° C.).

In comparison, Agfa's Zirfon PERL® membrane has a very much lower porosity, so that it has a much higher ionic resistance. Chemours' Nafion® 115 and 117 membrane separators are inherently ion conductive and not porous at all. Their ionic resistance is a function of their polymeric structure, which contains ionizable groups that facilitate ion migration through them.

Accordingly, example embodiment cells may provide for significantly lower ionic resistance, and therefore significantly higher energy efficiency when compared to conventional zero-gap electro-synthetic or electro-energy cells. These improvements may derive from the capillarity of the porous capillary spacer 110 which exploits low ionic resistance of the electrolyte.

In example embodiments, the porous capillary spacer may preferably have a porosity of more than 60%. In other examples, the porous capillary spacer may have a porosity of more than 70%, more than 80%, or more than 90%.

Preferred embodiment porous capillary spacers 110 filled with liquid electrolyte 100 may exhibit an ionic resistance of less than 140 mΩ cm² at room temperature. In other examples, the ionic resistance may be less than 270 mΩ cm², less than 200 mΩ cm², less than 180 mΩ cm², or less than 160 mΩ cm², or less than 150 mΩ cm². In other examples, the ionic resistance may be less than 130 mΩ cm², less than 120 mΩ cm², less than 110 mΩ cm², less than 100 mΩ cm², less than 90 mΩ cm², less than 80 mΩ cm², less than 70 mΩ cm², less than 60 mΩ cm², less than 50 mΩ cm², less than 40 mΩ cm², or less than 30 mΩ cm² at room temperature.

### Capillarity in the Porous Capillary Spacer 110 May Lead to Unusually Low Gas Crossover

In many electrochemical reactions it is critically important to minimise the movement of gas associated with one electrode (e.g. first gas body 125 in FIGS. 1-3) across the porous capillary spacer, to the other side of the porous capillary spacer, where it would mix with gas associated with the other electrode (e.g. second gas body 135 in FIGS. 1-3), and vice versa. As noted earlier, this phenomenon is known as ‘gas crossover’ and it decreases the energy efficiency of the cell in proportion to its prevalence. It also poses a potential safety risk in certain cells.

For example, in zero-gap water electrolysis cells having the architecture shown in FIGS. 1-3, the hydrogen gas produced at the cathode is preferably kept as free as possible of contamination by the oxygen gas produced at the anode, and vice versa. This is because hydrogen containing >4.6% oxygen, or oxygen with >3.8% hydrogen, is an explosive mixture (at the normal operating temperature of such electrolysis cells, 80° C.).

In conventional zero-gap water electrolysis cells, the gases are produced as gas bubbles in the liquid electrolyte on both sides of the inter-electrode separator membrane (i.e. in the anolyte and catholyte). In such systems, gas crossover may occur by two possible mechanisms: (A) diffusion of gas, dissolved in the liquid electrolyte, across the inter-electrode separator membrane to the other side (referred to as ‘diffusion-based crossover’), and (B) the physical movement of liquid containing gas and gas bubbles, passing through the inter-electrode separator membrane, driven by pressure differentials between the two sides (referred to as ‘cross permeation-based crossover’). Cross permeation-based crossover may be created by transient and fluctuating pressure differentials across the separator, including those arising from bubble formation and release.

In commercial alkaline electrolysis cells that typically employ Zirfon PERL® inter-electrode separators, cross-permeation-based crossover is, by far, the dominant mechanism. Even with extremely small pressure differentials between the two sides (i.e. the anolyte and catholyte), crossover in conventional zero-gap alkaline electrolysis cells is mostly due to cross permeation-based crossover. For example, if the pressure difference between the two sides of a thin Zirfon PERL® membrane could be limited to a mere 1%, then, when operating at 200 mA/cm² with a 6 bar overall pressure, the cross permeation-based crossover of hydrogen into the oxygen product stream would be ˜2%, while the accompanying diffusion-based crossover would be only ˜0.3%. It is for this reason that Zirfon PERL® separators have relatively small pores, with average pore diameters of only ˜0.14 μm. Small pores of this type minimize the mobility of the liquid electrolyte, which is typically aqueous 6 M KOH, within and through the membrane in order to minimise gas crossover (as taught in: H. I. Lee et al. The Synthesis of a Zirfon PERL®-type Porous Separator with Reduced Gas Crossover for Alkaline Electrolyzer, Int J. Energy Res. 2020, Vol 44, p. 1875-1885). The level of diffusion-based crossover is so low because the high levels of K⁺ and OH⁻ ions in 6 M KOH ‘salt out’ dissolved gases. That is, 6 M KOH has an exceedingly low solubility for dissolved gases like hydrogen and oxygen. The rate of diffusion of dissolved oxygen and hydrogen in 6 M KOH is also very low.

In commercial PEM electrolysis cells by contrast, the typically employed Chemours' Nafion® membranes are non-porous. This eliminates cross-permeation crossover as a mechanism of gas crossover since the de-ionized water that is used in such cells, is not free to pass through the membrane at all. However, diffusion-based crossover is still possible, and since the combined solubility and diffusion rates for gases like hydrogen and oxygen are ˜40-120-times higher in de-ionized water at 80° C., diffusion-based crossover transports a high level of gas across the membrane. Accordingly, commercial PEM electrolysis cells generally have higher gas crossover than commercial alkaline membranes.

Example embodiment cells, such as, that depicted in FIG. 1, enjoy the benefits of both alkaline and PEM electrolysis cells without suffering the disadvantages of either. Thus, cross-permeation-based crossover is essentially impossible in example embodiment cells because there are no bodies of free liquid electrolyte on the outsides of the electrodes; those volumes are occupied by gas bodies 125 and 135 respectively. Liquid electrolyte is, instead, supplied from below, along the porous capillary spacer 110. That is: there may be no anolyte or catholyte in example embodiment cells and, therefore, no body of liquid electrolyte free to permeate from one side to the other, across the porous capillary spacer 110. It is, indeed, this feature that makes it possible to use porous capillary spacers with high porosities.

Moreover, in using an electrolyte with high ionic concentration, example embodiment cells also benefit from the very low solubility and diffusion rate in 6 M KOH of gases like oxygen and hydrogen. Accordingly, the diffusion-based crossover that occurs is low.

Thus, example embodiment cells display significantly lower gas crossover than equivalent conventional alkaline or PEM electrolysis cells under comparable conditions.

The constraint that gas crossover exercises on inter-electrode separator selection and design is, thereby, lifted to a large extent. Thus, example embodiment cells may employ large pore diameters that produce high flow rates within the porous capillary spacer 110 without significant gas crossover. As noted earlier, embodiment porous capillary spacers 110 preferably have average pore diameters of more than 2 μm, while average pore diameter in Zirfon PERL® is only 0.14 μm. This would be unthinkable and diametrically opposite to the teaching in the field of conventional inter-electrode separators (as noted earlier). But it is possible in example embodiment cells because of their unique cell architecture.

The cell architecture of example embodiment cells not only enables the use of large average pore diameters in the porous capillary spacer 110, but also leads to unusually low ionic resistances, as noted in the previous section.

Moreover, it also maximises the mobility of liquid-phase water inside the porous capillary spacer. In so doing, it overcomes the challenge noted in the Background Section, that conventional inter-electrode separators may generally strongly limit the electrolyte mobility in the separator in order to minimise gas crossover. For this reason, the electrodes in zero-gap water electrolysis cells may have to draw water reactant from the outside of the electrode, thereby setting up a counter multiphase flow in which liquid-phase water moving toward the electrode counters gas-phase bubbles moving away from the electrode. In example embodiments, the porous capillary spacer 110 is specifically enabled to supply the needed water and ion reactants from inside the separator, thereby avoiding such counter multi-phase flow, and doing so without notable gas crossover. That is, by virtue of their unique cell architectures, example embodiment porous capillary spacers are able to avoid the counter multiphases flows that may occur in conventional zero-gap water electrolysers. This is the essence of the invention and its novelty.

Another advantage of low gas crossover is that it may allow for successful operation at higher overall absolute pressures than may be possible in conventional alkaline electrolysis cells. This is because there may be scope for a more substantial increase in crossover, as the absolute pressure is increased, before the safety limit is approached, than would be the case in equivalent conventional cells.

‘Benchmark gas crossover’ is the extent of gas crossover after 30 min under the specific condition that the cell operates at a fixed 200 mA/cm² at room temperature and atmospheric pressure.

In embodiment porous capillary spacers 110 preferably the liquid electrolyte in the porous capillary spacer blocks or hinders the first gas body 125 from mixing with the second gas body 135 and maintains a benchmark gas crossover of less than 2%. In other examples, the benchmark gas crossover may be less than 1%, less than 0.8%, less than 0.6%, less than 0.4%, less than 0.2%, less than 0.1%, less than 0.05%, or less than 0.01%.

### Capillarity in the Porous Capillary Spacer 110 May Make it an Unusually Good Bubble Barrier

While some preferred embodiment cells may be free of visible gas bubbles, invisibly small micro- or nano bubbles may still be present. In other embodiments, visible gas bubbles may be formed. Bubbles are, of course, non-conducting voids whose presence within an inter-electrode spacer increases electrical resistance (i.e. impedance) between the electrodes and decreases the energy efficiency of the cell. Moreover, over time, increasing numbers of bubbles may progressively become lodged in the spacer, until they form a single contiguous gas pathway that bridges or partially bridges the porous capillary spacer. Such bridges typically produce exceedingly high levels of gas crossover, severely impairing the energy efficiency of the cell. Problems of this type may occur in some conventional inter-electrode spacers.

The capillarity of the porous capillary spacer 110 may induce it to act as a better barrier to gas bubbles, including and especially micro- or nano-bubbles, than conventional inter-electrode separators.

As noted earlier, gas bubbles can only nucleate inside porous capillary spacers 110 if newly formed gases at the electrodes create bubbles whose internal pressures overcome the capillary pressure within the porous capillary spacer 110. This may be unlikely to occur in example embodiments since the first electrode 120 and the second electrode 130 may be in direct contact with associated first gas body 125 and second gas body 135 respectively, which have no additional capillary pressure to overcome. Accordingly, gas bubble formation may be preferentially directed to electrode locations away from the porous capillary spacer 110 and closer to, or at the interface with gas bodies 125 or 135. In such cases, the capillarity of the spacer 110 will have been utilized to make it significantly more effective as a bubble barrier than may be the case with conventional inter-electrode spacers of zero-gap cells.

In preferred embodiments, the porous capillary spacer 110 may block transport between the electrodes of gas bubbles of more than 1 micron diameter. In other examples, it may block bubbles of more than 2 micron diameter, more than 5 micron diameter, more than 10 micron diameter, more than 25 micron diameter, more than 50 micron diameter, or more than 100 micron diameter.

### Capillarity in the Porous Capillary Spacer 110 May Impart the Benefits of a ‘Dry Cell’ Architecture

By virtue of the capillarity of the porous spacer and its capacity to draw in and hold liquid electrolyte within itself while the outside environment is dry and liquid-free, example embodiment cells may have the benefits of a so-called ‘dry cell’ architecture, in which the inter-electrode spacers are typically solid-state conducting materials. At the same time, example embodiment cells may also enjoy the advantages of a liquid electrolyte, which may be much more conducting than a solid-state conducting material. Accordingly, preferred embodiments may combine the advantages of a dry cell architecture with the advantages of a liquid electrolyte architecture, whilst avoiding the disadvantages of each. In so doing, the cell may avoid the need for external engineering systems that may normally be needed to manage, including actively manage, zero-gap electro-synthetic or electro-energy cell.

### Capillarity in the Porous Capillary Spacer 110 May Allow the Use of Expensive/Exotic/Scarce Electrolytes

In a further example aspect, there is provided an electro-synthetic or electro-energy cell that employs a liquid electrolyte of a class that is versatile or has useful properties for facilitating electrochemical reactions. Such an electrolyte may be expensive and/or scarce and/or exotic, and may be, by way of example only, an ionic liquid. An example embodiment cell employing such a liquid electrolyte may be practically viable by virtue of the small volume of electrolyte required in the porous capillary spacer and reservoir. An example embodiment cell employing such a liquid electrolyte may enable industrialisation of an electrochemical reaction that has not before been commercially viable.

### Methods of Operating the Electro-Synthetic or Electro-Energy Cell

In another example aspect, there is provided a method of operating the electro-synthetic or electro-energy cell to perform an electrochemical reaction. The method comprising the steps of: filling the porous capillary spacer 110 with the liquid electrolyte 100, and contacting the liquid electrolyte 100 with the first electrode 120, for example a first gas diffusion electrode, and the second electrode 130, for example a second gas diffusion electrode. In another alternative example, the method comprises the steps of: transporting the liquid electrolyte 100 from the reservoir 140 along the porous capillary spacer 110 by at least capillary action; and contacting the liquid electrolyte 100 with first gas diffusion electrode 120 and second electrode 130, which may also be a gas diffusion electrode, after having been transported along the porous capillary spacer 110. In another example, the method includes filling the porous capillary spacer 110 with the liquid electrolyte 100 from the reservoir 140 by at least capillary action. In another example, the method includes filling the porous capillary spacer 110 with the liquid electrolyte 100 before the end 150 of the porous capillary spacer 110 is positioned within the reservoir 140. In another example, the method includes, during operation, the porous capillary spacer 110 remaining filled with liquid electrolyte 100. In another example, the method includes, during operation, the porous capillary spacer 110 remaining filled with liquid electrolyte 100 by migration of liquid electrolyte 100 under capillary/diffusion/osmosis from the reservoir 140. In another example, the method includes, during operation, the porous capillary spacer 110 remaining filled with liquid electrolyte 100 by migration of liquid electrolyte in a thin film along and up an electrode surface, 120 and/or 130, from the reservoir 140. In another example, the method provides that the cell 10 is an electro-synthetic cell and the electrochemical reaction produces a chemical product that is transported away external to the electro-synthetic cell 10. In another example, the method includes, during operation, the porous capillary spacer 110 remaining filled with liquid electrolyte 100 due to vapour in gas body 125 and/or 135 condensing in or evaporating from the liquid electrolyte 100 in the porous capillary spacer 110. In another example, the method provides that the cell 10 is an electro-energy cell and the electrochemical reaction produces electrical power that is used to provide work external to the electro-synthetic cell 10. In another example, the method includes the steps of: supplying/replenishing reactants from outside of the cell and/or removing products to outside of the cell during operation, wherein these movements occur within sealed (liquid- and/or gas-tight) external conduits and housings that separately connect to each of the first gas body and/or the second gas body and/or the reservoir.

In one example, the porous capillary spacer draws in and maintains a column height of the liquid electrolyte within the porous capillary spacer by capillary action. In another example, the maximum column height of the liquid electrolyte is at least equal to or greater than the height of the first gas diffusion electrode. In another example, the maximum column height of the liquid electrolyte extends to the top of the cell and to all edges of the cell. In another example, an electrode draws a thin film of liquid electrolyte along or up its surface. In another example, liquid electrolyte in the porous capillary spacer is replenished/maintained by vapour of that liquid, present in a gas phase pathway, condensing in or evaporating from the liquid electrolyte in the porous capillary spacer.

Preferably, during the electrochemical reaction, the liquid electrolyte within the porous capillary spacer facilitates migration of one or more liquid-phase materials along a length of the porous capillary spacer. Alternatively, during the electrochemical reaction, the liquid electrolyte facilitates migration of one or more liquid-phase materials along the surface of an electrode. Also preferably, the migration of the one or more liquid-phase materials along the length of the porous capillary spacer is under control of liquid-phase capillary action, diffusion and/or osmotic action. In another example, the electrochemical reaction is self-regulating in the electro-synthetic or electro-energy cell. In yet another example, movement of liquid-phase materials out of a cross-plane axis is self-regulated by the composition of the liquid electrolyte in the reservoir.

Preferably, migration pathways of liquid-phase materials and gas-phase materials into and out of a cross-plane axis are differently oriented and separate. In another example, liquid-phase capillary, diffusion and/or osmotic actions, act within the porous capillary spacer to: (i) continuously replenish one or more liquid-phase materials that are consumed within the liquid electrolyte; or (ii) continuously remove one or more liquid-phase materials that are produced within the liquid electrolyte. In another example, this is achieved by liquid-phase capillary motion along an electrode surface that does not interfere with an gas-phase pathways.

For example, cells of preferred embodiments may avoid the need for gas humidification systems, with all their associated engineering components and electronic controls, as is typically needed in PEM fuel cells. In another example, cells of the preferred embodiment may avoid the need for circulating liquid electrolyte systems, with all of their associated pipes, pumps and other engineering and electronic components, as may be needed in water electrolyzers.

In another example, vapour present in gas body condenses in or evaporates from the liquid electrolyte in the porous capillary spacer to: (i) continuously replenish one or more liquid-phase materials that are consumed within the liquid electrolyte; or (ii) continuously remove one or more liquid-phase materials that are produced within the liquid electrolyte. In another example, this is achieved by a non-interfering gas phase pathway.

An Osmotic Reservoir Configuration that May Amplify the Maximum Column Height and Flow Rate of Liquid Electrolyte in a Porous Capillary Spacer, and Whose Operation May be Automated

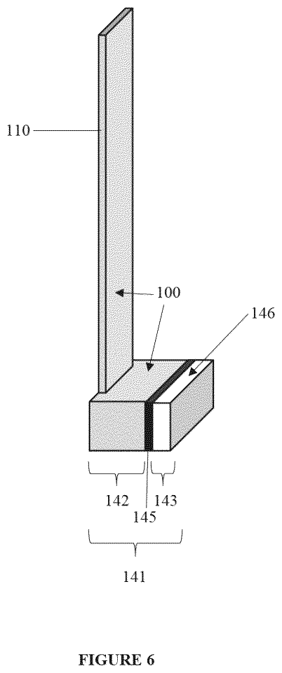

In cases where the capillarity of the porous capillary spacer 110 provides an insufficient maximum column height and/or flow rate of the liquid electrolyte 100 in porous capillary spacer 110, the reservoir 140 and porous capillary spacer 110 may be configured as an osmotic system in order to amplify the maximum column height and/or flow rate. FIG. 6 depicts an example of such an alternative, osmotic configuration as reservoir 141.

The reservoir 141 may be confined within a cavity of fixed volume, into which the porous capillary spacer 110 is positioned and preferably sealed, as shown in FIG. 6. The reservoir 141 may have a membrane 145 sealed across it to thereby separate or divide the reservoir 141 into two fixed and confined volumes, first volume 142 and second volume 143. The membrane 145 may be permeable to water but impermeable to ions; that is, the membrane 145 may be a ‘semi-permeable’ membrane of the type common in osmotic systems. The porous capillary spacer 110 may be positioned in, or dipped in, or is otherwise in liquid communication with, liquid electrolyte 100 (i.e. a first liquid) contained in first volume 142, while the second volume 143 on the other side of the membrane 145, contains, for example, pure water (i.e. a second liquid 146). That is, the porous capillary spacer 110 may be positioned in the first volume 142, the first liquid may be the liquid electrolyte 100, and the second liquid 146 may be different to the first liquid.

Such an arrangement may create an osmotic pressure that is transmitted from second volume 143, through the semi-permeable membrane 145, to first volume 142. The osmotic pressure may result in the liquid electrolyte 100 being driven higher up the porous capillary spacer 110 than it would be due only to the capillarity of the porous capillary spacer 110. The osmotic pressure may also amplify the rate at which liquid electrolyte 100 and its components may flow along and up the porous capillary spacer 110.

The maximum height of the column of liquid electrolyte 100 due to the osmotic effect, and its flow rate in the porous capillary spacer 110, may typically depend on the composition of the liquid electrolyte 100 relative to the pure water (i.e. second liquid 146), as well as to the total volume of the liquid electrolyte 100 relative to the total volume of the pure water 146. That is, by adjusting the chamber size of volume 143 relative to the chamber size of volume 142 and the volume of liquid electrolyte 100 in porous capillary spacer 110, and taking into account the composition of the electrolyte 100 relative to pure water (i.e. second liquid 146), it may be possible to control and adjust the additional maximum column height and additional flow rate of the liquid electrolyte 100 in the porous capillary spacer 110 imparted by the osmotic pressure created.

Accordingly, there is provided an alternative embodiment reservoir configuration 141 that may employ an osmotic effect to assist in amplifying the maximum column height and flow rate of the liquid electrolyte 100 in the porous capillary spacer 110.

This configuration may also help automate example cells in which water is the sole product generated or reactant consumed by the electrochemical reaction. That is, a reservoir of configuration 141 may also be employed to automate the removal or addition of water in example embodiment hydrogen-oxygen fuel cells (in which water is the sole reaction product) or example embodiment water electrolysis cells (in which water is the sole reactant that is consumed) respectively.

In such example embodiment cells, an osmotic equilibrium may exist between the pure water (i.e. second liquid 146) in second volume 143 and the liquid electrolyte 100 in first volume 142 and the porous capillary spacer 110. The formation of additional, new water by the electrochemical reaction in an example embodiment hydrogen-oxygen fuel cell may dilute the liquid electrolyte 100. This may cause the above equilibrium to shift, with additional pure water passing from the first volume 142 through the semi-permeable membrane 145 into the second volume 143 until the balance is restored. The additional pure water flowing into second volume 143 may be removed by periodically opening a valve between second volume 143 and a pipe of pure water that is attached to second volume 143. The valve may be configured to automatically open whenever the quantity of pure water in second volume 143 exceeds a particular amount. In this way, reservoir management may be automated, so that, without human intervention, water that is generated as the sole product in an example embodiment hydrogen-oxygen fuel cell may be automatically removed via the reservoir 141 providing an osmotic system.

In an example embodiment water electrolysis cell, water is the sole reactant that is consumed by the electrochemical reaction. The effect of consuming water will cause the liquid electrolyte 100 to become more concentrated, which will also shift the above equilibrium, albeit in the opposite direction. That is, pure water may be induced to flow out of second volume 143 across the semi-permeable membrane 145 into first volume 142 and the porous capillary spacer 110 until the balance is restored. The additional pure water flowing out of second volume 143 may be replenished by periodically opening a valve between second volume 143 and a pipe of pure water that is attached to second volume 143. The valve may be configured to automatically open whenever the quantity of pure water in second volume 143 falls below a particular amount. In this way, reservoir management may be automated, so that, without human intervention, water consumed as the sole reactant in an example embodiment water electrolyzer may be automatically replenished via the reservoir 141 providing an osmotic system.

### Example Porous Capillary Spacers and Example Liquid Electrolytes

While the examples above employed porous capillary spacers 110 comprising of porous polyethersulfone material filters with average pore diameter of 0.45 μm, 1.2 μm, 5 μm, and 8 μm, supplied by the Pall Corporation, it is to be understood that a wide range of other porous, thin materials capable of incorporating liquid electrolyte within them, may be employed as porous capillary spacers 110. This includes but is not limited to porous, thin films of various types, or combinations of types, or hybrids of different types, including, without limitation:
PVDF, PTFE, tetrafluoroethylene, fluorinated polymers of various types; polyimides, polyamides, nylon, nitrogen-containing materials of various types; glass fibre, silicon-containing materials of various types; polyvinyl chloride, chloride-containing polymers of various types, cellulose acetate, cellulose nitrate, cellophane, ethyl-cellulose, cellulose-containing materials of various types; polycarbonate, carbonate-containing materials of various types; polyethersulfone, polysulfone, polyphenylsulfone, sulfone-containing materials of various types; polyphenylene sulphide, sulphide-containing materials of various types; polypropylene, polyethylene, polyolefins, olefin-containing materials of various types; asbestos, titanium-based ceramics, zirconium-based ceramics, ceramic materials of various types; polyvinyl chloride, vinyl-based materials of various types; rubbers of various types; porous battery separators of various types; and clays of various types.

While the examples above employed aqueous 6 M KOH solution as the liquid electrolyte 100, it is to be understood that a wide range of other liquids or gels may be employed as electrolytes 100, including but not limited to:
water containing one or more dissolved ions, such as, but not limited to: 0.001-14 M concentrations of Na⁺, K⁺, Ca²⁺, Mg²⁺, OH⁻, SO₄²⁻, HSO₄⁻, Cl⁻, NO₃⁻, ClO₄⁻, phosphates (including HPO₄⁻), carbonates (including HCO₃⁻), PF₆⁻, BF₄⁻, (CF₃SO₂)₂N⁻, or polyelectrolytes that contain polymers with functional groups, such as, but not limited to polystyrene sulfonate, DNA, polypeptides;
non-aqueous liquids containing solutes, such as, but not limited to propylene carbonate or dimethoxyethane or propionitrile liquids containing solutes such as, but not limited to, LiClO₄, or Bu₄NPF₆;
conductive liquids, such as, but not limited to ambient temperature molten salts or ionic liquids comprising of alkyl-substituted ammonium, imidazolium or pyridinium cations paired with suitable anions;
Gels that are conductive and able to act as electrolytes.

Of particular relevance are electrolytes that are versatile or useful in facilitating electrochemical reactions but which may be expensive and/or scarce. By virtue of the very small volume of electrolyte that may be present in the thin porous capillary spacer (and reservoir), cells of preferred embodiments may enable more widespread use of such electrolytes in electro-synthetic or electro-energy cells. Examples in this respect include, but are not limited to, ionic liquids, which have been found, in many cases, to facilitate practically useful but currently practically unviable electrochemical reactions. Despite their great technical versatility and utility in electrochemical reactions, many ionic liquids have, to date, not found widespread application as electrolytes in electro-synthetic or electro-energy cells because of their high cost and scarce availability.

Example Cells with a Simple Engineering Design

In the following, example cells that facilitate a variety of different electrochemical reactions and having the architecture depicted in FIG. 1, are described. In order to provide reproducible descriptions, an example cell having a simple and easily reproduced engineering design, has been used. It is to be understood that this design is one of many that may be employed in example embodiment cells and that a variety of example cells fall within the scope of the invention.

FIGS. 5 and 6 describe the fabrication of example cells. Electrode-spacer-electrode assemblies 139 were prepared by mounting the assemblies inside a specially cut plastic laminate that became rigid after heat treatment by passing through a stationery-store laminator.

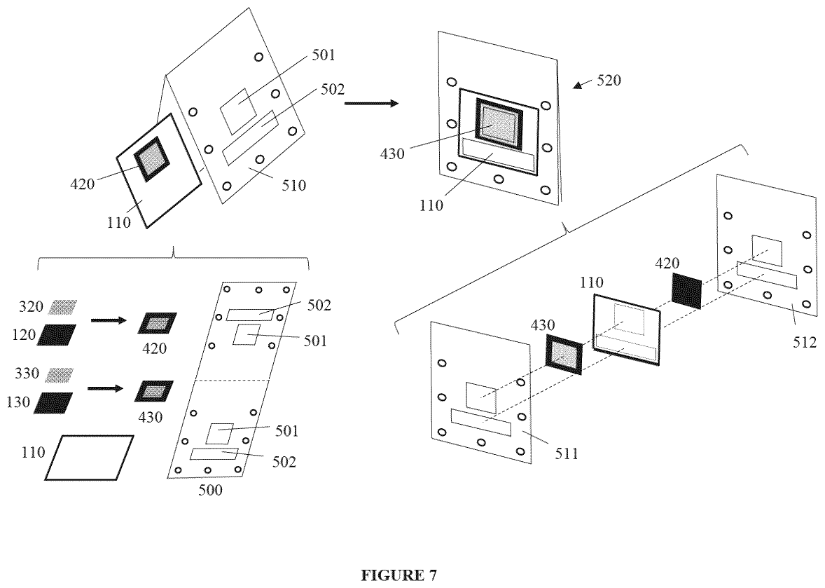

As shown in FIG. 7, a transparent plastic laminate was cut to the design of cut-out 500 using a laser cutter. The cut-out 500 incorporated two 3.2 cm×3.2 cm electrode windows 501 and two reservoir windows 502 of dimensions 5 cm wide×2 cm high. A porous capillary spacer 110 was cut to dimensions 6.5×6.5 cm. First electrode 120, embodied as a gas diffusion electrode, of dimension 3.3×3.3 cm had a gas-porous, fine metal mesh current carrier 320 of dimensions 3.25×3.25 cm incorporated into or on to it, to form an electrode-current carrier assembly 420. Second electrode 130, embodied as a gas diffusion electrode, of dimension 3.3×3.3 cm had a second gas-porous, fine metal mesh current carrier 330 of dimension 3.25×3.25 cm incorporated into or onto it, to form a second electrode-current carrier assembly 430.

The cut-out 500, being a transparent laminate, was folded in two as depicted as folded cut-out 510. Into the fold was inserted the porous capillary spacer 110 with the electrode-current carrier assembly 420 on its front side and the electrode-current carrier assembly 430 on its back side. Each of the electrode-current carrier assembly 420 and the electrode-current carrier assembly 430 had their current carriers 320 and 330 respectively, facing outward, away from the porous capillary spacer 110. Each of the electrode-current carrier assembly 420 and the electrode-current carrier assembly 430 had their first electrode 120 and second electrode 130 respectively, facing inward, in direct contact with the porous capillary spacer 110. The porous capillary spacer was so located that it would cover the entirety of both windows 501 and 502. The electrode-current carrier assemblies 420, 430 were located so that they would just cover the windows 501 on each side. The resulting assembly was then passed through a stationery store laminator, causing the two inner sides of folded cut-out 510 to adhere to each other and become rigid, thereby forming the current carrier-electrode-spacer-electrode-current carrier assembly 520.

The lower right of FIG. 7 depicts an exploded view of the assembly 520, showing how the components inside the assembly 520 registered with the windows 501 and 502 on each side. The front side 511 of the laminate formed the front of assembly 520. The back side 512 of the laminate formed the back of assembly 520. Between the front side 511 and the back side 512 of the laminate was located the porous capillary spacer 110. The porous capillary spacer 110 was in register with and covered both top and bottom windows in each of the laminates' front side 511 and back side 512 (shown as the dashed lines on porous capillary spacer 110 in the bottom right of FIG. 7). On the front side of porous capillary spacer 110 was located the electrode-current carrier assembly 430, whose electrode side faced the porous capillary spacer 110 and whose current carrier side faced the front side 511 laminate covering. The assembly 430 was in register with the top window on the front side 511 of the laminate. The current carrier 330 in the electrode-current carrier assembly 430 covered the entire top window in the front side 511 of the laminate. On the back side of porous capillary spacer 110 was located the electrode-current carrier assembly 420, whose electrode side faced the porous capillary spacer 110 and whose current carrier side 320 faced the back side 512 of the laminate. The assembly 420 was in register with the top window on 512. The current carrier in 420 covered the entire top window in the back side 512 of the laminate.

As can be seen in FIG. 7, the height of porous capillary spacer 110 was at least equal to or greater than the height of the first electrode 120 and the height of the second electrode 130. Similarly, the surface area of porous capillary spacer 110 overlapped with and was at least equal to or greater than the surface area of the first electrode 120 and the surface area of the second electrode 130. Accordingly, the maximum column height of the liquid electrolyte 100 within the porous capillary spacer 110 exceeds the height of the first electrode 120 and the height of the second electrode 130. Preferably, the maximum column height of the liquid electrolyte is at least equal to or greater than the height of the first gas diffusion electrode. The maximum column height also exceeds the height of the top of the cell. Similarly, this allowed the surface area covered by the liquid electrolyte 100 within the porous capillary spacer 110 to be at least equal to or be greater than the surface area of the first electrode 120 facing the porous capillary spacer and the surface area of the second electrode 130 facing the porous capillary spacer.

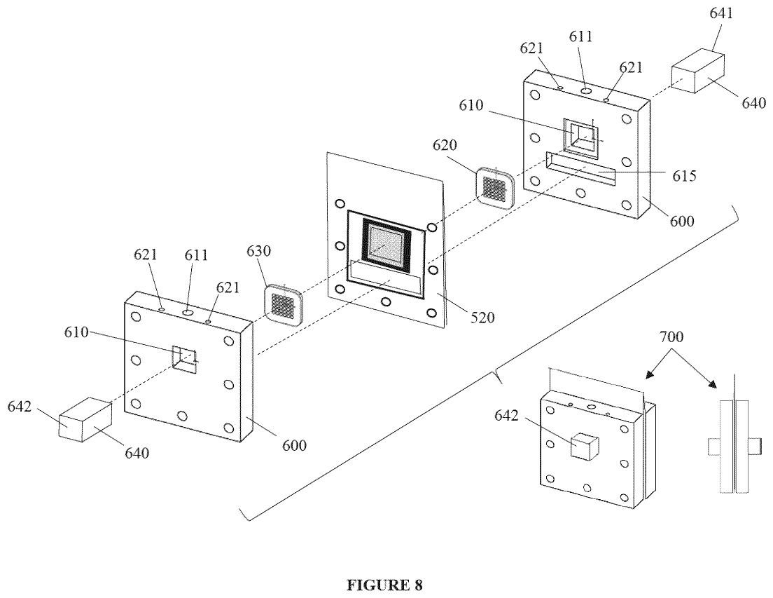

FIG. 8 shows an exploded view of the cell that was assembled using the current carrier-electrode-spacer-electrode-current carrier assembly 520.

Two cell halves 600 were machined from stainless steel. Each half-cell 600 contained a stepped window 610 which was connected to a pipe 611 that exited at the top of the half-cell 600. Each half-cell 600 also contained a recessed rectangular well 615 of dimensions 5 cm wide×2 cm high×1 cm deep. This recess 615 connected to two pipes 621 that both exited at the top of the half-cell 600.

Into the top window 610 of each half-cell 600, a conductive metallic flow field 620, 630 was placed in a specially designed recess. Each flow field 620, 630 contained a porous central area of dimensions 3.2 cm×3.2 cm. Various designs could be used for the porous section of the flow fields 620, 630. In the example depicted in FIG. 8, the flow fields 620, 630 had closely packed cylindrical vacancies going through them, from front to back. Where possible, prior to incorporating catalyst, the electrodes 120 and 130 were welded to their respective current carriers 320 and 330 and/or to their respective flow fields 620 and 630.

As depicted in FIG. 8, the assembly 520 was then sandwiched between the two half-cells 600, with the current carriers on the outsides of assembly 520 in tight contact with the conductive flow fields 620, 630 in each of the half-cells 600. The two half-cells 600 were tightly screwed to each other using non-conducting polymer bolts that were passed through the seven edge-arrayed holes that ran through the thickness of the overall assembly, yielding the overall cell 700, which is depicted at the bottom right of FIG. 8 in perspective (left) and cross-section (right).

Thereafter, liquid electrolyte was run down one of the tubes 621 on each half-cell 600 in full cell 700, to fill the reservoir cavities 615 in each half-cell 600. The liquid in those reservoirs 615 passed through the windows 502 on either side of assembly 520 and was drawn up in the porous capillary spacer 110, between the first electrode 120 and the second electrode 130, where the first electrode 120 and the second electrode 130 are both gas diffusion electrodes.

To make an electrical connection with the electrodes 120, 130, conductive busbars 640 were passed through the windows 610 in each half-cell 600 and compressed against the conductive flow fields 620, 630. These were in turn compressed against the conductive current carriers 320, 330 that were incorporated into first electrode 120 and second electrode 130 respectively. The compression was provided by two bolts that were torqued against the busbars to deliver the preferred electrode compression. In some embodiments, the busbars 640 were replaced with stainless steel bolts that screwed into and through the housing 600 at the same location (i.e. at 610); the bolts were torqued to deliver the preferred electrode compression. The applied pressure delivered by the torqued bolts could be checked using a pressure-sensitive film. The two ends 641, 642 of the busbars 640 served as the connection points with the external electrical circuit. The busbars 640 (or the abovementioned stainless-steel bolts) were so constructed as to allow ready flow between the flow fields 320, 330 and the pipes 611 in the respective half-cells 600.

Gas connections were made to the cell via the pipes 611 at the top of each of the half-cells 600. Gas flowing into or out of those pipes 611 connected with the first electrode 120 and second electrode 130 respectively, via the flow-fields 620, 630 and gas-porous current carriers 320, 330 respectively.

The above cells could be adapted to have the architecture depicted in FIG. 2 by merely removing the polymer between vacancies 501 and 502 in the laminate 500 (see FIG. 7) and removing the metal barrier between chambers 615 and 610 in the cell 600 (see FIG. 8), and then ensuring that the liquid in reservoir 615 has a level high enough to touch at least one of the electrodes 120 or 130.

The above cells could also be adapted to have the architecture depicted in FIG. 3 by merely not cutting out the vacancies 502 in the laminate 500 (see FIG. 7) and by not cutting out the chamber 615 in the half cells 600 (see FIG. 8). There will then be no reservoir in the cell.

### Example Multi-Cell Stacks

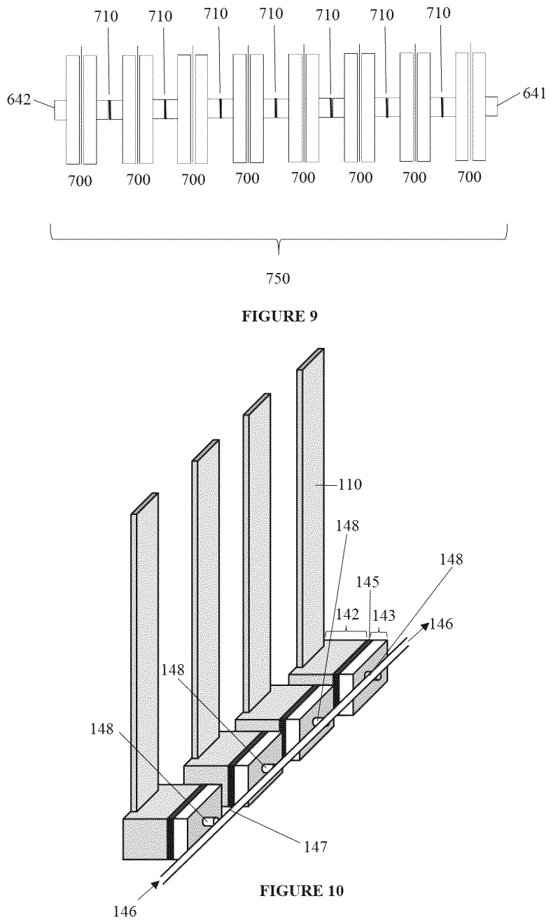

Referring to FIG. 9, multiple individual cells 700, providing at least a first electro-synthetic or electro-energy cell and a second electro-synthetic or electro-energy cell, may be stacked into bipolar cell stacks 750 (that are electrically connected in series) as a multi-cell stack, by electrically connecting one end 642 of the external busbar 640 of one cell to the other end 641 of the external busbar 640 on the next cell. FIG. 9 depicts such a stack 750, which is illustrated by way of example, to comprise of eight individual cells 700 (that is a first cell, a second cell, a third cell, a fourth cell, a fifth cell, a sixth cell, a seventh cell, an eighth cell) with seven electrical connections 710 between them. Each electrical connection 710 involved the end 642 of busbar 640 in one cell 700 contacting with the end 641 of busbar 640 in the next cell 700. The external electrical circuit was then connected across the open end 642 on the left of FIG. 9 and the open end 641 on the right of FIG. 9.

Advantages of this multi-cell arrangement compared to many conventional zero-gap electrochemical cells include but are not limited to the following examples.
(1) Shunt-current elimination: ‘shunt’ currents (also called ‘parasitic’ currents or ‘bypass’ currents) can be problematic in electrochemical cell stacks connected in electrical series. Shunt currents occur when there is a body of conductive liquid electrolyte that connects and is common to all or to a multiplicity of the cells in the cell stack. The presence of such a common body of electrolyte allows unwanted currents to pass between electrodes in different individual cells within the stack. Such ‘shunt’ currents circumvent the desired current pathway and may cause a significant loss of efficiency, as well as corrosion and non-uniform cell performance. Shunt currents can only be totally avoided by ensuring that each individual cell in the stack has its own liquid electrolyte that is not in conductive, physical contact with the liquid electrolyte of any other individual cell in the cell stack.
   Example cell stacks 750 conform to that requirement. That is, each individual cell 700, providing at least a first electro-synthetic or electro-energy cell and a second electro-synthetic or electro-energy cell, has its own, individual liquid electrolyte 100 within its own porous capillary spacer 110 and its own reservoir 140, which is not in physical contact with the liquid electrolyte 100 in any other individual cell 700 in the cell stack 750. Thus, a common body of conductive liquid electrolyte, which is, at any time, connecting to, or common to all or a multiplicity of the cells 700 in cell stack 750, may not exist in cell stack 750.
(2) Multiple individual reservoirs may be maintained using a single water supply/removal system without creating shunt currents; the system may be automated: This raises the question as whether it is possible and practically viable to automate the maintenance of multiple, individual reservoirs in a cell stack 750, via a single, common water supply or removal system, without creating shunt currents? That is, is it feasible to manage multiple individual reservoirs from a single water supply or removal system and still also avoid shunt currents? (As noted in FIG. 6 and associated text, the use of a reservoir of type 141 may allow for automated reservoir maintenance in individual, embodiment cells in which water is the sole product generated by the electrochemical reaction (e.g. hydrogen-oxygen fuel cells), or the sole reactant consumed (e.g. water electrolyzer cells)).
   To answer that question, FIG. 10 schematically and illustratively by way of example, depicts four reservoirs of type 141 in a cell stack 750 comprising of four individual cells 700. In each reservoir, the second volumes 143, which contain pure water 146, have a pressure or volume-sensitive valve 148 that connect them to a single, common water-supply or removal pipe 147 that contains pure water 146. During operation, the valves may open and close automatically and individually to remove water that is produced (in a hydrogen-oxygen fuel cell) or to replenish water that is consumed (in a water electrolyzer). Thus, the second liquid 146, in this example pure water, of each of the plurality of cells, may be in liquid communication via a common supply or removal pipe 147 connected to the second volumes 143 of each of the plurality of cells. As the valves operate independently, it is self-evident that a possibility exists that two valves may be simultaneously open at any time. On such occasions, there would be a single, common body of water between the electrodes in the two individual cells. However, because the water in pipe 147, as well as in the two transiently opened second volumes 143, is pure water 146, and pure water is non-conductive, it will not be possible for a shunt current to be created. That is, because the connections between the individual reservoirs and the common water supply/removal system are made via non-conductive, pure water, shunt currents are not enabled.
   Accordingly, example embodiment cells with reservoirs of type 141 may be arrayed in a cell stack 750 with each reservoir connected to a single, common water supply/removal system 147 without creating the possibility of shunt currents. That is, an example embodiment may allow for a complete elimination of shunt currents and all the serious challenges that they bring to cells stacks 750.
(3) Lifting of restraints on the number of cells in the stack: In the absence of shunt currents, the restraints that exist in many conventional electrochemical cells regarding the number of cells that can be viably incorporated into a single high-voltage stack may be lifted. That is, example embodiments may allow for the number of cells within a stack to be tailored to the voltage output of the most efficient and/or lowest cost power supply that is available. This is presently not possible in many conventional electrochemical cells, which often must use bespoke power supplies that may be relatively inefficient and costly.
(4) Gas supply or removal may be done directly, using a single, common gas manifold: Another feature of example embodiment cell stacks 750 is that the gas bodies 125 in each of the cells 700 in a cell stack 750 may be connected to a single, common gas manifold, allowing for the gas in gas body 125 to be supplied to, or removed from the cell stack 750 via a single external fitting. Similarly, each gas body 135 in each of the cells 700 in a cell stack 750 may be connected to a single, common gas manifold, allowing for the gas in gas body 135 to be supplied to, or removed from the cell stack 750 from a single external fitting. Moreover, the use of single gas manifolds for each of gas bodies 125, 135 respectively, allows for the gases in these manifolds to be pressurized and, indeed, for the entire cell, including the reservoir, to be pressurized (if apertures like those at 149 in FIG. 1 are present). The gas bodies 125, 135 may be pressurized to the same pressure, or to pressures that differ by less than the bubble point of the electrolyte-infused porous capillary spacer 110 during operation. Furthermore, a gas that is supplied or removed via such a single gas manifold is in direct, gas-phase contact with the cross-plane axis of each cell, allowing for improved and self-regulated control.
(5) Elimination of the need for bubble management systems: In many conventional electrochemical cells, gases are produced in the form of bubbles. Such cells often have bubble management systems. For example, many cells continuously pump circulating electrolyte over the electrodes to dislodge bubbles as they are formed. Bubble-management systems may become increasingly complex and expensive as the number of cells in a cell stack increases (for example, because of the need to avoid transient pressure differentials at all points in such systems even when a large volume of the bubbles must be collected and separated in a gas-liquid separators). Example embodiment cell stacks of the type 750 may avoid the need for bubble management systems and all of the complexities that they introduce because any produced gases move directly into the gas bodies 125, 135 along gas-phase pathways 200 and are collected there.

### Example Embodiment Cells for Various Reactions

The following examples provide a more detailed discussion of embodiments. The examples are intended to be illustrative only and not limiting to the scope of the present invention.

Materials: The following materials were employed (Supplier): Porous polyethersulfone material filters (0.03 μm, 0.45 μm, 1.2 μm, 5 μm, and 8 μm pore diameter; supplied by Pall Corporation), Carbon black (AkzoNobel), 10% Pt on Vulcan XC-72 (Premetek Co. #P10A100), 20% Pt—Pd on Vulcan XC-72 (Premetek Co. #P13A200), nanoparticulate Ni (average diameter 20 nm) (American Elements; SDC Materials, Inc, Tempe, Arizona), PTFE dispersion (as binder or gas handling structure) (60 wt. % dispersion in alcohols/H₂O; Sigma-Aldrich #665800), PTFE fine powder (Alfa Aesar, A12613, 15-25 μm particle size), Nafion® dispersion (5% in in alcohols/water; Sigma Aldrich #527084), Sigracet™ carbon paper (Fuel Cell Store, 29BC), KOH 90%, flakes (Sigma-Aldrich #484016), H₂SO₄ 95-98% (Sigma-Aldrich #320501), Ni mesh, 200 LPI (Century Woven, Beijing) (cleaned using isopropyl alcohol prior to use), Ni foam (Goodfellows; TMax Battery Equipment, 1 mm thick, 97% porosity, density: 350±20 g/m²), Polypropylene-backed Preveil™ expanded PTFE (ePTFE) Gortex membranes with 0.2 m average pore diameter, produced by General Electric Energy, and Ti mesh (Goodfellows).

1. Example Electro-Synthetic Nitrogen Reduction Cell for Producing Ammonia from Nitrogen and Hydrogen or Oxygen; for Cracking Ammonia Back to Hydrogen and Nitrogen; for NO_{X} Cleanup. Example Ammonia Fuel Cell for Generating Electricity from Ammonia

Example embodiment nitrogen reduction cells having the architectures depicted in FIGS. 1-3 were fabricated using a porous polyethersulfone material filter with average pore diameter of 1.2 μm as the porous capillary spacer 110. The liquid electrolyte 100 was the ionic liquid, trihexyl(tetradecyl) phosphonium tris(pentafluoroethyl) trifluorophosphate ([P6,6,6,14][eFAP]) or the ionic liquid 1-butyl-1-methylpyrrolidinium tris(pentafluoroethyl) trifluorophosphate ([C4mpyr][eFAP]). The ionic liquid electrolyte 100 may be acidified. The electrode-current carrier assembly 420 comprised the Fe catalyst deposited on stainless steel cloth that is described in Zhou, F., et al. (2017), Electro-synthesis of ammonia from nitrogen at ambient temperature and pressure in ionic liquids, Energy & Environmental Science, 10(12), 2516-2520, which is incorporated herein by reference. The stainless steel cloth served as the current carrier 320. The counter electrode 130 involved a Sigracet™ carbon paper substrate sprayed on its microporous side with a thin catalyst layer of 10% Pt on Vulcan XC-72 with PTFE (from a PTFE dispersion) as binder. The electrode 130 was compressed against a Ni mesh that served as the current carrier 330 to thereby provide the electrode-current carrier assembly 430. The flow fields 620 and 630 in the full cell were Ni foam. The conductive busbars 640 were Ni coated stainless steel. A flow of nitrogen was passed through the cell as gas body 125. During its transit through the cell, while the cell was in operation, it came to also contain ammonia and hydrogen, so that the gas in gas body 125 passing out of the cell also contained ammonia and hydrogen. Pure hydrogen was introduced into the cell as gas body 135. In an alternative embodiment, oxygen or air-oxygen was introduced into the cell as gas body 135 (with suitable catalysts at the associated electrode). The produced ammonia was removed from the exiting gas body 125 by means known to the art.

Because of the very low total volume of liquid electrolyte required in the cell, it was practically possible to use an ionic liquid as the electrolyte. In conventional electro-synthetic or electro-energy cells, it is generally not viable to use an ionic liquid as the electrolyte because of scare availability and high cost.

In an alternative embodiment, the operation of the cell may be reversed with ammonia introduced into the cell, cracked into, i.e. producing, hydrogen and nitrogen. With the same catalysts and suitable applied voltages the cell produced hydrogen from ammonia.

In an alternative embodiment, the cell may be harnessed for NOₓ clean-up, i.e. using NO_{X} as a reactant, with NO_{X}-containing gases removed when passing through. In an alternative embodiment, the operation of the cell may be reversed with ammonia introduced into the cell as one of the gas bodies and oxygen or air-oxygen introduced into the cell as the other gas body, with the cell producing electricity.

2. Example Electro-Synthetic Chlor-Alkali Cell for Producing Chlorine, Hydrogen and Caustic from Brine

Example embodiment chlor-alkali cells for manufacturing chlorine, caustic and hydrogen from brine having the architecture depicted in FIGS. 1-2 were fabricated using a tri-layered porous capillary spacer 110, that was tightly compressed together in the overall cell and that comprised of, from one side to the other, in order: (i) layer 1: a GLA-5000 polyvinylchloride (PVC) material filter with average pore diameter of 5 μm (Pall Corp) containing within it, and having one end dipped into a liquid reservoir containing an aqueous solution of 280 g/L NaCl (brine), acidified to pH 3, (ii) layer 2: an industry standard perfluorinated sodium exchange membrane, and (iii) layer 3: a polyethersulfone material filter with average pore diameter of 8 μm, containing within it, and having one end dipped into a second, separate liquid reservoir containing an aqueous solution of 35% NaOH. The chlorine-generating electrode 120 comprised of a commercially available dimensionally stable anode (Permascand), which also served as the electrode-current carrier assembly 420. The hydrogen-generating electrode 130 involved a Sigracet™ carbon paper substrate sprayed on its microporous side with a thin catalyst layer of 10% Pt on Vulcan XC-72 with PTFE (from a PTFE dispersion) as binder. The electrode 130 was compressed against a Ni mesh that served as the current carrier 330 to thereby provide the electrode-current carrier assembly 430. The flow fields 620 and 630 in the overall cell were Ti mesh and Ni foam respectively. The conductive busbars 640 were Ti- and Ni-coated stainless steel respectively. Chlorine was produced by the cell as gas body 125, while hydrogen was produced by the cell as gas body 135. Sodium chloride (brine) was consumed from the reservoir containing acidified NaCl, while caustic (sodium hydroxide) was produced in the reservoir containing NaOH. Continuous replenishment and removal of these materials from their respective reservoirs could be undertaken by means known to persons skilled in the art.

3. Example Electro-Synthetic Oxygen-Depolarized Chlor-Alkali Cell for Producing Chlorine and Caustic from Brine

Example embodiment oxygen-depolarized chlor-alkali cells for manufacturing chlorine and caustic from brine having the architecture depicted in FIGS. 1-2 were fabricated using a tri-layered porous capillary spacer 110, that was tightly compressed together in the overall cell and that comprised of, from one side to the other, in order: (i) layer 1: a GLA-5000 polyvinylchloride (PVC) material filter with average pore diameter of 5 μm (Pall Corp) containing within it, and having one end dipped into a liquid reservoir containing an aqueous solution of 280 g/L NaCl, acidified to pH 3 (brine), (ii) layer 2: an industry standard perfluorinated sodium exchange membrane, and (iii) layer 3: a polyethersulfone material filter with average pore diameter of 8 μm, containing within it, and having one end dipped into a second and separate liquid reservoir containing an aqueous solution of 35% NOH. The chlorine-generating electrode 120 comprised of a commercial dimensionally stable anode (Permascand), which also served as the electrode-current carrier assembly 420. The oxygen-depolarised counter electrode 130 involved a Sigracet™ carbon paper substrate sprayed on its microporous side with a thin catalyst layer of 10% Pt on Vulcan XC-72 with PTFE (from a PTFE dispersion) as binder. The electrode 130 was compressed against a Ni mesh that served as the current carrier 330 to thereby provide the electrode-current carrier assembly 430. The flow fields 620 and 630 in the overall cell were Ti mesh and Ni foam respectively. The conductive busbars 640 were Ti- and Ni-coated stainless steel respectively. Chlorine was produced by the cell as gas body 125, while oxygen was passed into the cell as gas body 135. Sodium chloride (brine) was consumed from the reservoir containing acidified NaCl, while caustic (sodium hydroxide) was produced in the reservoir containing NaOH. Continuous replenishment and removal of these materials from their respective reservoirs could be undertaken by means known to persons skilled in the art.

### 4. Example Electro-Synthetic Cell for Recycling Hydrochloric Acid to Produce Chlorine and Hydrogen

Example embodiment cells for manufacturing chlorine and hydrogen from hydrochloric acid having the architectures depicted in FIG. 1 or FIG. 2 were fabricated using a GLA-5000 polyvinylchloride (PVC) material filter with average pore diameter of 5 μm (Pall Corp) as the porous capillary spacer 110. The liquid electrolyte 100 was aqueous 1 M HCl. The chlorine-generating electrode 120 comprised of a commercially available dimensionally stable anode (Permascand), which also served as the electrode-current carrier assembly 420. The hydrogen-generating electrode 130 involved a Sigracet™ carbon paper substrate sprayed on its microporous side with a thin catalyst layer of 10% Pt on Vulcan XC-72 with PTFE (from a PTFE dispersion) as binder. The electrode 130 was compressed against a Ni mesh that served as the current carrier 330 to thereby provide the electrode-current carrier assembly 430. The flow field 620 and 630 in the overall cell were Ti mesh and Ni foam respectively. The conductive busbars 640 were Ti- and Ni-coated stainless steel respectively. Chlorine was produced by the cell as gas body 125, while hydrogen was produced by the cell as gas body 135. Hydrochloric acid was consumed from reservoir 140. The reservoir 140 may be continuously replenished with hydrochloric acid by means known to persons skilled in the art.

5. Example Electro-Energy Fuel Cell for Producing Electrical Energy from Hydrogen and Oxygen

Example embodiment hydrogen-oxygen fuel cells having the architectures depicted in FIG. 1 or FIG. 2 were fabricated using a polyethersulfone material filter with average pore diameter of 8 μm, as the porous capillary spacer 110. The liquid electrolyte 100 was aqueous 6 M KOH. The first electrode 120 and the second electrode 130 both comprised of mixtures of 20% Pd/Pt on Vulcan XC-72, carbon black and PTFE (from a 60% PTFE dispersion) that were deposited on and compressed onto Ni meshes that served as the current carriers 320 and 330 respectively, to thereby provide the electrode-current carrier assemblies 420 and 430 respectively. The flow fields 620 and 630 in the full cell were Ni foam. The conductive busbars 640 were Ni coated stainless steel. Oxygen was introduced into the cell as gas body 125, while hydrogen was introduced into the cell as gas body 135.

In an alternative example, the electrode-current carrier assemblies 420 and 430 were fabricated as described in Wagner, K., Tiwari, P., Swiegers, G. F. & Wallace, G. G., ‘Alkaline Fuel Cells with Novel Gortex-Based Electrodes are Powered Remarkably Efficiently by Methane Containing 5% Hydrogen’, Advanced Energy Materials, 8 (7), 1702285-1-1702285-10, incorporated herein by reference. As the resulting electrode-current carrier assemblies 420 and 430 had a non-conductive Gortex membrane backing on them, the flow-fields 620 and 630 were cut to have sharp projections on their electrode-facing sides. These projections cut through the Gortex backing on 420 and 430, to thereby establish electrical connections between the first electrode 120 and the second electrode 130 and their respective flow fields 420 and 430.

These examples represent variations in the electrode-spacer interfaces 126 and 136 respectively, to thereby alter or better control or accelerate the capillarity and/or diffusion processes for gas-phases materials moving along the pathways 200, as described with reference to FIG. 4.

The fuel cells operated as described in the above cited scientific paper. Water was produced as the reaction product in the reservoir 140. The water could be continuously removed from the reservoir 140 by various means known to the person skilled in the art.

Cells having the architecture depicted in FIG. 3 could be made by the same process, wherein the liquid electrolyte in the porous capillary spacer was maintained in a non-interfering manner by evaporation of water, causing humidification of the hydrogen and/or oxygen gas steam. The humified hydrogen and/or oxygen was circulated through the cell and dried outside of the cell to remove the evaporated moisture.

6. Example Electro-Synthetic Water Electrolysis Cell for Producing Hydrogen and Oxygen from Water

Example embodiment water electrolysis cells having the architecture depicted in FIG. 1 or FIG. 2 were fabricated using a polyethersulfone material filter with average pore diameter of 8 μm as the porous capillary spacer 110. The liquid electrolyte 100 was aqueous 6 M KOH.

The hydrogen-generating electrode 130 was fabricated as taught in the scientific paper entitled: “An Alkaline Water Electrolyzer with Sustainion™ Membranes: 1 A/cm² at 1.9 V with Base Metal Catalysts” by Z. Liu, S. D. Sajjad, Yan Gao, J. J. Kaczur, and R. I. Masel, in ECS Transactions (2017) 77 (9), 71-73, which is incorporated herein by reference. This procedure involved spraying a Sigracet™ carbon paper substrate on its microporous side with a thin catalyst layer of 10% Pt on Vulcan XC-72 (0.5 mg Pt/cm²) with 5% Nafion® as binder (26% by weight). The electrode 130 was compressed against a Ni mesh that served as the current carrier 330 to thereby provide the electrode-current carrier assembly 430.

The oxygen-generating electrode 120 comprised of a fine nickel mesh (200 LPI) that had been electrocoated with NiFe catalyst as described in the scientific paper entitled: “Novel NiFe/NiFe-LDH composites as competitive catalysts for clean energy purposes” by A. M. P. Sakita, E. Vallés, R. Della Noce, and A. V. Benedetti, in Applied Surface Science 447 (2018) 107-116, which is incorporated herein by reference. The nickel mesh was placed in an electrocoating solution that comprised of: a 3:1 mixture of NiCl₂ (0.075 M) and FeCl₂ (0.025 M) (following FIG. 8(c) and FIG. 1(a) in the above paper), along with 1 M KCl supporting electrolyte (following FIG. 8(b) in the above paper). The nickel mesh immersed in the electrocoating solution was coated with NiFe by repeated cycling using cyclic voltammetry between −1.0 V and −0.2 V (vs Ag/AgCl) at 10 mV/s (following FIG. 1 in the above paper). The lower voltage of −1.0 V was chosen as it allowed for inclusion of a gas handling material, without formation of a precipitate, as described in the next paragraph. The upper voltage of −0.2 V provided the best performance of the resulting catalyst. Coating was continued until a charge of 16.6 C had been deposited (for an electrode with 1 cm² geometric area). The Ni mesh itself served as the current carrier 320, to thereby provide the electrode-current carrier assembly 420. The flow fields 620 and 630 in the overall cell were Ni foam. The conductive busbars 640 were nickel. Oxygen was produced by the cell as gas body 125, while hydrogen was produced by the cell as gas body 135.

Cells having the architecture depicted in FIG. 3 could be made by the same process, wherein the liquid electrolyte in the porous capillary spacer was maintained in a non-interfering way by condensation of water, from a humidification of the hydrogen and/or oxygen gas steam. The hydrogen and/or oxygen was circulated through the cell and humified external to the cell to facilitate condensation of vapour in the porous capillary spacer.

### 6.1 Example: Inclusion of a Gas Handling Structure in an Electrode

The above electrode 120 was modified to include a gas handling structure, comprising of the low surface energy material polytetrafluoroethylene (PTFE). As noted above, PTFE has a propensity to scavenge and coalesce dissolved gases on its surface. The gases may further migrate along its surface into the gas body 125 without forming bubbles in the liquid electrolyte. The PTFE gas handling structure was incorporated into electrode 120 by incorporating a PTFE dispersion (60 wt. % dispersion in alcohols/H₂O; 10 g/L) in the above electrocoating solution. The fabrication procedure was otherwise as stated above.

6.2 Example: Comparison with a Fully Flooded Cell

For comparative purposes a cell was also fabricated in which the above-described electrode-spacer-electrode assembly (139) was flooded with liquid electrolyte. Such a cell corresponds to the architecture depicted in FIG. 2, wherein A and B were both to the top of the cell; that is, the electrodes were entirely covered with liquid electrolyte and there were no gas bodies 125 and 135 whatsoever present. This is the conventional cell arrangement for a water electrolysis cell, with the gases generated in the form of gas bubbles in the liquid electrolyte. Gas was formed in the cell as gas bubbles that rose to the top of the cell.

### 6.3 Example: Demonstration of Improved Energy Efficiency by an Embodiment Cell

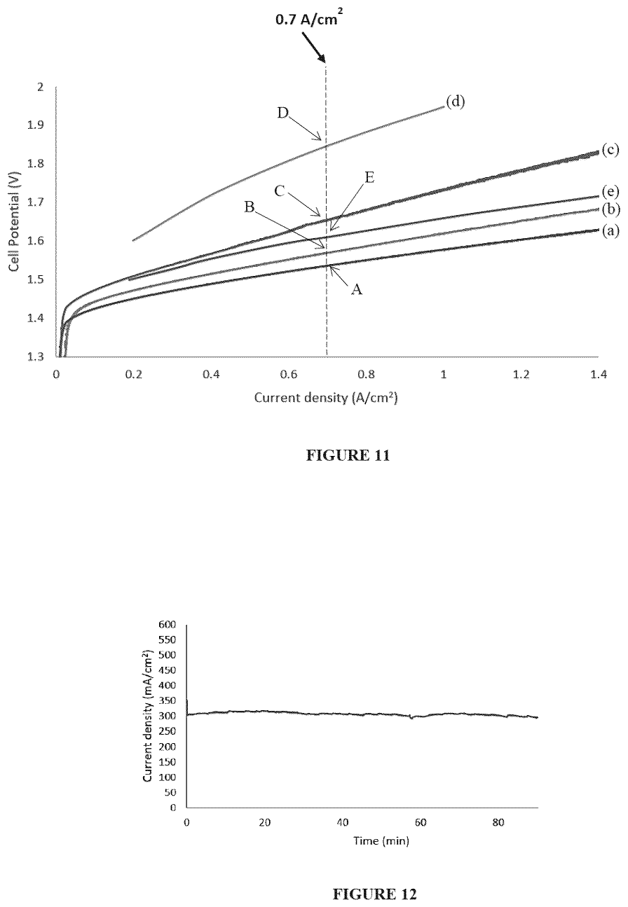

FIG. 11(a)-(b) depict polarisation curves at 80° C. of the resulting water electrolyzers having the cell architecture in FIG. 1. It should be noted that these curves are not corrected for internal resistance; that is, they include the resistance imparted by busbars 640 and conductive flow fields 620, 630.

Curve (a) in FIG. 11 depicts the polarisation curve of the cell wherein the oxygen-generating electrode described above (120/320/420) incorporated the above-mentioned PTFE gas handling structure. This cell displayed an overall cell resistance, not corrected for internal resistance, as low as 118.2 Ω cm², which was the lowest of any tested or, indeed, of any that the inventors were aware of. Curve (b) in FIG. 11 depicts the polarisation curve of the same cell but wherein the oxygen-generating electrode described above (120/320/420) did not incorporate the PTFE gas handling structure described above.

Curve (c) in FIG. 11 depicts the polarisation curve of a comparable water electrolysis cell employing the same porous capillary spacer and the same electrodes described above, but wherein the cell was fully filled with liquid electrolyte. This is the conventional cell arrangement for a water electrolysis cell, with the gases generated in the form of gas bubbles in the liquid electrolyte. FIG. 11 depicts comparable polarisation curves (d)-(e) at 80° C. of cells of the best commercial alkaline water electrolyzer and PEM water electrolyzer, respectively, whose data was publicly available.

Curves (a) and (b) in FIG. 11 can be seen to improve notably upon the comparable fully flooded cell in curve (c), which used the same electrodes and porous capillary spacer but wherein the gases were produced in the form of gas bubbles in the liquid electrolyte. This demonstrated the improved energy efficiency of the example embodiment cell architecture when compared to the conventional cell architecture.

Curves (a) and (b) in FIG. 11 also improved substantially upon the best commercial alkaline water electrolysis cell (FIG. 11 curve (d)) and commercial PEM water electrolysis cell (FIG. 11 curve (e)). This demonstrated the improved energy efficiency of the example embodiment cell architecture, especially when considering that the cells in FIG. 11(a)-(b) are alkaline water electrolysis cells, which are notably cheaper, more durable, and have a significantly longer lifetime than PEM water electrolysis cells of the type depicted in FIG. 11(e).

It is also notable that curve (c) in FIG. 11, which involves an alkaline electrolysis cell, drastically improves upon the best commercial alkaline water electrolysis cell (FIG. 11 curve (d)). This demonstrated that, under comparable conditions, the architecture depicted in FIG. 2, wherein A and B both extend to the top of the cell, also provides an improved efficiency, albeit a lesser improved efficiency than the cells in FIG. 11(a)-(b). The reason is that the cell in FIG. 11(c) is an ‘independent pathway cell’.

Thus, for example, comparing the cells in their capacity to produce hydrogen at a current density of 0.7 A/cm² (the dashed line in FIG. 11):
the cell in FIG. 11 curve (a) required only 1.536 V (point A), which equates to 96% energy efficiency relative to the higher heating value (HHV) of hydrogen.
the cell in FIG. 11 curve (b) required only 1.568 V (point B), which equates to 94% energy efficiency relative to the higher heating value (HHV) of hydrogen.
the cell in FIG. 11 curve (c) required 1.655 V (point C), which equates to 89% energy efficiency relative to the higher heating value (HHV) of hydrogen.
the best commercial alkaline water electrolysis cell in FIG. 11 curve (d) required 1.84 V (point D), which equates to 80% energy efficiency (HHV)
the best commercial PEM water electrolysis cell in FIG. 11 curve (e) required 1.61 V (point E), which equates to 91% energy efficiency (HHV)

The capacity for improved energy efficiency is further demonstrated by FIG. 12, which depicts the performance over time of the cell in FIG. 11 curve (a) when it was held at a fixed cell voltage of 1.47 V at 80° C., which represents 100% energy efficiency (HHV). As can be seen, the cell produced a steady 300 mA/cm² (=0.3 A/cm²) at 100% energy efficiency (HHV). By contrast, the best publicly reported current at 1.47 V at 80° C. by a commercial alkaline electrolysis cell is ˜0.1 A/cm² and by a commercial PEM electrolysis cell is ˜0.2 mA/cm².

### 6.4 Example: Demonstration of Lower Inter-Electrode Resistance

There were several contributors to the improved energy efficiency of the cell in FIG. 11 curve (a). These included the lower resistance of the porous capillary spacer in FIG. 11 curve (a), which was 22 mΩ cm² at 80° C., compared to ˜130 mΩ cm² at 80° C. for the Zirfon PERL® separator membrane in FIG. 11 curve (d) and ˜74 mΩ cm² at 80° C. for the Nafion® 115 separator membrane in FIG. 11 curve (e) at 80° C. The effect was to lower the voltage required at 1 A/cm² for the cell in FIG. 11 curve (a) by ˜0.108 V relative to the cell in FIG. 11 curve (d) and by ˜0.052 V relative to the cell in FIG. 11 curve (e).

### 6.5 Example: Demonstration of Lower Gas Crossover

The cell in FIG. 11 curve (a) had a low benchmark gas crossover, with the % H₂-in-O₂ being 0.04-0.14% and the % O₂-in-H₂ being 0.00%. By comparison, Zirfon PERL® is believed to display a benchmark gas crossover when used in a comparable, fully flooded alkaline water electrolysis cell of >0.22%.

### 6.6 Example: Demonstration of Improved Energy Efficiency Due to the Inclusion of a Gas Handling Structure in an Electrode

As can be seen, curve (a) in FIG. 11 improved on curve (b) in FIG. 11, indicating that incorporation of the PTFE gas handling structure in the oxygen generating electrode had a beneficial effect. The gas handling structure assisted newly formed gases to leave the electrode without forming visible gas bubbles. It did so by decreasing the surface energy of the pathways along which the gases departed.

6.7 Example: Demonstration of Improved Energy Efficiency Due to the Electrodes being ‘Bubble-Free’

Another major contributor to the improved energy efficiency in FIG. 11 curve (a) was therefore the absence of visible gas bubbles at either electrode. This notably improved the energy efficiency of, and diminished the voltages required for electrolysis as indicated by the comparison with FIG. 11 curve (c).

In this example, a thin layer of liquid electrolyte (less than 0.125 mm thick) appears to have been drawn onto the catalytic surfaces of the electrodes from the porous capillary spacer 110. When gas was then generated by the electrodes, it migrated through the thin layer of electrolyte to its nearby, external surface and crossed that interface to join the respective gas bodies 125 and 135. Alternatively, or additionally, within the oxygen-generating electrode 120, newly formed oxygen gas coalesced on the PTFE surfaces present in the electrode and migrated along them to join the oxygen gas body 125.

Accordingly, there was no need to expel gas by forming gas bubbles on or near the electrode surfaces. As a result, the electrodes were not masked with gas bubbles as they may be in conventional, bubbled systems. Moreover, the liquid electrolyte near the electrode surface did not have to be supersaturated with gas to nucleate gas bubble formation. In so doing, the additional voltage that may be required to create such supersaturation, was avoided. Furthermore, whereas bubbles tend to form in (and often strongly cling to) the clefts, cracks and defects on an electrode surface, which are also the most catalytically active sites present, such sites were largely unaffected and operating at full catalytic activity in the absence of gas bubble formation. The catalytic surface of the electrodes was, therefore, more fully used, for all the time.

6.8 Example: The Water Electrolysis Cell was an ‘Independent Pathway Cell’ that Demonstrated Improved Energy Efficiency

The fact that the porous capillary spacer 110 was able to indefinitely supply the liquid-phase reactants that the electrodes 120 and 130 needed to sustain the reaction, whilst the gas products moved away from the electrodes in a complementary direction to the liquid-phase movements, indicated that counter multiphase flows were avoided and at least one separate, independent, and non-interfering pathway was available for the movement (flow) of each individual liquid-phase and gas-phase reactant and product within the cell.

Accordingly, the cells in FIGS. 11(a)-(b) were ‘independent pathway cells’ and this was, fundamentally, the reason for their higher energy efficiency. The cell in FIG. 11(c) was also an independent pathway cell, although of lowered energy efficiency because of the gas bubbles formed. That is, it avoided the energy needed to overcome the inefficiencies associated with counter multiphase flows, but not that associated with bubble formation.

The bubble-free action of the cells in FIGS. 11(a)-(b) increased the efficiency of the pathway for removing gas from the bubble-free electrode. The inclusion of a gas handling structure at the oxygen electrode provided for a particularly improved pathway for removing gas from that electrode. The effect was to improve the efficiency of molecular-level motions in the cell and thereby increase the energy efficiency of the cell.

This example therefore demonstrates why independent pathway cells may achieve higher energy efficiencies than other cells. It also shows that the improvements in energy efficiency may be substantial.

6.9 Example: Demonstration of High Energy Efficiency after Modifying an Electrode Surface to Facilitate Capillary-Induced Movement of Electrolyte Up the Electrode

As noted above, capillary-induced movements of liquid electrolyte along and up an electrode may typically interfere with and even block gas movements between the electrodes and their associated gas bodies. This may decrease the energy efficiency of the cell, often substantially.

However, if such movements are engineered to be limited to very thin layers of liquid electrolyte moving on the surface of the electrode, then there may be no interference with, or hindrance of gas movements, and no deleterious effects on energy efficiency.

Such capillary-induced transport of a thin-film of liquid electrolyte may be engineered by depositing a thin hydrophobic layer on the electrode surface as described below and employing a cell design like that depicted in FIG. 2.

A nickel foam was used as an alternative oxygen electrode in the above water electrolyzer. The nickel foam was ultrasonicated in ethanol for 10 min to remove any organic residues and then rinsed with water prior to further ultrasonication cleaning in 3 M HCl for 20 min, followed by water rinsing and drying. The Ni foam was then immersed in an autoclave containing an aqueous solution of 43 mM NiNO₃ and 14.3 mM FeNO₃, and 0.28 M urea and heated at 120° C. for 12 h. The resulting electrode was washed with water and allowed to dry in air.

The thin layer of NiFe layered double hydroxide (LDH) that was deposited using this method was both strongly hydrophilic and a good catalyst for oxygen-generation from water. Its high hydrophilicity saw it facilitate upward, capillary-based movement of a thin layer of 6 M KOH liquid electrolyte on the electrode surface at a rate of >5 cm/min. This was a notably faster rate of movement than that exhibited by the porous capillary spacer 110 comprising polyethersulfone material filter with 8 μm pore diameter.

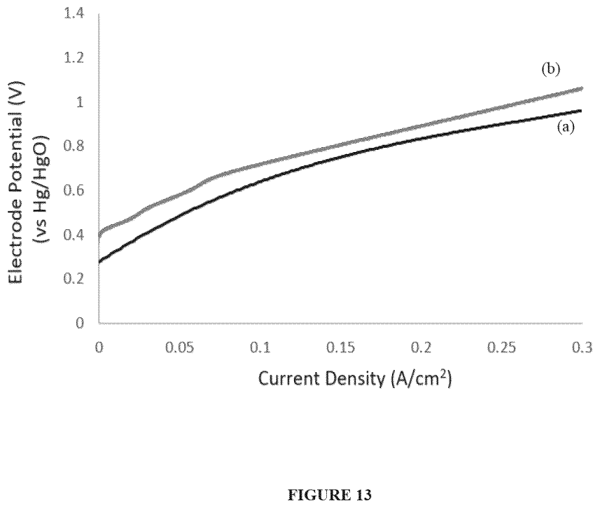

During catalytic oxygen-generation, the above NiFe-coated Ni foam also exhibited high energy efficiency that was comparable to the oxygen electrode in FIG. 11 curve (a). FIG. 13 depicts a comparison of the electrode potential of the oxygen electrode vs current density of:
(a) the oxygen electrode in the cell in FIG. 11 curve (a), and
(b) the above NiFe-coated Ni foam when used as the oxygen electrode in the cell in FIG. 11 curve (a).
   As can be seen, the performance of the two electrodes is very similar indicating that the capillary-induced movement on the surface of the NiFe-coated Ni foam electrodes did not significantly decrease its energy efficiency.

### 6.10 Example: Incorporation of a Gas Handling Structure in a Surface Modified Electrode

The above-described Ni foam electrode could also be modified to incorporate a PTFE gas handling structure during its surface modification.

This was achieved as follows: an aqueous solution of 43 mM NiNO₃ and 14.3 mM FeNO₃, and 0.28 M urea was heated in an autoclave at 120° C. for 12 h. The obtained NiFe-LDH catalyst was collected, and centrifugally washed with deionized water three times before drying in a vacuum oven at room temperature. A dispersion of the resulting NiFe powder was prepared in a solution containing isopropanol and water (4:1 vol %), with addition of a dispersion of Nafion® (10 g/L) The NiFe-LDH dispersion was then airbrushed on the pre-cleaned Ni foam or Ni mesh to obtain a NiFe-LDH coated electrode at the desired weight/thickness.

### 6.11 Example: Inclusion of a Gas Capillary Structure in an Electrode

In an alternative example, the electrode-current carrier assemblies 420 and 430 were fabricated to incorporate a gas capillary structure, which, in this case, was a hydrophobic Gore-Tex™ membrane (i.e. a hydrophobic membrane including expanded polytetrafluoroethylene (ePTFE)), whose PTFE side was placed tight up against the outside of the electrode-current carrier assemblies 420 and 430. In the final assembled cell, the outside of the electrode including the Gore-Tex™ membrane was then in contact with the respective flow-field 620 or 630. The generic version of Gore-Tex™ membrane is known as ‘Gortex’ membrane.

Gore-Tex™ or Gortex membranes comprise gas capillary structures that spontaneously extract newly formed gases from such closely adjacent gas-generating electrodes.

As the resulting electrodes-current carrier assemblies had a non-conductive Gortex membrane backing them, the flow-fields 620 and 630 were cut to create sharp projections on their electrode-facing sides. These projections cut through the Gortex membrane backing on 420 and 430, to thereby establish electrical connections between the first electrode 120 and the second electrode 130 and their respective flow fields 420 and 430.

These examples represent variations in the electrode-spacer interfaces 126 and 136 respectively, to thereby alter or better control or accelerate the capillarity and/or diffusion processes for gas-phases materials moving along the pathways 200, as described with reference to FIG. 4.

The water electrolysis cell operated as described in the above cited scientific paper. Reactant water was continuously removed from the reservoir 140. Water could be replenished to the reservoir 140 by various means known to persons skilled in the art.

7. Example: Electro-Synthetic Extraction Cell for Extracting Pure Hydrogen from Gas Mixtures Containing Hydrogen

Example embodiment hydrogen extraction cells having the architectures depicted in FIGS. 1-3 were fabricated using a polyethersulfone material filter with average pore diameter of 1.2 μm as the porous capillary spacer 110. The liquid electrolyte 100 was aqueous 1 M sulfuric acid. The first electrode 120 and the second electrode 130 both comprised of mixtures of 10% Pt on Vulcan XC-32, carbon black and 20% PTFE dispersions that were deposited on and compressed onto Ni meshes that served as the current carriers 320 and 330 respectively, to thereby provide the electrode-current carrier assemblies 420 and 430 respectively. The flow fields 620 and 630 in the full cell were Ni foam. The conductive busbars 640 were Ni coated stainless steel. A mixture of methane and hydrogen (for example in 5-10% by volume) was passed into and through the cell as gas body 125, while pure hydrogen was produced by the cell as gas body 135.

In an alternative example, the electrode-current carrier assemblies 420 and 430 were fabricated as described in K. Wagner et al., An electrochemical cell with Gortex-based electrodes capable of extracting pure hydrogen from highly dilute hydrogen-methane mixtures, Energy and Environmental Science, 2018, Vol. 11, page 172, which is incorporated herein by reference. As the resulting electrode-current carrier assemblies have a non-conductive Gortex membrane backing them, the flow-fields 620 and 630 were cut to create sharp projections on their electrode-facing sides. These projections cut through the Gortex membrane backing on 420 and 430, to thereby establish an electrical connection between the first electrode 120 and the second electrode 130 and their respective flow fields 420 and 430.

These examples represent variations in the electrode-spacer interfaces 126 and 136 respectively, to thereby alter or better control the capillarity and/or diffusion processes for gas-phases materials moving along the pathways 200, as described with reference to FIG. 4. The hydrogen-extraction cell operated as described in the above cited scientific paper.

### Further Example Cell Architectures

It is to be understood that a variety of other cell architectures may fall within the scope of the present specification. Architectures that incorporate parts, elements and features of the embodiments referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

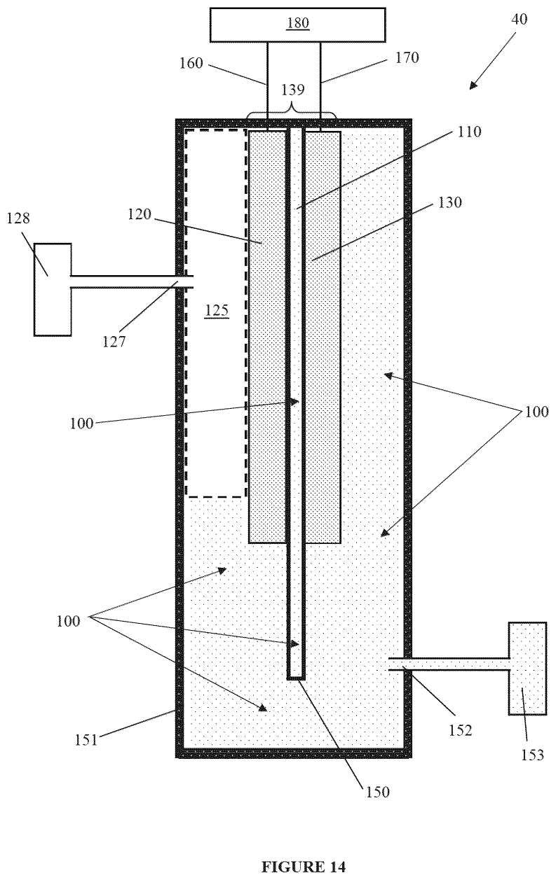

Illustrative, but non-limiting, selections of other example architectures are provided in FIGS. 14-33.

FIG. 14 illustrates a schematic cross-sectional view of a further example electro-synthetic or electro-energy cell 40, in which there is no gas body 135. The electrode 130 produces or consumes little/no gas, and there is non-interfering, capillary-based, electrolyte migration up electrode 120.

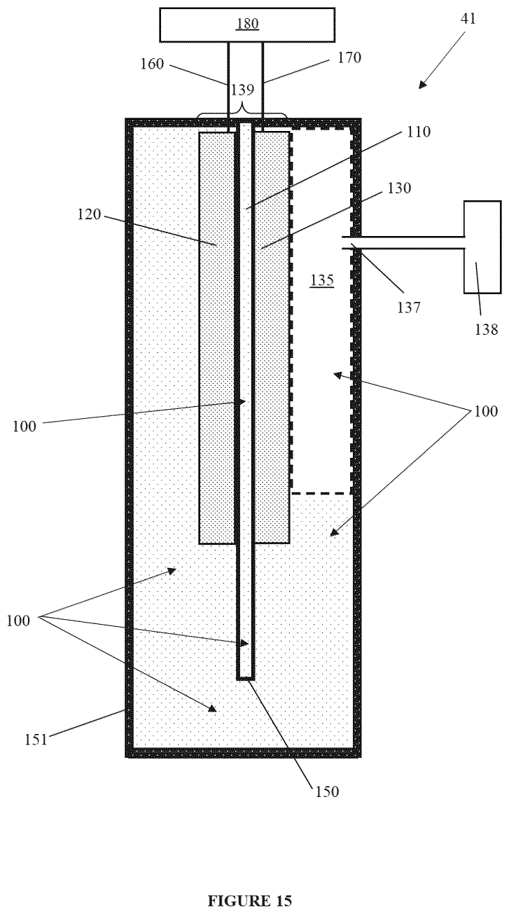

FIG. 15 illustrates a schematic cross-sectional view of a further example electro-synthetic or electro-energy cell 41, in which there is no gas body 125. The electrode 120 produces or consumes little/no gas, and there is non-interfering, capillary-based, electrolyte migration up electrode 130. The liquid electrolyte is replenished/maintained by a non-interfering vapour-phase pathway via gas body 135.

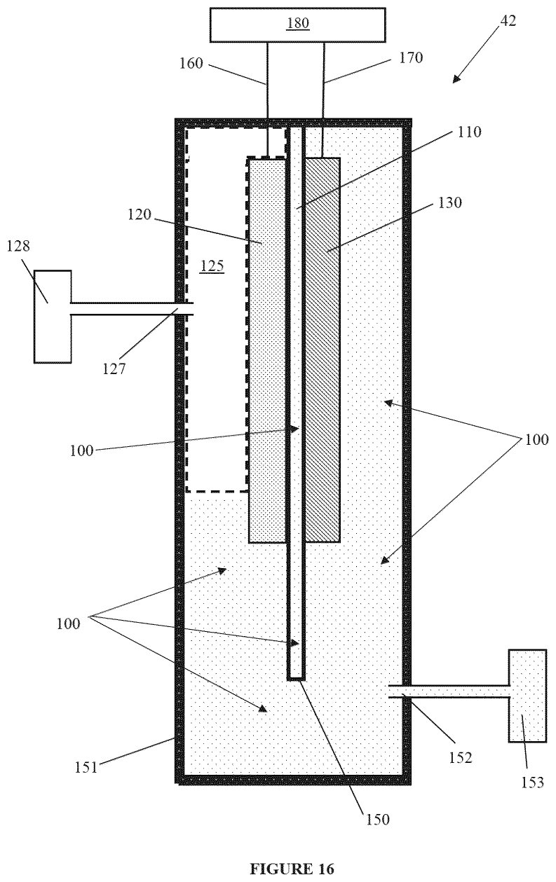

FIG. 16 illustrates a schematic cross-sectional view of a further example electro-synthetic or electro-energy cell 42, in which there is no gas body 135. The electrode 130 produces or consumes little/no gas, and there is non-interfering, capillary-based, electrolyte migration up electrode 120. There are provided headspaces above both electrodes. A headspace is occupied by liquid electrolyte above electrode 130 and by gas above electrode 120. The liquid electrolyte held in the porous capillary spacer 110 blocks gas crossover.

FIG. 17 illustrates a schematic cross-sectional view of a further example electro-synthetic or electro-energy cell 43, in which there is non-interfering, capillary-based, electrolyte migration up electrode 130, and non-interfering, capillary-based, electrolyte migration up electrode 120. There are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas bodies 125 and 135.

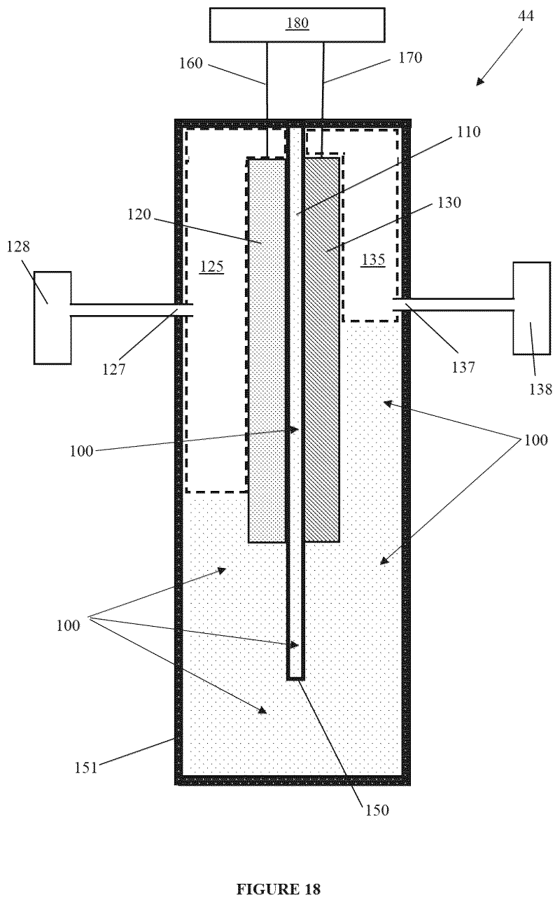

FIG. 18 illustrates a schematic cross-sectional view of a further example electro-synthetic or electro-energy cell 44, in which there is non-interfering, capillary-based, electrolyte migration up electrode 130, and there is non-interfering, capillary-based, electrolyte migration up electrode 120. There are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas bodies 125 and 135. The liquid electrolyte is replenished/maintained by a non-interfering vapour-phase pathway via gas body 125.

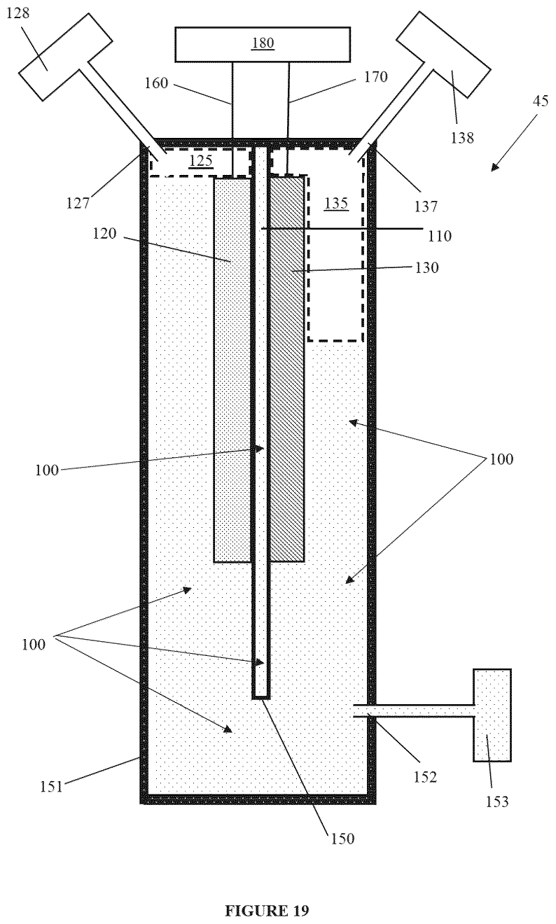

FIG. 19 illustrates a schematic cross-sectional view of a further example electro-synthetic or electro-energy cell 45, in which there is non-interfering, capillary-based, electrolyte migration up electrode 130. There are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas bodies 125 and 135. Electrode 120 contacts gas body 125 at the top of the electrode only (in the headspace).

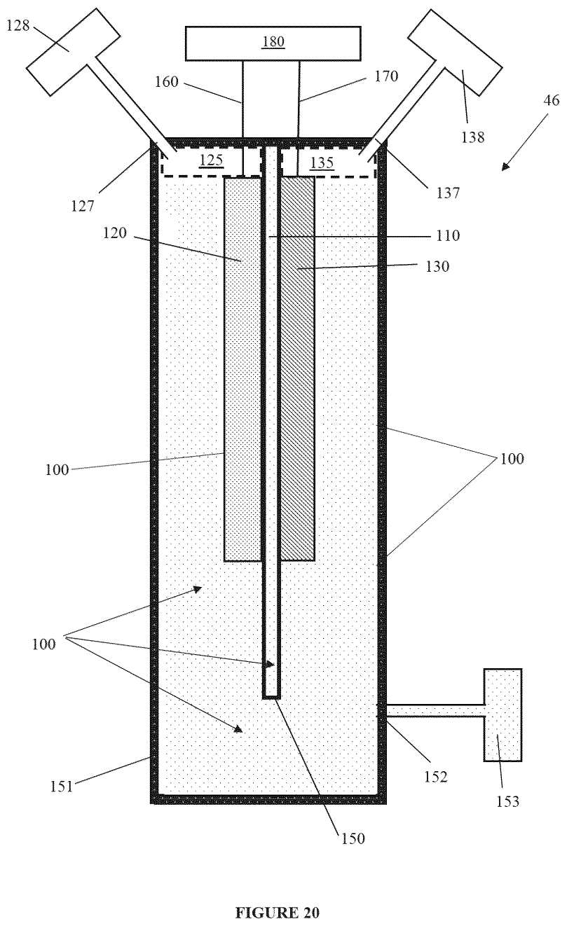

FIG. 20 illustrates a schematic cross-sectional view of a further example electro-synthetic or electro-energy cell 46, in which there are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas bodies 125 and 135. Electrode 120 contacts gas body 125 at the top of the electrode only (in the headspace). Electrode 130 contacts gas body 135 at the top of the electrode only (in the headspace).

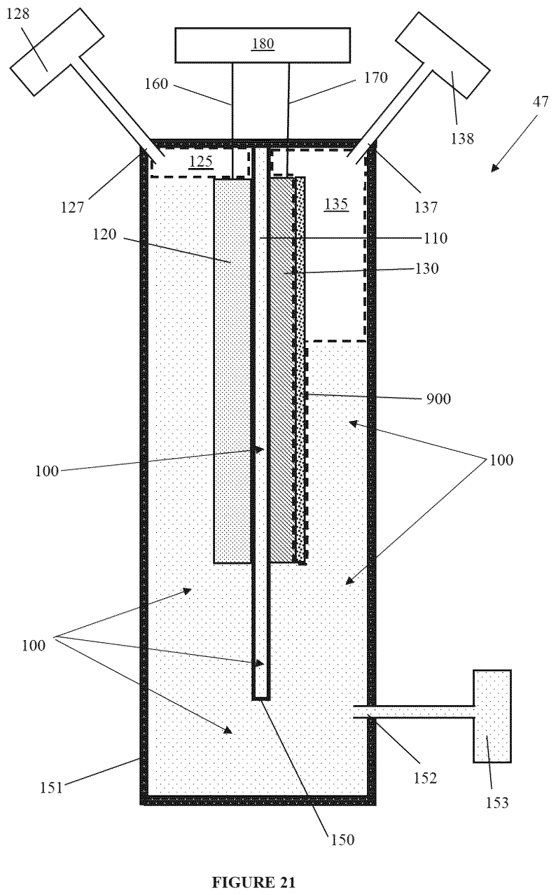

FIG. 21 illustrates a schematic cross-sectional view of a further example electro-synthetic or electro-energy cell 47, in which there is non-interfering, capillary-based, electrolyte migration up electrode 130. There are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas body 125 and gas body 135. Electrode 120 contacts gas body 125 at the top of the electrode only (in the headspace). Electrode 130 incorporates a gas handling structure 900, which is filled with gas that is contiguous with the headspace (collectively forming gas body 135).

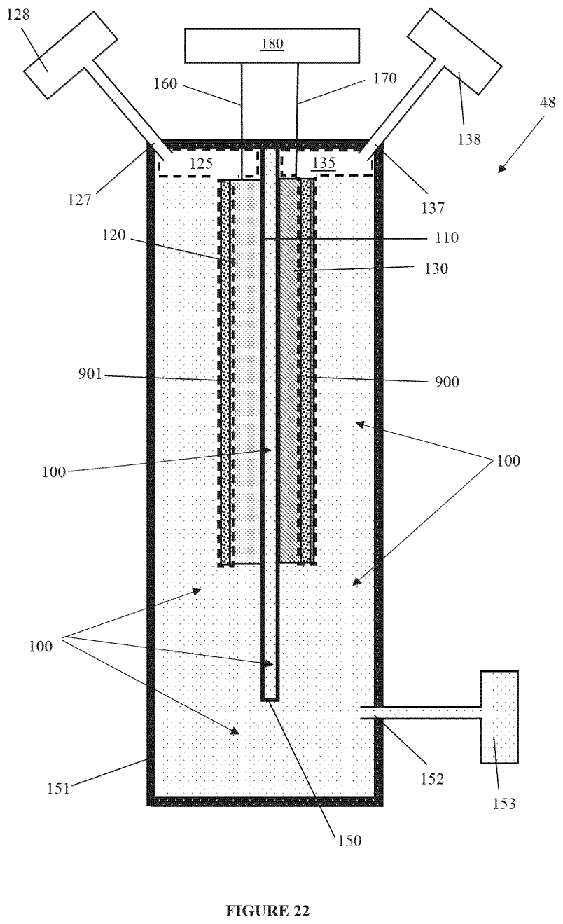

FIG. 22 illustrates a schematic cross-sectional view of a further example electro-synthetic or electro-energy cell 48, in which there are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas body 125 and gas body 135. Electrode 120 incorporates a gas handling structure 901, which is filled with gas that is contiguous with the headspace (collectively forming gas body 125). Electrode 130 incorporates a gas handling structure 900, which is filled with gas that is contiguous with the headspace (collectively forming gas body 135).

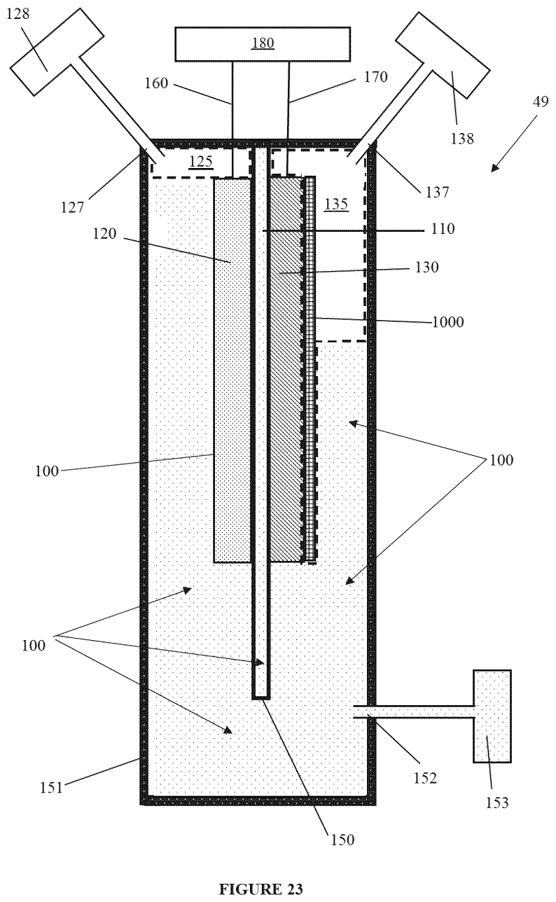

FIG. 23 illustrates a schematic cross-sectional view of a further example electro-synthetic or electro-energy cell 49, in which there is non-interfering, capillary-based, electrolyte migration up electrode 130. There are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas body 125 and gas body 135. Electrode 120 contacts gas body 125 at the top of the electrode only (in the headspace). Electrode 130 is adjacent to a gas capillary structure 1000, which is filled with gas that is contiguous with the headspace (collectively forming gas body 135).

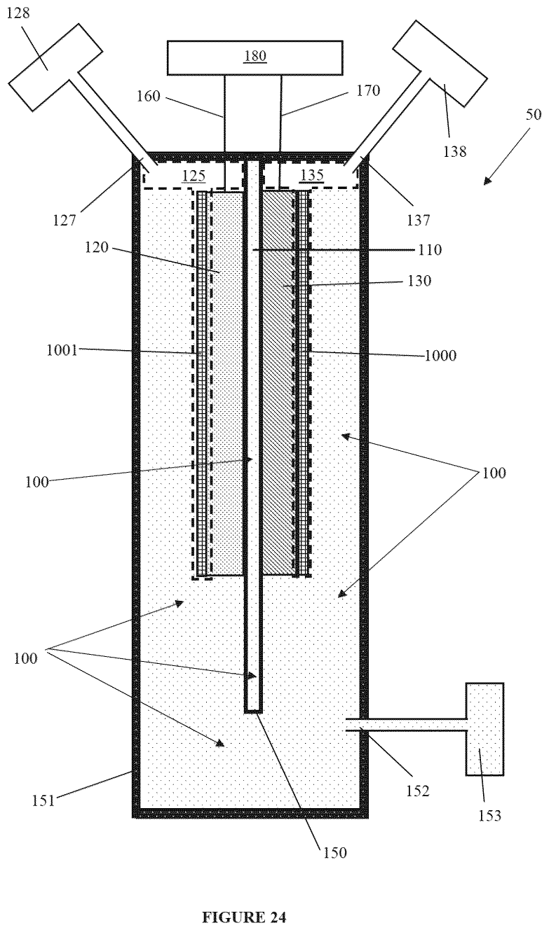

FIG. 24 illustrates a schematic cross-sectional view of a further example electro-synthetic or electro-energy cell 50, in which there are provided headspaces above both electrodes. The headspace above electrode 120 is occupied by gas body 125. The headspace above electrode 130 is occupied by gas body 135. The liquid electrolyte held in the porous capillary spacer 110 blocks gas crossover between gas body 125 and gas body 135. Electrode 120 is adjacent to a gas capillary structure 1001, which is filled with gas that is contiguous with the headspace (collectively forming gas body 125). Electrode 130 is adjacent to a gas capillary structure 1000, which is filled with gas that is contiguous with the headspace (collectively forming gas body 135).

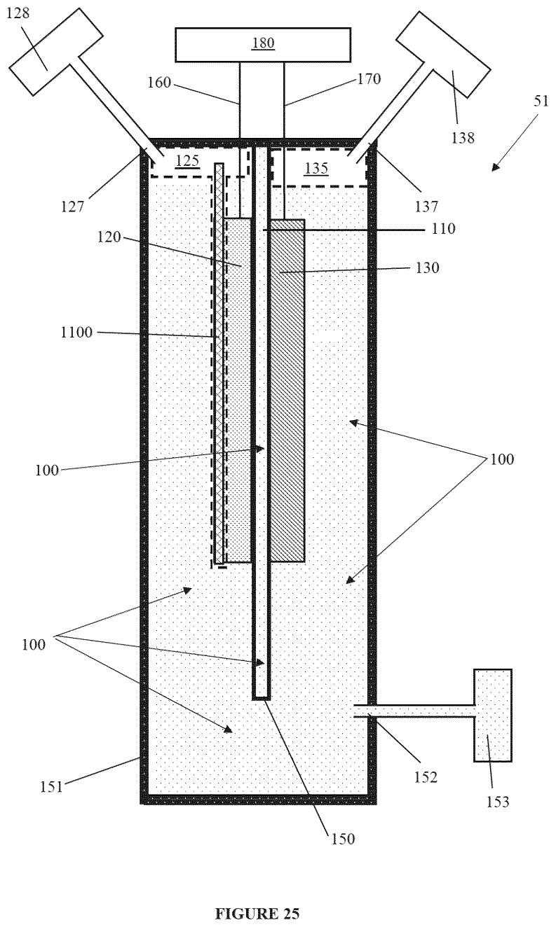

FIG. 25 illustrates a schematic cross-sectional view of a further example electro-synthetic or electro-energy cell 51, in which electrode 130 produces or consumes little or no gas. There are provided headspaces above both electrodes. The headspace above electrode 120 is partially occupied by gas body 125 and partially occupied by liquid electrolyte 100. The headspace above electrode 130 is partially occupied by gas body 135 and partially occupied by liquid electrolyte 100. The liquid electrolyte held in the porous capillary spacer 110 blocks gas crossover between gas body 125 and gas body 135. Electrode 120 has an attached or incorporated gas capillary or gas handling structure 1100, which extends through the liquid electrolyte 100 above the electrode to the headspace. Gas capillary or gas handling structure 1100 is filled with gas that is contiguous with the headspace gas (collectively forming gas body 125).

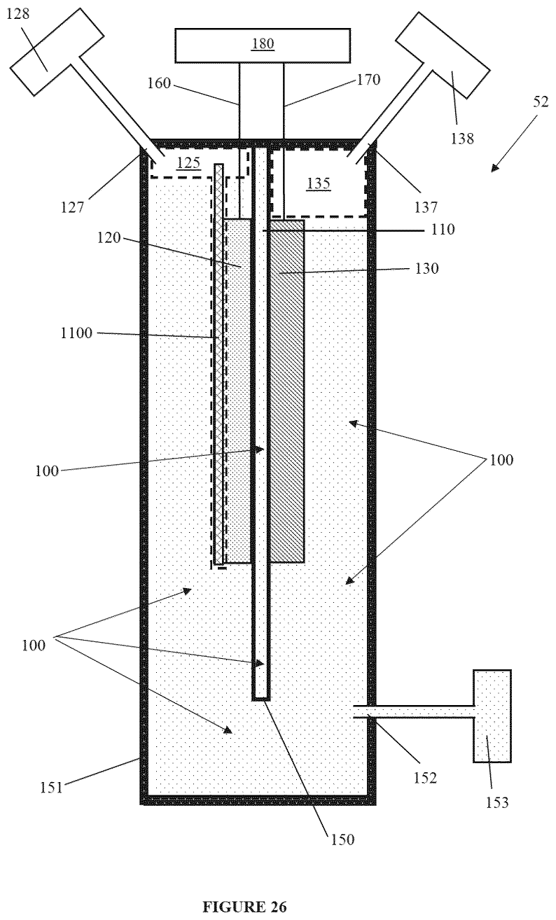

FIG. 26 illustrates a schematic cross-sectional view of a further example electro-synthetic or electro-energy cell 52, in which there are provided headspaces above both electrodes. The headspace above electrode 120 is partially occupied by gas body 125 and partially occupied by liquid electrolyte 100. The headspace above electrode 130 is occupied by gas body 135. The liquid electrolyte held in the porous capillary spacer 110 blocks gas crossover between gas body 125 and gas body 135. Electrode 120 has an attached or incorporated gas capillary or gas handling structure 1100, which extends through the liquid electrolyte 100 above the electrode to the headspace. Gas capillary or gas handling structure 1100 is filled with gas that is contiguous with the headspace gas (collectively forming gas body 125). Electrode 130 contacts gas body 135 only at its top (in the headspace).

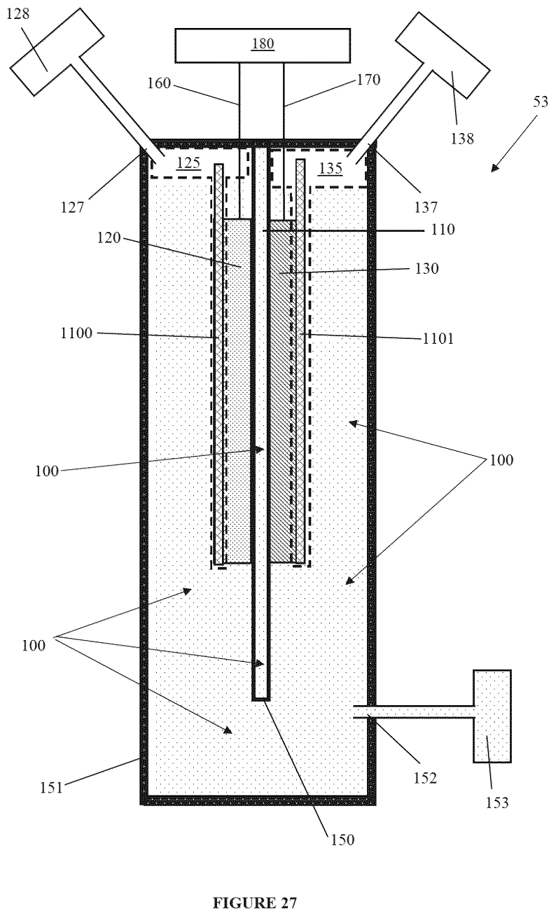

FIG. 27 illustrates a schematic cross-sectional view of a further example electro-synthetic or electro-energy cell 53, in which there are provided headspaces above both electrodes. The headspace above electrode 120 is partially occupied by gas body 125 and partially occupied by liquid electrolyte 100. The headspace above electrode 130 is partially occupied by gas body 135 and partially occupied by liquid electrolyte 100. The liquid electrolyte held in the porous capillary spacer 110 blocks gas crossover between gas body 125 and gas body 135. Electrode 120 has an attached or incorporated gas capillary or gas handling structure 1100, which extends through the liquid electrolyte 100 above the electrode to the headspace. Gas capillary or gas handling structure 1100 is filled with gas that is contiguous with the headspace gas (collectively forming gas body 125). Electrode 130 has an attached or incorporated gas capillary or gas handling structure 1101, which extends through the liquid electrolyte 100 above the electrode to the headspace. Gas capillary or gas handling structure 1100 is filled with gas that is contiguous with the headspace gas (collectively forming gas body 135).

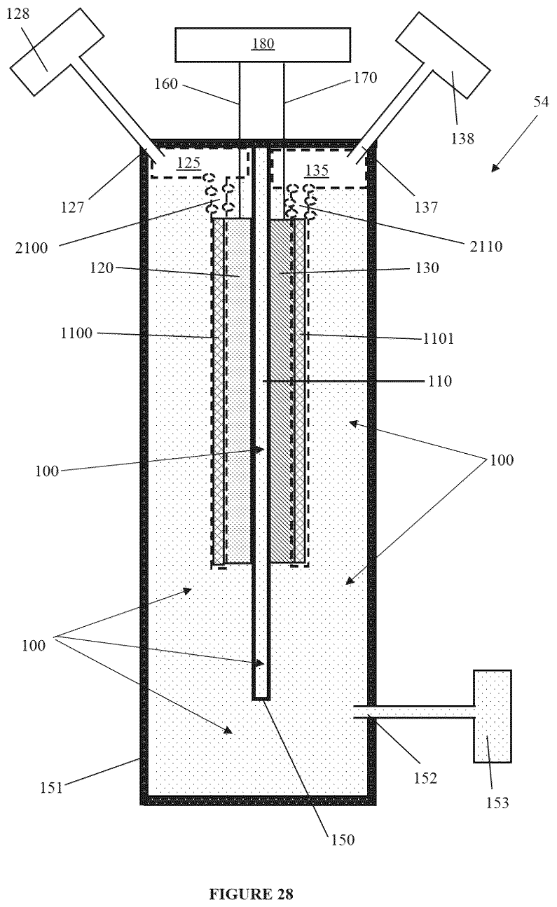

FIG. 28 illustrates a schematic cross-sectional view of a further example electro-synthetic or electro-energy cell 54, in which there are provided headspaces above both electrodes. The headspace above electrode 120 is partially occupied by gas body 125 and partially occupied by liquid electrolyte 100. The headspace above electrode 130 is partially occupied by gas body 135 and partially occupied by liquid electrolyte 100. The liquid electrolyte held in the porous capillary spacer 110 blocks gas crossover between gas body 125 and gas body 135. Electrodes 120 and 130 each produce gas. Electrode 120 has an attached or incorporated gas capillary or gas handling structure 1100, which releases bubbles/volumes of gas through the liquid electrolyte 100 along pathway 2100, where pathway 2100 often or routinely creates a contiguous connection between the body of gas within gas capillary or gas handling structure 1100 and the headspace gas (collectively forming gas body 125). Electrode 130 has an attached or incorporated gas capillary or gas handling structure 1101, which releases bubbles/volumes of gas through the liquid electrolyte along pathway 1210, where pathway 2110 often or routinely creates a contiguous connection between the body of gas within gas capillary or gas handling structure 1101 and the headspace gas (collectively forming gas body 135)

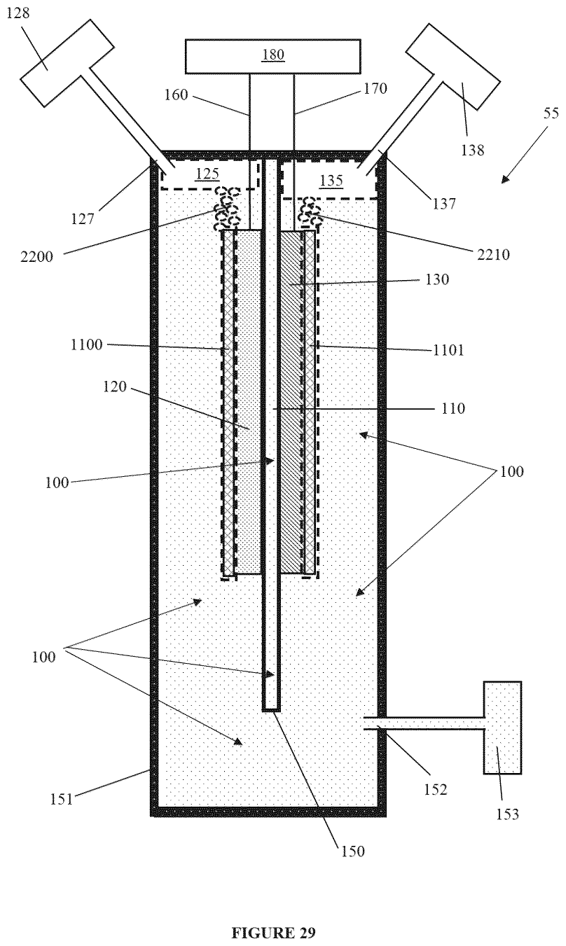

FIG. 29 illustrates a schematic cross-sectional view of a further example electro-synthetic or electro-energy cell 55, in which there are provided headspaces above both electrodes. The headspace above electrode 120 is partially occupied by gas body 125 and partially occupied by liquid electrolyte 100. The headspace above electrode 130 is partially occupied by gas body 135 and partially occupied by liquid electrolyte 100. The liquid electrolyte held in the porous capillary spacer 110 blocks gas crossover between gas bodies 125 and 135. Electrodes 120 and 130 each produce gas. Electrode 120 has an attached or incorporated gas capillary or gas handling structure 1100, which releases bubbles/volumes of gas through the liquid electrolyte 100 along pathway 2200, where pathway 2200 occasionally or irregularly creates a contiguous connection between the body of gas within gas capillary or gas handling structure 1100 and the headspace gas (collectively forming gas body 125). Electrode 130 has an attached or incorporated gas capillary or gas handling structure 1101, which releases bubbles/volumes of gas through the liquid electrolyte 100 along pathway 2210, where pathway 2210 occasionally, or irregularly creates a contiguous connection between the body of gas within gas capillary or gas handling structure 1101 and the headspace gas (collectively forming gas body 135).

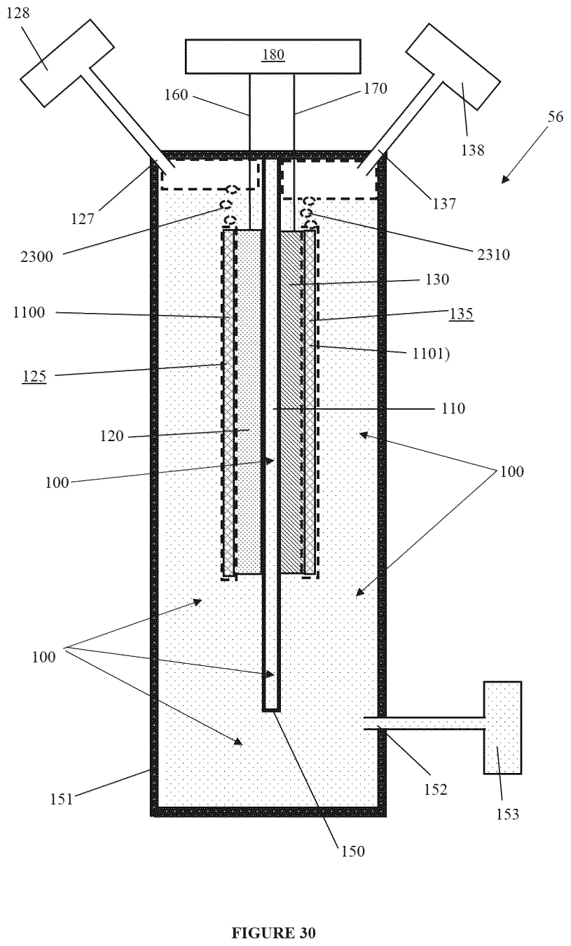

FIG. 30 illustrates a schematic cross-sectional view of a further example electro-synthetic or electro-energy cell 56, in which there are provided headspaces above both electrodes. The headspace above electrode 120 is partially occupied by a gas body associated with conduit 127 and partially occupied by liquid electrolyte 100. The headspace above electrode 130 is partially occupied by a gas body associated with conduit 137 and partially occupied by liquid electrolyte 100. The liquid electrolyte held in the porous capillary spacer 110 blocks gas crossover between the gas body associated with conduit 127 and the gas body associated with conduit 137. Electrodes 120 and 130 each produce gas. Electrode 120 has an attached or incorporated gas capillary or gas handling structure 1100 that contains gas body 125 within it. Gas body 125 is in gaseous communication with external conduit 127 and external gas storage system 128, via pathway 2300 through the liquid electrolyte 100. Gas body 125 releases bubbles/volumes of gas through the liquid electrolyte along pathway 2300 to the headspace, where the gas may enter external conduit 127 and external gas storage system 128. Electrode 130 has an attached or incorporated gas capillary or gas handling structure 1100 that contains gas body 135 within it. Gas body 135 is in gaseous communication with external conduit 137 and external gas storage system 138, via pathway 2310 through the liquid electrolyte 100. Gas body 135 releases bubbles/volumes of gas through the liquid electrolyte along pathway 2310 to the headspace, where the gas may enter external conduit 137 and external gas storage system 138.

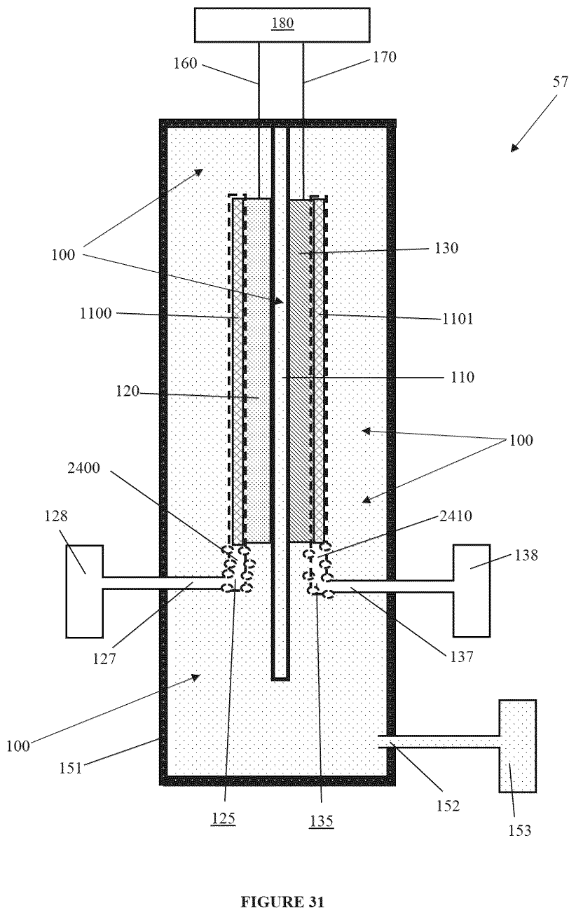

FIG. 31 illustrates a schematic cross-sectional view of a further example electro-synthetic or electro-energy cell 57, in which there are provided headspaces above both electrodes. The headspace above electrode 120 is occupied by liquid electrolyte 100. The headspace above electrode 130 is occupied by liquid electrolyte 100. The liquid electrolyte held in the porous capillary spacer 110 blocks gas crossover in the headspace. Electrodes 120 and 130 each consume gas. Electrode 120 has an attached or incorporated gas capillary or gas handling structure 1100 that contains a volume of gas. Gas capillary or gas handling structure 1100 receives bubbles/volumes of gas through the liquid electrolyte 100 along pathway 2400, from external gas conduit 127. Pathway 2400 often or routinely creates a contiguous connection between the body of gas within gas capillary or gas handling structure 1100 and the gas in gas conduit 127 (collectively forming gas body 125). Electrode 130 has an attached or incorporated gas capillary or gas handling structure 1101 that contains a volume of gas. Gas capillary or gas handling structure 1101 receives bubble/volumes of gas through the liquid electrolyte 100 along pathway 2410, from external gas conduit 137. Pathway 2410 often or routinely creates a contiguous connection between the body of gas within gas capillary or gas handling structure 1101 and the gas in gas conduit 137 (collectively forming gas body 135).

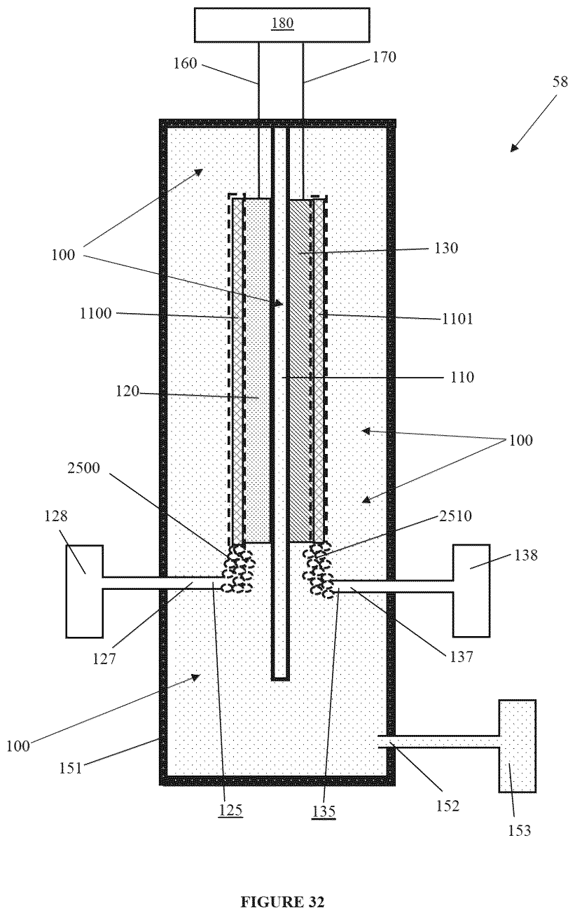

FIG. 32 illustrates a schematic cross-sectional view of a further example electro-synthetic or electro-energy cell 58, in which there are provided headspaces above both electrodes. The headspace above electrode 120 is occupied by liquid electrolyte 100. The headspace above electrode 130 is occupied by liquid electrolyte 100. The liquid electrolyte held in the porous capillary spacer 110 blocks gas crossover in the headspace. Electrodes 120 and 130 each consume gas. Electrode 120 has an attached or incorporated gas capillary or gas handling structure 1100 that contains a volume of gas. Gas capillary or gas handling structure 1100 receives bubbles/volumes of gas through the liquid electrolyte 100 along pathway 2500, from external gas conduit 127. Pathway 2500 occasionally or irregularly creates a contiguous connection between the body of gas within gas capillary or gas handling structure 1100 and the gas in gas conduit 127 (collectively forming gas body 125). Electrode 130 has an attached or incorporated gas capillary or gas handling structure 1101 that contains a volume of gas. Gas capillary or gas handling structure 1101 receives bubbles/volumes of gas through the liquid electrolyte 100 along pathway 2510, from external gas conduit 137. Pathway 2510 occasionally or irregularly creates a contiguous connection between the body of gas within gas capillary or gas handling structure 1101 and the gas in gas conduit 137 (collectively forming gas body 135).

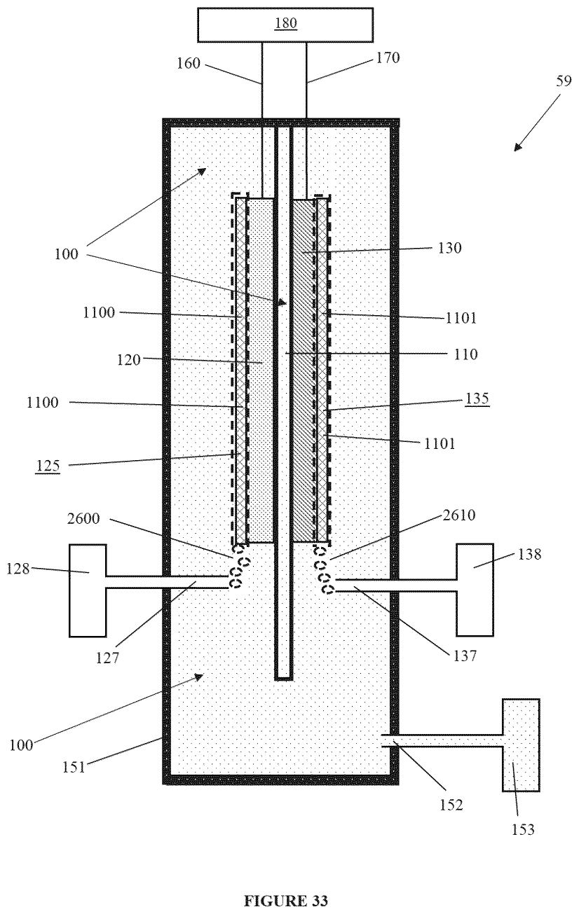

FIG. 33 illustrates a schematic cross-sectional view of a further example electro-synthetic or electro-energy cell 59, in which there are provided headspaces above both electrodes. The headspace above electrode 120 is occupied by liquid electrolyte 100. The headspace above electrode 130 is occupied by liquid electrolyte 100. The liquid electrolyte held in the porous capillary spacer 110 blocks gas crossover in the headspace. Electrodes 120 and 130 each consume gas. Electrode 120 has an attached or incorporated gas capillary or gas handling structure 1100 that contains gas body 125 within it. Gas body 125 is in gaseous communication with external conduit 127 and external gas storage system 128, via pathway 2600 through the liquid electrolyte 100. Gas body 125 receives bubbles/volumes of gas from conduit 127 through the liquid electrolyte along pathway 2600, where the gas may enter external conduit 127 from external gas storage system 128. Electrode 130 has an attached or incorporated gas capillary or gas handling structure 1101 that contains gas body 135 within it. Gas body 135 is in gaseous communication with external conduit 137 and external gas storage system 138, via pathway 2610 through the liquid electrolyte 100. Gas body 135 receives bubbles/volumes of gas from conduit 137 through the liquid electrolyte along pathway 2610, where the gas may enter external conduit 137 from external gas storage system 138.

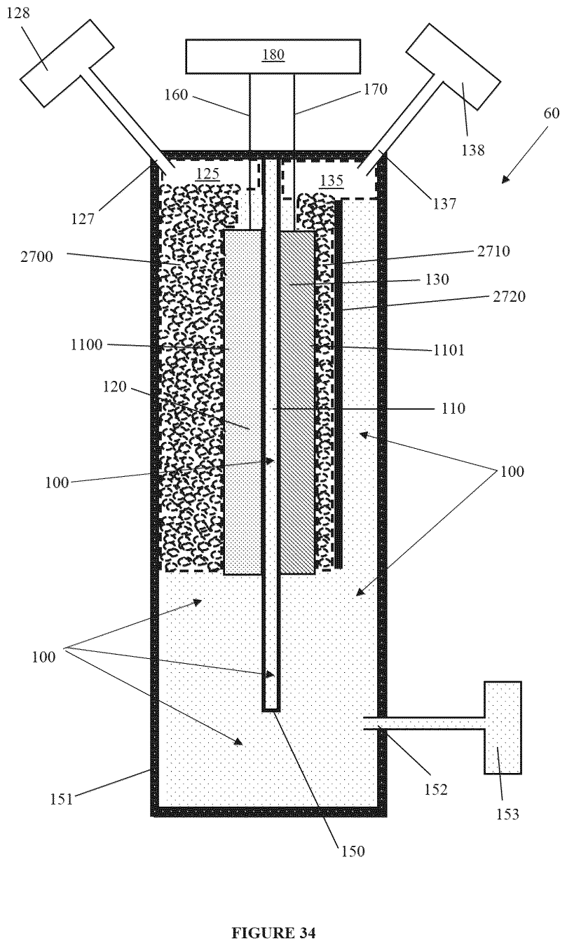

FIG. 34 illustrates a schematic cross-sectional view of a further example electro-synthetic or electro-energy cell 60, in which there are provided headspaces above both electrodes. The headspace above electrode 120 is partially occupied by a gas body associated with conduit 127 and partially occupied by liquid electrolyte 100. The headspace above electrode 130 is partially occupied by a gas body associated with conduit 137 and partially occupied by liquid electrolyte 100. The liquid electrolyte held in the porous capillary spacer 110 blocks gas crossover between the gas body associated with conduit 127 and the gas body associated with conduit 137. Cell 60 is a water electrolysis cell and electrodes 120 and 130 each produce a gas. During operation, electrode 120 generates a large volume of gas in the form of bubbles that fill volume 2700. In so doing, the gas bubbles in volume 2700 may routinely, often, or occasionally become contiguous with the gas body associated with conduit 127, thereby forming an overall gas body 125 (shown by the dashed line around and near volume 2700). The reaction continues because porous capillary spacer 110 is able to supply the water and/or liquid-phase ions required by electrode 120 to sustain the reaction. Before or after operation, liquid electrolyte 100 fills volume 2700. The overall gas body 125 shown by the dashed line around and near volume 2700 in FIG. 34, is therefore created dynamically when operating of the cell. During operation, electrode 130 generates a small volume of gas in the form of gas bubbles. The gas bubbles fill a smaller volume 2710 created by the placement of a solid or porous barrier 2720 near to the outer surface of electrode 130. In so doing, the gas bubbles in volume 2710 may routinely, often, or occasionally become contiguous with the gas body associated with conduit 137, thereby forming an overall gas body 135 (shown by the dashed line near electrode 130). The reaction continues at electrode 130 because porous capillary spacer 110 is able to supply the water and/or liquid-phase ions required by electrode 130 to sustain the reaction. Before or after operation, liquid electrolyte 100 fills volume 2710. The overall gas body 135 shown by the dashed line near electrode 130 in FIG. 34, is therefore created dynamically when operating of the cell. Cell 60 is an independent pathway cell as the cell provides separate, independent, non-interfering pathways for ingress of the liquid-phase water reactant to the reaction zone, whilst also providing separate, independent, non-interfering pathways for expulsion of the gas 125 from electrode 120 and expulsion of the gas 135 from electrode 130.

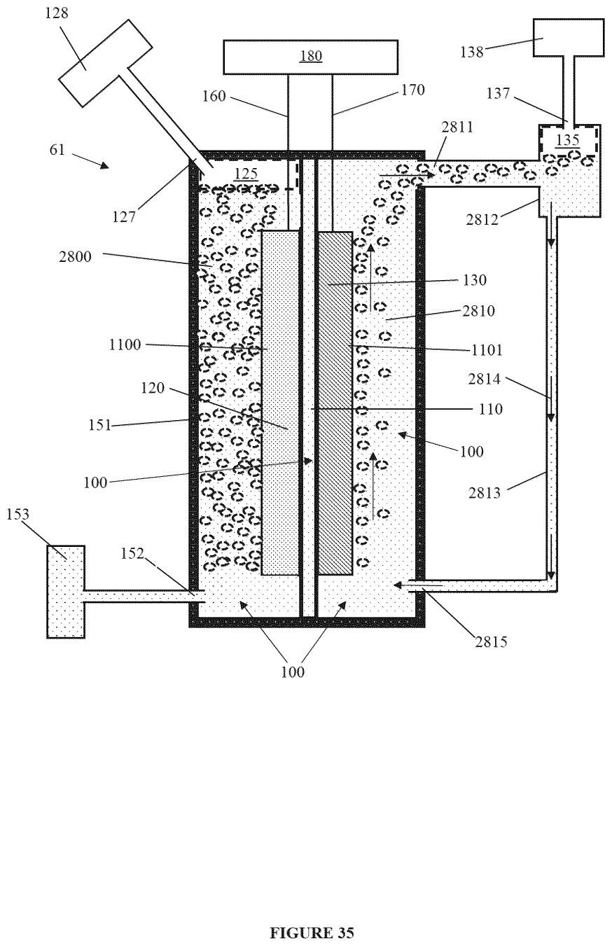

FIG. 35 illustrates a schematic cross-sectional view of a further example electro-synthetic or electro-energy cell 61, in which there is provided a headspace above electrode 120, which is partially occupied by gas body 125 and partially occupied by liquid electrolyte 100. The liquid electrolyte 100 about electrode 130 in volume 2810, is in fluid communication, via conduits 2811 and 2815, with a gas-liquid separator tank 2812, that is partially occupied by contiguous gas body 135 and partially occupied by liquid electrolyte 100. The liquid electrolyte held in the porous capillary spacer 110 blocks gas crossover between the half-cell associated with electrode 120 and the half-cell associated with electrode 130. Cell 61 is a water electrolysis cell and electrodes 120 and 130 each produce a gas. During operation, electrode 120 generates a volume of gas in the form of bubbles that rise within volume 2800 to join gas body 125. That is, the gas produced by electrode 120 is in fluid contact with the external conduit 127. During operation, electrode 130 generates a volume of gas in the form of bubbles that rise within volume 2810 to enter conduit 2811, flow to the separator tank 2812, wherein the gases separate into contiguous gas body 135, which is in gaseous communication with external conduit 137. The separated liquid electrolyte at the bottom of gas-liquid-separator tank 2812, then flows along conduit 2813, through conduit 2815, back into the volume 2810. This circulating flow, which occurs in the direction shown by the arrow 2814 and the other arrows in the half-cell associated with electrode 130, may be driven by the natural buoyancy of the gas bubbles, or it may be driven by a pump. That is, the gas produced by electrode 130 is in fluid contact with the conduit 137. One, or a combination of the following conditions pertain to cell 61:
Porous capillary spacer 110 has a sufficiently high flow rate to supply the liquid-phase water and/or ion reactants required by electrodes 120 and 130 to sustain the reaction, from between the electrodes. This means that cell 61 is an ‘independent pathway cell’ because it provides separate, independent, non-interfering pathways for: (a) the liquid-phase movement of the water and the ion reactants required by electrodes 120 and 130, and (b) the gas phase product 125 of electrode 120, and (c) the gas-phase product 135 of electrode 130;
The liquid electrolyte in the porous capillary spacer flows at a flow rate of more than 0.0014 g water per minute at a height of more than 8 cm;
The porous capillary spacer has an average pore diameter of more than 2 μm and less than 400 μm;
The porous capillary spacer has a maximum column height of more than 0.4 cm;
The porous capillary spacer 110 has a porosity of more than 60%;
The electrodes are compressed against the porous capillary spacer 110 with a pressure of more than 2 bar;
The porous capillary spacer 110 is less than 0.45 mm thick;
The liquid electrolyte in the porous capillary spacer blocks or hinders the first gas body 125 from mixing with the second gas body 135 and maintains a benchmark gas crossover of less than 2%;
The porous capillary spacer 110 has an ionic resistance of less than 140 mΩ cm² at room temperature;
Cell 61 displays an energy efficiency that is more than 0.5% higher than an identical cell equipped with a porous capillary spacer 110 that has an insufficient flow rate to supply the liquid-phase water and/or ions required by either electrode 120 or electrode 130 to sustain the reaction, from between the electrodes. The liquid-phase water and/or ion reactants required by either electrode 120 or electrode 130 to sustain the reaction, must instead be supplied from volumes 2800 or 2810 respectively. Such a cell would not be an independent pathway cell because it does not provide a separate, independent, non-interfering pathway for the liquid-phase movement of the water and the ion reactants required by electrodes 120 and 130.

In the example in FIG. 35, there is provided an electro-synthetic or electro-energy cell, wherein the porous capillary spacer has an average pore diameter of more than 2 μm and less than 400 μm, a porosity of more than 60%, an electrode compression of more than 2 bar, and wherein the electrolyte comprises a hydroxide salt and has a pH of at least 10.

In the example in FIG. 35, there is provided an electro-synthetic or electro-energy cell, wherein the liquid electrolyte in the porous capillary spacer flows at a flow rate of more than 0.0014 g water per minute at a height of more than 8 cm, a thickness of less than 0.45 mm, a porosity of more than 60%, an electrode compression of more than 2 bar, and wherein the electrolyte comprises a hydroxide salt and has a pH of at least 10.

In the example in FIG. 35, there is provided an electro-synthetic or electro-energy cell, wherein the porous capillary spacer has a maximum column height of more than 0.4 cm, a porosity of more than 60%, an electrode compression of more than 2 bar, and wherein the electrolyte comprises a hydroxide salt and has a pH of at least 10.

### FURTHER EXAMPLE EMBODIMENTS

According to still further non-limiting example embodiments, the following points disclose further example cells and example methods of operation of cells.
1. An electro-synthetic or electro-energy cell, comprising:
   a reservoir containing a liquid electrolyte;
   a first gas diffusion electrode;
   a second electrode; and
   a porous capillary spacer filled with the liquid electrolyte and positioned between the first gas diffusion electrode and the second electrode, the porous capillary spacer having a distal end positioned within the reservoir and in liquid contact with the liquid electrolyte.
2. The cell of point 1, further including an external housing for the cell, the external housing providing at least one external liquid conduit.
3. The cell of point 2, wherein the liquid electrolyte, liquid-phase reactants and/or products are transported into or out of the reservoir via the at least one external liquid conduit.
4. The cell of point 3, wherein the at least one external liquid conduit is in fluid communication with an external liquid storage system for externally storing, supplying or removing the liquid electrolyte, the liquid-phase reactants and/or products.
5. The cell of any one of points 1 to 4, wherein no external liquid conduit exists and the liquid electrolyte and/or liquid-phase reactants and/or products are transported into or out of the cell in the form of vapour within a gas stream.
6. The cell of any one of points 1 to 5, wherein the vapour preferentially condenses in or evaporates from the body of liquid electrolyte within the porous capillary spacer.
7. The cell of any one of points 1 to 6, wherein the first gas diffusion electrode is separated from part of the liquid electrolyte being in the reservoir.
8. The cell of any one of points 1 to 6, wherein the first gas diffusion electrode contacts part of the liquid electrolyte being in the reservoir.
9. The cell of any one of points 1 to 8, wherein the second electrode is separated from part of the liquid electrolyte being in the reservoir.
10. The cell of any one of points 1 to 8, wherein the second electrode contacts part of the liquid electrolyte being in the reservoir.
11. The cell of any one of points 1 to 10, wherein the distal end of the porous capillary spacer extends beyond the first gas diffusion electrode and the second electrode.
12. The cell of any one of points 1 to 11, wherein the porous capillary spacer is filled with the liquid electrolyte before the distal end of the porous capillary spacer is positioned within the reservoir.
13. The cell of any one of points 1 to 11, wherein the liquid electrolyte contacts the first gas diffusion electrode and the second electrode after first being transported along the porous capillary spacer from the reservoir.
14. The cell of any one of points 1 to 13, wherein during operation, at least part of the porous capillary spacer adjacent to all of the first gas diffusion electrode and at least part of the porous capillary spacer adjacent to all of the second electrode, remain filled with the liquid electrolyte.
15. The cell of any one of points 1 to 14, wherein there is no reservoir present, or the reservoir is incorporated into the porous capillary spacer, wherein the liquid electrolyte in the porous capillary spacer comprises the only contiguous body of liquid electrolyte in the cell.
16. The cell of any one of points 1 to 15, wherein the second electrode is a second gas diffusion electrode.
17. The cell of any one of points 1 to 16, wherein the first gas diffusion electrode and the second electrode are spaced apart from the reservoir.
18. The cell of any one of points 1 to 17, wherein an area of direct contact between the porous capillary spacer and the first gas diffusion electrode is outside of the reservoir, and an area of direct contact between the porous capillary spacer and the second electrode is outside of the reservoir.
19. The cell of any one of points 1 to 18, wherein liquid-phase reactants or products for an electrochemical reaction in the cell follow pathways within the liquid electrolyte inside the porous capillary spacer.
20. The cell of any one of points 1 to 19, wherein the reservoir includes an opening through which the porous capillary spacer passes.
21. The cell of any one of points 1 to 20, wherein a surface area covered by the liquid electrolyte within the porous capillary spacer is at least equal to or greater than a surface area of the first gas diffusion electrode.
22. The cell of any one of points 1 to 21, further including an external housing for the cell, the external housing providing at least one external first gas conduit.
23. The cell of any one of point 22, wherein the external housing further provides at least one external first gas conduit.
24. The cell of any one of points 1 to 23, further including a first gas body comprised of a first gas adjacent the first gas diffusion electrode, where the first gas is a reactant or product supplied into or removed out of the cell during operation.
25. The cell of point 22 or 23, and 24, wherein the first gas is transported into or out of the first gas body via the at least one external first gas conduit.
26. The cell of point 25, wherein the at least one external first gas conduit is in gaseous communication with an external first gas storage system for externally storing, supplying or removing the first gas.
27. The cell of point 16, further including a second gas body comprised of a second gas adjacent the second gas diffusion electrode, where the second gas is a reactant or product supplied into or removed out of the cell during operation.
28. The cell of point 22 or 23, the external housing providing at least one external second gas conduit.
29. The cell of point 27 and 28, wherein the second gas is transported into or out of the second gas body via the at least one external second gas conduit.
30. The cell of point 29, wherein the at least one external second gas conduit is in gaseous communication with an external second gas storage system for externally storing, supplying or removing the second gas.
31. The cell of any one of points 1 to 30, wherein the first gas diffusion electrode and the second electrode each have a side with a geometric surface area of greater than or equal to 10 cm².
32. The cell of any one of points 1 to 31, wherein the first gas diffusion electrode includes a metallic mesh, a metallic foam and/or a metallic perforated plate.
33. The cell of point 16, wherein the second gas diffusion electrode includes a metallic mesh, a metallic foam and/or a metallic perforated plate.
34. The cell of point 16, wherein a first side of the porous capillary spacer is adjacent a first side of the first gas diffusion electrode, a second side of the porous capillary spacer is adjacent a first side of the second gas diffusion electrode, a second side of the first gas diffusion electrode is adjacent the first gas body, and a second side of the second gas diffusion electrode is adjacent the second gas body.
35. The cell of point 34, wherein at least part of the second side of the first gas diffusion electrode is in direct gas-phase contact with the first gas body; and at least part of the second side of the second gas diffusion electrode is in direct gas-phase contact with the second gas body.
36. The cell of any one of points 1 to 35, including a gas handling structure positioned:
   between the first gas diffusion electrode and the porous capillary spacer,
   in the first gas diffusion electrode,
   at or near the first gas diffusion electrode, or
   in a portion of the first gas diffusion electrode.
37. The cell of any one of points 1 to 36 and point 16, including a second gas handling structure positioned:
   between the second gas diffusion electrode and the porous capillary spacer,
   in the second gas diffusion electrode,
   at or near the second gas diffusion electrode, or
   in a portion of the second gas diffusion electrode.
38. The cell of any one of points 1 to 37, including a gas capillary structure positioned in or at the first gas diffusion electrode.
39. The cell of point 38 and point 16, including a second gas capillary structure positioned in or at the second gas diffusion electrode.
40. The cell of any one of points 1 to 39, wherein the liquid electrolyte is transported along the porous capillary spacer at least by capillary action.
41. The cell of any one of points 1 to 39, wherein the liquid electrolyte is transported along the porous capillary spacer by capillary action, diffusion and/or osmotic action.
42. The cell of any one of points 1 to 39, wherein the cell is self-regulated by capillary action, diffusion and/or osmotic action occurring within the porous capillary spacer.
43. The cell of any one of points 1 to 42, wherein the liquid electrolyte in the porous capillary spacer blocks or hinders the first gas body from mixing with the second gas body.
44. The cell of any one of points 1 to 43, the cell being a zero-gap cell, whereby the porous capillary spacer is less than 2 mm thick.
45. The cell of any one of points 1 to 44, including two or more porous capillary spacers.
46. The cell of point 45, including two or more reservoirs containing liquid electrolyte, wherein an end of each of the two or more porous capillary spacers is positioned in one of the two or more reservoirs.
47. The cell of any one of points 1 to 46, wherein the porous capillary spacer is at least partially comprised of a polyethersulfone material.
48. The cell of any one of points 1 to 47, wherein the porous capillary spacer has an average pore size of about 5 μm, or about 8 μm.
49. The cell of any one of points 1 to 48, wherein the porous capillary spacer is at least partially comprised of one or materials selected from the group comprising: PVDF, PTFE, tetrafluoroethylene, fluorinated polymers, polyimides, polyamides, nylon, nitrogen-containing materials, glass fibre, silicon-containing materials, polyvinyl chloride, chloride-containing polymers, cellulose acetate, cellulose nitrate, cellophane, ethyl-cellulose, cellulose-containing materials, polycarbonate, carbonate-containing materials, polyethersulfone, polysulfone, polyphenylsulfone, sulfone-containing materials, polyphenylene sulphide, sulphide-containing materials, polypropylene, polyethylene, polyolefins, olefin-containing materials, asbestos, titanium-based ceramics, zirconium-based ceramics, ceramic materials, polyvinyl chloride, vinyl-based materials, rubbers, porous battery separators, and clays.
50. The cell of any one of points 1 to 49, wherein the reservoir comprises a first volume containing a first liquid, a second volume containing a second liquid, and a semi-permeable membrane separating the first volume and the second volume.
51. The cell of point 50, wherein the porous capillary spacer is positioned in the first volume, the first liquid is the liquid electrolyte, and the second liquid is different to the first liquid.
52. The cell of any one of points 1 to 51, wherein a plurality of the cells are electrically connected as a multi-cell stack.
53. The cell of points 51 and 52, wherein the second liquid, of each of the plurality of the cells, is in liquid communication via a common supply or removal pipe connected to the second volume of each of the plurality of the cells.
54. The cell of point 51, wherein the second liquid is pure water.
55. The cell of any one of points 1 to 54, wherein the liquid electrolyte comprises water containing one or more ions selected from the group comprising: 0.001-14 M concentrations of Na⁺, K⁺, Ca²⁺, Mg²⁺, OH⁻, SO₄²⁻, HSO₄⁻, Cl⁻, NO₃⁻, ClO₄⁻, phosphates, HPO₄⁻, carbonates, HCO₃⁻, PF₆⁻, BF₄⁻, (CF₃SO₂)₂N⁻, polyelectrolytes that contain polymers with functional groups, polystyrene sulfonate, DNA, and polypeptides.
56. The cell of any one of points 1 to 54, wherein the liquid electrolyte comprises non-aqueous liquids containing solutes selected from the group comprising: propylene carbonate liquid, dimethoxyethane liquid, propionitrile liquid, LiClO₄ solute, and Bu₄NPF₆ solute.
57. The cell of any one of points 1 to 54, wherein the liquid electrolyte is a conductive liquid selected from the group comprising: ambient temperature molten salts, and ionic liquids comprising of alkyl-substituted ammonium, imidazolium and pyridinium cations.
58. The cell of any one of points 1 to 54, wherein the liquid electrolyte is a conductive gel.
59. A method of operating an electro-synthetic or electro-energy cell to perform an electrochemical reaction, the electro-synthetic or electro-energy cell comprising:
   a reservoir containing a liquid electrolyte;
   a first gas diffusion electrode;
   a second electrode; and
   a porous capillary spacer positioned between the first gas diffusion electrode and the second electrode, the porous capillary spacer having a distal end positioned within the reservoir and in liquid contact with the liquid electrolyte;
   the method comprising the steps of:
      filling the porous capillary spacer with the liquid electrolyte; and
      contacting the liquid electrolyte with the first gas diffusion electrode and the second electrode.
60. The method of point 59, including filling the porous capillary spacer with the liquid electrolyte from the reservoir by at least capillary action.
61. The method of point 59, including filling the porous capillary spacer with the liquid electrolyte before the distal end of the porous capillary spacer is positioned within the reservoir.
62. The method of point 60, including contacting the liquid electrolyte with the first gas diffusion electrode and the second electrode after having been transported along the porous capillary spacer.
63. The method of any one of points 59 to 62, wherein during operation, the porous capillary spacer remains filled with liquid electrolyte.
64. The method of any one of points 59 to 63, wherein the cell is an electro-synthetic cell and the electrochemical reaction produces a chemical product that is transported away external to the electro-synthetic cell.
65. The method of any one of points 59 to 64, further including an external housing for the cell, the external housing providing at least one external liquid conduit, wherein the liquid electrolyte is transported into or out of the reservoir via the at least one external liquid conduit.
66. The method of point 65, further including the external housing providing at least one external first gas conduit, wherein a first gas is transported into or out of a first gas body via the at least one external first gas conduit.
67. The method of any one of points 59 to 64, further including an external housing for the cell, the external housing providing at least one external first gas conduit, wherein a first gas is transported into or out of a first gas body via the at least one external first gas conduit.
68. The method of any one of points 65 to 67, further including the external housing providing at least one external second gas conduit, wherein a second gas is transported into or out of a second gas body via the at least one external second gas conduit.
69. The method of any one of points 59 to 68, wherein the cell operates using an electrical current through the first gas diffusion electrode and the second electrode of greater than or equal to 1 Amp.
70. The method of any one of points 59 to 69, wherein the cell is able to continuously operate for at least 24 hours.
71. The method of any one of points 59 to 70, wherein the porous capillary spacer draws in and maintains a column height of the liquid electrolyte within the porous capillary spacer by capillary action.
72. The method of any one of points 59 to 71, wherein the maximum column height of the liquid electrolyte is at least equal to or greater than the height of the first gas diffusion electrode.
73. The method of any one of points 59 to 72, wherein during the electrochemical reaction, the liquid electrolyte within the porous capillary spacer facilitates migration of one or more liquid-phase materials along a length of the porous capillary spacer.
74. The method of any one of points 59 to 73, wherein the migration of the one or more liquid-phase materials along the length of the porous capillary spacer is under control of liquid-phase capillary action, diffusion and/or osmotic action.
75. The method of any one of points 59 to 74, wherein the electrochemical reaction is self-regulating in the electro-synthetic or electro-energy cell.
76. The method of any one of points 59 to 75, wherein movement of liquid-phase materials out of a cross-plane axis is self-regulated by the composition of the liquid electrolyte in the reservoir.
77. The method of any one of points 59 to 76, wherein migration pathways of liquid-phase materials and gas-phase materials into and out of a cross-plane axis are differently oriented.
78. The method of any one of points 59 to 77, wherein liquid-phase capillary, diffusion and/or osmotic actions, act within the porous capillary spacer to:
   (i) continuously replenish one or more liquid-phase materials that are consumed within the liquid electrolyte; or
   (ii) continuously remove one or more liquid-phase materials that are produced within the liquid electrolyte.
79. The method of any one of points 59 to 78, wherein the electrochemical reaction produces Ammonia from Nitrogen and Hydrogen or Oxygen.
80. The method of any one of points 59 to 78, wherein the electrochemical reaction produces electricity from Ammonia and Oxygen.
81. The method of any one of points 59 to 78, wherein the electrochemical reaction produces Hydrogen and Nitrogen from Ammonia.
82. The method of any one of points 59 to 78, wherein the electrochemical reaction uses NO_{X} as a reactant.
83. The method of any one of points 59 to 78, wherein the electrochemical reaction produces Chlorine, Hydrogen and Caustic from Brine.
84. The method of any one of points 59 to 78, wherein the electrochemical reaction produces Chlorine and Caustic from Brine.
85. The method of any one of points 59 to 78, wherein the electrochemical reaction produces Chlorine and Hydrogen from Hydrochloric Acid.
86. The method of any one of points 59 to 78, wherein the electrochemical reaction produces electrical energy from Hydrogen and Oxygen.
87. The method of any one of points 59 to 78, wherein the electrochemical reaction produces Hydrogen and Oxygen from water.
88. The method of any one of points 59 to 78, wherein the electrochemical reaction extracts pure Hydrogen from gas mixtures containing Hydrogen.

Although preferred embodiments have been described in detail, it is to be understood that many modifications, changes, substitutions or alterations will be apparent to those skilled in the art without departing from the scope of the present invention.

Embodiments and modes of operation may be said to broadly involve the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

1. A method of operating an electrochemical cell to perform an electrochemical reaction, the electrochemical cell comprising:
a reservoir containing a liquid electrolyte;
a first gas diffusion electrode;
a second electrode; and
a porous capillary spacer positioned between the first gas diffusion electrode and the second electrode, the porous capillary spacer having an end positioned within the reservoir and in liquid contact with the liquid electrolyte;
wherein the electrochemical cell is an electro-synthetic cell;
the method comprising the steps of:
contacting the first gas diffusion electrode and the second electrode with the liquid electrolyte; and
applying a voltage across the first gas diffusion electrode and the second electrode.

2. The method of claim 1, including filling the porous capillary spacer with the liquid electrolyte from the reservoir by at least capillary action.

3. The method of claim 2, including filling the porous capillary spacer with the liquid electrolyte before the end of the porous capillary spacer is positioned within the reservoir.

4. The method of claim 3, including contacting the first gas diffusion electrode and the second electrode with the liquid electrolyte after having been transported along the porous capillary spacer.

5. The method of claim 1, wherein during operation, the porous capillary spacer remains filled with liquid electrolyte.

6. (canceled)

7. The method of claim 1, further including an external housing for the cell, the external housing providing at least one external liquid conduit, wherein the liquid electrolyte is transported into or out of the reservoir via the at least one external liquid conduit.

8. (canceled)

9. The method of claim 1, further including the external housing providing at least one external first gas conduit, wherein a first gas is transported into or out of a first gas body via the at least one external first gas conduit.

10.-12. (canceled)

13. The method of claim 1, wherein the cell operates using an electrical current through the first gas diffusion electrode and the second electrode of greater than or equal to 1 Amp, preferably greater than or equal to 1.5 Amp, more preferably greater than or equal to 2 Amp, and more preferably greater than or equal to 2.5 Amp.

14. (canceled)

15. The method of claim 1, wherein the porous capillary spacer draws in and maintains a column height of the liquid electrolyte within the porous capillary spacer by capillary action.

16. The method of claim 1, wherein the maximum column height of the liquid electrolyte is at least equal to or greater than the height of the first gas diffusion electrode.

17. (canceled)

18. (canceled)

19. The method of claim 1, wherein the electrochemical reaction is self-regulating in the electro-synthetic cell.

20. (canceled)

21. The method of claim 1, wherein migration pathways of liquid-phase materials and gas-phase materials into and out of a cross-plane axis are differently oriented.

22. The method of claim 1, wherein liquid-phase capillary, diffusion and/or osmotic actions, act within the porous capillary spacer to:
(i) continuously replenish one or more liquid-phase materials that are consumed within the liquid electrolyte; or
(ii) continuously remove one or more liquid-phase materials that are produced within the liquid electrolyte.

23. The method of claim 1, wherein the electrochemical reaction produces Ammonia from Nitrogen and Hydrogen.

24. (canceled)

25. The method of claim 1, wherein the electrochemical reaction produces Hydrogen and Nitrogen from Ammonia.

26. (canceled)

27. The method of claim 1, wherein the electrochemical reaction produces Chlorine, Hydrogen and/or Caustic from Brine.

28.-30. (canceled)

31. The method of claim 1, wherein the electrochemical reaction produces Hydrogen and Oxygen from water.

32. The method of claim 1, wherein the electrochemical reaction extracts pure Hydrogen from gas mixtures containing Hydrogen.

33. An electrochemical cell comprising:
a reservoir containing a liquid electrolyte;
a first gas diffusion electrode;
a second electrode; and
a porous capillary spacer positioned between the first gas diffusion electrode and the second electrode, the porous capillary spacer having an end positioned within the reservoir and in liquid contact with the liquid electrolyte;
wherein the electrochemical cell is an electro-synthetic cell, and
wherein the electrochemical cell is configured to be operated in accordance with the method of claim 1.

34. A stack of electrochemical cells, comprising:
a first electrochemical cell according to claim 33, and
a second electrochemical cell according to claim 33.

35. (canceled)
